(19) United States
(12) Patent Application Publication
(10) Pub. No.: US 2012/0310599 A1
(43) Pub. Date: Dec. 6, 2012

(54) SENSOR DATA COLLECTION SYSTEM

(75) Inventors: Kyoko TANAKA, Shime (JP); Akira Imahase, Dazaifu (JP); Kei Hamada, Fukuoka (JP)

(73) Assignee: FUJITSU LIMITED, Kawasaki-shi (JP)

(21) Appl. No.: 13/447,992

(22) Filed: Apr. 16, 2012

(30) Foreign Application Priority Data
May 31, 2011 (JP) 2011-122664
Dec. 28, 2011 (JP) 2011-289696

(51) Int. Cl. G06F 15/00; G01D 7/00

(52) U.S. Cl. 702/189; 73/866.1

(57) ABSTRACT

A first collecting device is connected to a first network to which a first sensor is connected, and to an external network. A second collecting device is connected to a second network to which a plurality of second sensors for measuring a second amount of observation are connected, and to the external network, and collects second sensor data. When the first collecting device cannot collect first sensor data through the first network, an adapter transfers the first sensor data to the second collecting device through the second network, and transmits the first sensor data to the first collecting device from the second collecting device through the external network.

### CROSS-REFERENCE TO RELATED APPLICATIONS

This application is based upon and claims the benefit of priority of the prior Japanese Patent Application No. 2011-122664, filed on May 31, 2011, and the prior Japanese Patent Application No. 2011-289696, filed on Dec. 28, 2011, the entire contents of which are incorporated herein by reference.

### FIELD

The following modes for embodying the present invention relate to the sensor data collection system using a sensor network.

### BACKGROUND

Recently, there is remarkable technological progress of a sensor, and the sensor market rapidly spreads not only in the industrial field and the consumer product field, but also into new fields such as the medical field, the environment field, etc. In addition, with the development of the sensor network (sensor NW) technology in which a sensor is connected to a network, the environment of connecting a sensor to a network has become well prepared.

At present, as one of the services using sensor data, a “agriculture support service of providing a plurality of sensors for collecting information such as a temperature, humidity, illuminance, etc. for a farm, visualizing the state of the farm from the collected sensor data, and presenting advice for the farm” has been proposed. In the agriculture support service, a number of demonstration experiments have been performed.

Unlike a normal ad hoc network, the sensor NW has two unique characteristics of “limiting the calculation capability of the sensor itself” and “a large number of sensors in the network”. That is, the sensor generates a large volume of sensor data, but the data is not aggregated in the sensor NW in most cases.

In the situation described above, when a system for collecting sensor data is built up, there occurs a problem from the viewpoint of scalability if each sensor directly transmits data directly to the data center (for example, in the case of the TCP, each sensor establishes a connection). The TCP refers to a transmission control protocol.

Therefore, when the sensor data is collected, the aggregation device of the sensor data directly connected to the sensor NW once collects and aggregates the sensor data in the sensor NW, and transmits the data to the data center which centrally manages the sensor data.

FIG. 1 is the configuration of the system for aggregating the sensor NW and the sensor data. A sensor NW 10 is a network in which a plurality of sensors are connected to one another. The sensors transmit the sensor data detected by themselves through a communication circuit. A aggregation device 11 is a gateway (GS) of the sensor NW 10. The sensor of the sensor NW 10 collects the sensor data to be transmitted. A data center 13 provided for a global network 12 receives the sensor data collected from the sensor NW 10, and stores and manages the data.

ZigBee (whose (electrical) specification is standardized as IEEE 802.15.4) is well known as a standardized technology of the sensor NW. Practically, the optimum radio system and routing system for the sensor are selected depending on the distance for the sensor to be arranged and the characteristic of the sensor data (data size, transmission period of sensor data, etc.).

That is, when a plural types of sensor data are to be collected, a sensor NW is buildup and an aggregation device is provided for each type of sensor.

FIG. 2 illustrates a state in which a sensor NW is formed for each type of sensor. For example, assume that a sensor can be a temperature sensor, a illuminance sensor, and a humidity sensor in FIG. 2. In this case, a sensor NW 10-1 for the temperature sensor, a sensor NW 10-2 for the illuminance sensor, and a sensor NW 10-3 for the humidity sensor are formed. In each of the sensor NWs 10-1 through 10-3, the radio system, the routing system, the data transmission protocol, the data format of each own is determined.

An aggregation device 11-1 collects the sensor data from the temperature sensor of the sensor NW 10-1. An aggregation device 11-2 collects the sensor data from the illuminance sensor of the sensor NW 10-2. An aggregation device 11-3 collects the sensor data from the humidity sensor of the sensor NW 10-3. Then, the sensor data collected by the aggregation devices 11-1 through 11-3 is collected by the data center 13 provided for the global network 12.

A common protocol for mutually connecting one another among different types of sensor NWs can be an OSNAP (open sensor network access protocol). The OSNAP is to share an interface among GWs (aggregation devices) connected to the sensor NW, and is not to share the sensor NW itself.

Enumerated below are the differences between a normal network and a sensor NW. First, there is a difference in node for configuring a network. That is, in a normal network, a dedicated repeater (a switch, a router, etc.) configures a network. Basically, a repeater is fixed, and repeaters are connected to each other through a cable. As for the sensor NW, the sensor itself acts as a repeater, and configures a network. A sensor is movable in many cases, and sensors are connected to each other by radio in many cases.

There is also a difference in protocol of a transport. A common network is substantially unified by an Internet protocol (IP) (Networks are connected to each other through the IP). On the other hand, the sensor NW can be realized by various protocols by a sensor (it is difficult to connect networks).

The prior art can be a sensor NW etc. which can easily detect sensor data.
Patent Document 1: Japanese Laid-open Patent Publication No. 2006-195788
Patent Document 2: Japanese Laid-open Patent Publication No. 2003-67207

### SUMMARY

The sensor data collection system according to an aspect of the modes for embodying the present invention of the present invention includes a first collecting device, a second collecting device, and an adapter. The first collecting device is connected to a first network to which a plurality of first sensors are connected and an external network, and collects first sensor data as a measurement result of a first amount of observation of the plurality of first sensors. The second collecting device is connected to a second network to which a plurality of second sensors for measuring a second amount of observation and the external network, and collects second sensor data as a measurement result of a second amount of observation of the plurality of second sensors. When the first collecting device cannot collect the first sensor data through the first network, the adapter transfers the first sensor data to the second collecting device through the second network. Then, the adapter transmits the first sensor data to the first collecting device through the external network. The adapter is also connected to the first and second networks.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration of a system which aggregates a sensor NW and a sensor data;

FIG. 2 illustrates the state in which the sensor NW is formed for each type of sensor;

FIG. 3 illustrates the state in which the sensor NW is divided;

FIG. 4 illustrates the state of the sensor NW for which a substitute path is available by increasing the number of sensors;

FIG. 5 is an explanatory view of the first mode for embodying the present invention;

FIG. 6 is a configuration of the entire system according to the first mode for embodying the present invention;

FIG. 7 is a block diagram of the function of the sensor according to the first mode for embodying the present invention;

FIG. 8 is a block diagram of the function of the collecting server according to the first mode for embodying the present invention;

FIG. 9 is a block diagram of the function of the management server according to the first mode for embodying the present invention;

FIG. 10 is a block diagram of the function of the aggregation device according to the first mode for embodying the present invention (embodiment 1);

FIG. 11 is an example of the sensor operation state table according to the first mode for embodying the present invention (embodiment 1);

FIG. 12 is an example of the sensor NW state table according to the first mode for embodying the present invention (embodiment 1);

FIG. 13 is a block diagram of the function of the adapter according to the first mode for embodying the present invention (embodiment 1);

FIG. 14 is an example of the sensor NW table according to the first mode for embodying the present invention (embodiment 1);

FIG. 15 is an example of the sensor management table according to the first mode for embodying the present invention (embodiment 1);

FIG. 16 is an example of the transfer rule table according to the first mode for embodying the present invention (embodiment 1);

FIG. 17 is an example of the conversion rule table according to the first mode for embodying the present invention (embodiment 1);

FIG. 18 is an example (1) of the template file according to the first mode for embodying the present invention (embodiment 1);

FIG. 19 is an example (2) of the template file according to the first mode for embodying the present invention (embodiment 1);

FIG. 20 is an example of the sensor NW monitor sequence according to the first mode for embodying the present invention (embodiment 1);

FIG. 21 is an example of the contents of the poll reply transmitted from the aggregation device according to the first mode for embodying the present invention (embodiment 1);

FIG. 22 is an example of the sensor data collection sequence in the normal state according to the first mode for embodying the present invention (embodiment 1);

FIG. 23 is an example of the sequence from detecting a fault (division of sensor NW) to changing the destination of sensor data according to the first mode for embodying the present invention (embodiment 1);

FIG. 24 is an example of the sensor data transfer sequence in the adapter according to the first mode for embodying the present invention (embodiment 1);

FIG. 25 is an example of sensor data before a conversion according to the first mode for embodying the present invention (embodiment 1);

FIG. 26 is an example of sensor data after a conversion according to the first mode for embodying the present invention (embodiment 1);

FIG. 27 is an example of the sensor data transfer sequence in the aggregation device according to the first mode for embodying the present invention (embodiment 1);

FIG. 28 is an example of the collecting sequence up to the transmission of sensor data from the aggregation device to the collecting server according to the first mode for embodying the present invention (embodiment 1);

FIG. 29 is a block diagram of the function of the aggregation device according to the first mode for embodying the present invention (embodiment 2);

FIG. 30 is an example of the sensor data transfer sequence in the aggregation device according to the first mode for embodying the present invention (embodiment 2);

FIG. 31 is an example of the sensor data collection sequence from the aggregation device according to the first mode for embodying the present invention (embodiment 2);

FIG. 32 is an example of the operation of the conversion unit of the adapter according to the first mode for embodying the present invention (embodiments 1 and 2);

FIG. 33 is an example of the operation of the transfer destination determination unit of the adapter according to the first mode for embodying the present invention (embodiments 1 and 2);

FIG. 34 is an example of the operation of the protocol selection unit of the adapter according to the first mode for embodying the present invention (embodiments 1 and 2);

FIG. 35 is a configuration of the entire system according to the second mode for embodying the present invention;

FIG. 36 is a block diagram of the function of the aggregation device according to the second mode for embodying the present invention;

FIG. 37 is a block diagram of the function of the adapter according to the second mode for embodying the present invention;

FIG. 38 is a block diagram of the function of the aggregation device according to the second mode for embodying the present invention (embodiment 1);

FIG. 39 is an example of the contents of the sensor data acquire request to another sensor NW according to the second mode for embodying the present invention (embodiment 1);

FIG. 40 is an example of the acquisition requested information table according to the second mode for embodying the present invention (embodiment 1);

FIG. 41 is an example of the sensor data transmitted from another sensor NW according to the second mode for embodying the present invention (embodiment 1);

FIG. 42 is a sensor operation state table in the local sensor NW according to the second mode for embodying the present invention (embodiment 1);

FIG. 43 is a sensor NW state table in the local sensor NW according to the second mode for embodying the present invention (embodiment 1);

FIG. 44 is the adapter vicinity sensor information table according to the second mode for embodying the present invention (embodiment 1);

FIG. 45 is a block diagram of the function of the adapter according to the second mode for embodying the present invention (embodiment 1);

FIG. 46 is an example of the sensor NW management table according to the second mode for embodying the present invention (embodiment 1);

FIG. 47 is an example of the adapter management table according to the second mode for embodying the present invention (embodiment 1);

FIG. 48 is an example of the acquire request conversion rule table according to the second mode for embodying the present invention (embodiment 1);

FIGS. 49A and 49B are examples (1) of the template file according to the second mode for embodying the present invention (embodiment 1);

FIG. 50 is an example of the transmission data conversion rule table according to the second mode for embodying the present invention (embodiment 1);

FIGS. 51A and 51B are examples (2) of the template file according to the second mode for embodying the present invention (embodiment 1);

FIGS. 52A and 52B are an example of the flowchart of determining the collection destination of the aggregation device according to the second mode for embodying the present invention (embodiment 1);

FIG. 53 is an example of the sequence of detecting (monitoring the sensor NW) the abnormal condition of the sensor NW by confirming the connection between the aggregation device and the adapter according to the second mode for embodying the present invention (embodiment 1);

FIG. 54 is an example of the vicinity sensor information according to the second mode for embodying the present invention (embodiment 1);

FIG. 55 is an example of the sensor data collection sequence in a normal state (without a fault with the sensor NW) according to the second mode for embodying the present invention (embodiment 1);

FIG. 56 is an example of the sequence among the function blocks of the aggregation device collecting the sensor data through the aggregation device which manages another sensor NW and transmitting the sensor data aggregated in the collecting server according to the second mode for embodying the present invention (embodiment 1);

FIG. 57 is an example of the detailed sequence in S251 through S253 in FIG. 56;

FIG. 58 is an example of the detailed sequence in S254 through S258 in FIG. 56;

FIG. 59 is an example of the entire sequence of transferring to another aggregation device the sensor data acquire request issued from the external sensor NW according to the second mode for embodying the present invention (embodiment 1);

FIG. 60 is an example of the detailed sequence in S261 through S262 in FIG. 59;

FIG. 61 is an example of the scheduling table according to the second mode for embodying the present invention (embodiment 2);

FIG. 62 is a block diagram of the function of the aggregation device according to the second mode for embodying the present invention (embodiment 3);

FIG. 63 is an example of the sensor operation state table according to the second mode for embodying the present invention (embodiment 3);

FIG. 64 is an example of the acquisition requested information table according to the second mode for embodying the present invention (embodiment 3);

FIG. 65 is a block diagram of the function of the adapter according to the second mode for embodying the present invention (embodiment 3);

FIGS. 66A and 66B are examples of the template file used when a sensor data acquire request is issued according to the second mode for embodying the present invention (embodiment 3);

FIGS. 67A and 67B are examples of the template file used when sensor data is transmitted according to the second mode for embodying the present invention (embodiment 3);

FIG. 68 is an example of the entire sequence when the sensor data is aggregated in the adapter according to the second mode for embodying the present invention (embodiment 3);

FIG. 69 is an example of the detailed sequence in S272 through S276 in FIG. 68; and

FIG. 70 is a block diagram of the configuration of the hardware environment of the computer according to the first or second mode for embodying the present invention.

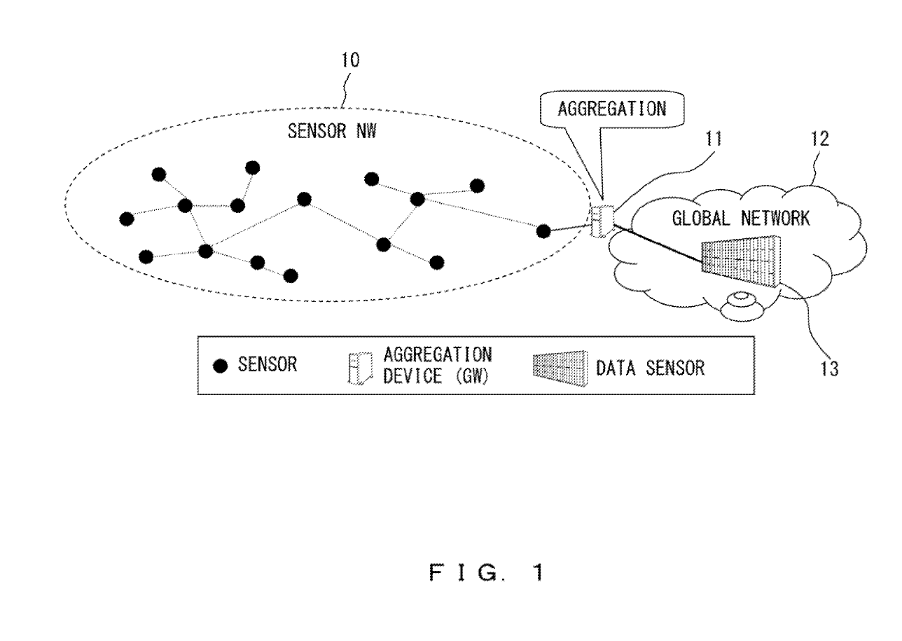

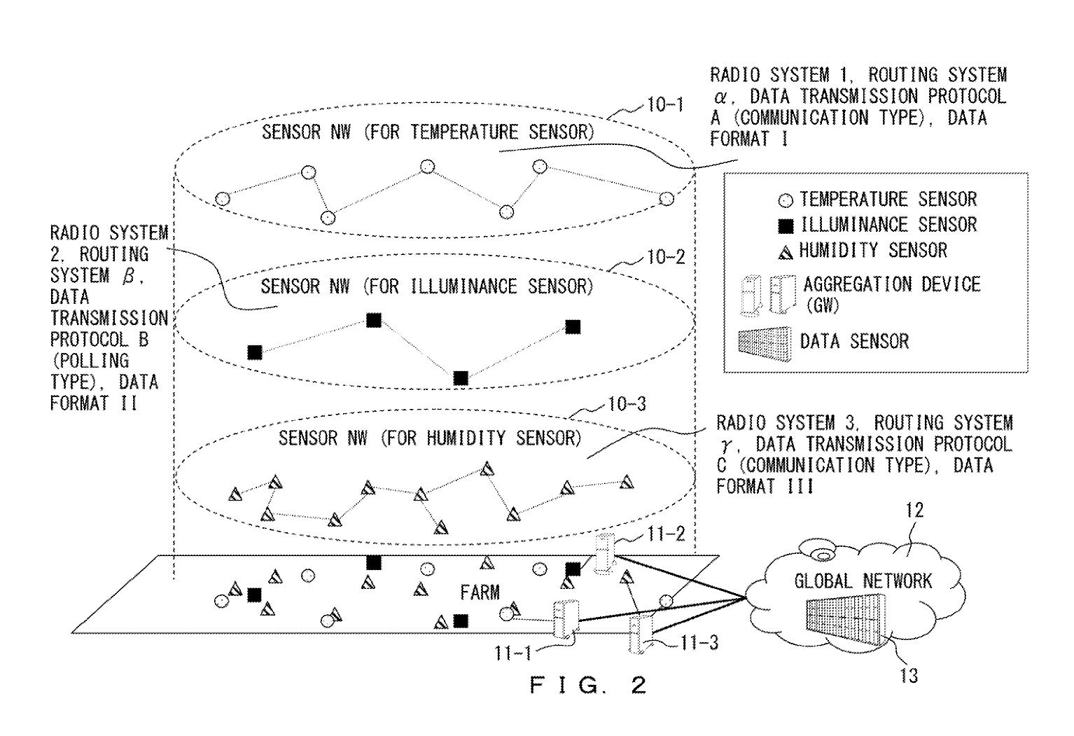

### DESCRIPTION OF EMBODIMENTS

Since a sensor is generally configured as an inexpensive device, it is subject to a fault by the exposure to wind and rain, a run-out buttery by a long-time operation, and a removal by a third party when it is placed in a field such as a farm, a pasture, etc. In addition, with a recent improved sensor technique, any user can easily use a sensor by connecting it to a network. Therefore, there occurs the problem of a theft of the sensor itself.

In this case, a sensor NW is divided with the boundary of the sensor which has become inoperable or has been stolen.

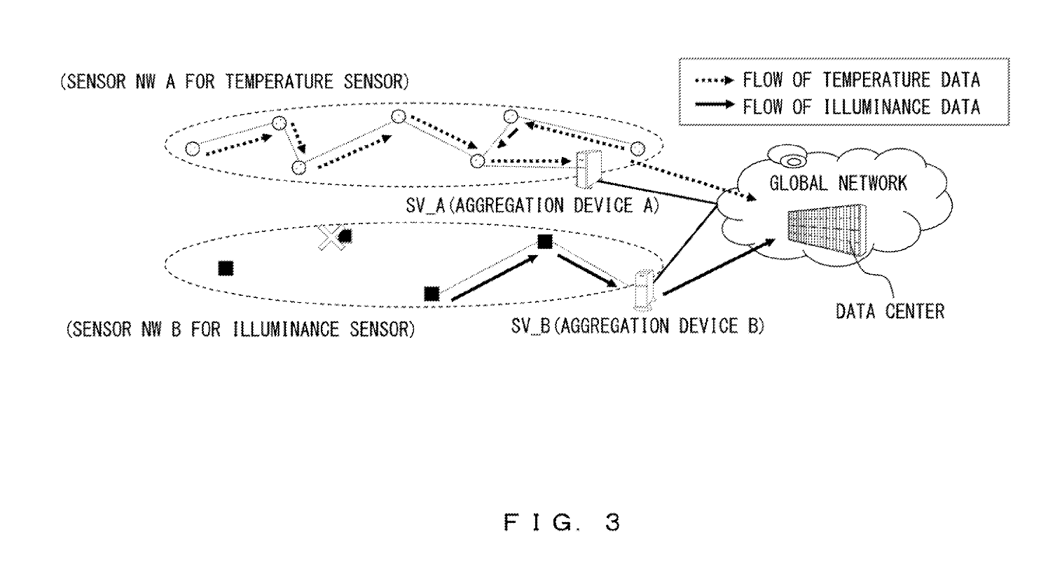

FIG. 3 illustrates the state in which the sensor NW is divided. In a sensor data collection system, the sensor NW is divided, and cannot collect sensor data from the sensor which has been disconnected from the aggregation device, thereby causing the trouble of losing sensor data in a part of region. FIG. 3 illustrates the state in which the sensor of an illuminance sensor network NW_B cannot be used and the sensor NW is divided. The sensor data of a normal sensor connected to the end of the unavailable sensor (x marked) in the illuminance sensor network NW_B cannot pass through the unavailable sensor. Thus, the sensor data of the normal sensor connected to the end of the unavailable sensor (x marked) cannot be collected by the aggregation device SV_B.

To solve the above-mentioned problem, the number of sensors has been conventionally increased to set a substitute path.

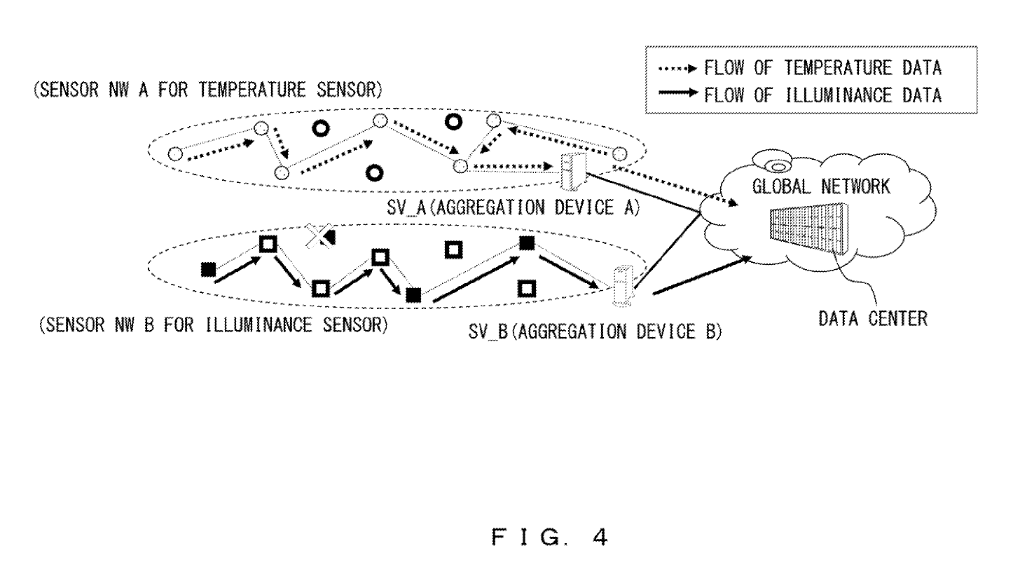

FIG. 4 illustrates the state of the sensor NW with which a substitute path is available by increasing the number of sensors. In FIG. 4, a sensor expressed as an unpainted circle or square indicates the sensor provided to supply a substitute path in the sensor NW. Normally, the sensor data is transmitted to the aggregation device through a path connecting sensors indicated by black painted circles or squares. In the illuminance sensor network NW_B, one of the sensors indicated by black painted squares is unavailable. In this case, the path connecting the sensors indicated by normal black painted squares incurs a sensor which cannot transmit sensor data. Then, the sensor data is transmitted through a communication path connecting the sensors indicated by unpainted squares which supply a substitute path.

However, in this case, the number of the sensors is wastefully increased because the sensors are arranged in places where it is not necessary to collect sensor data.

Furthermore, as for the agriculture field, the sensor data to be collected depends on the type of crop or the growing process. For example, in the growing process of rice, it is necessary to measure the level of water using a water level sensor in the early stage, but it is not necessary at maturity. That is, even on the same farm, the type of sensor to be used depends on the growing stage of crop. Therefore, it is necessary to use a sensor data collection system flexibly corresponding to the type of sensor and the replacement timing.

Provided below in the following modes for embodying the present invention is a sensor data collection system capable of collecting sensor data although there is an unavailable sensor in the sensor NW.

### First Mode for Embodying the Present Invention

### Embodiment 1

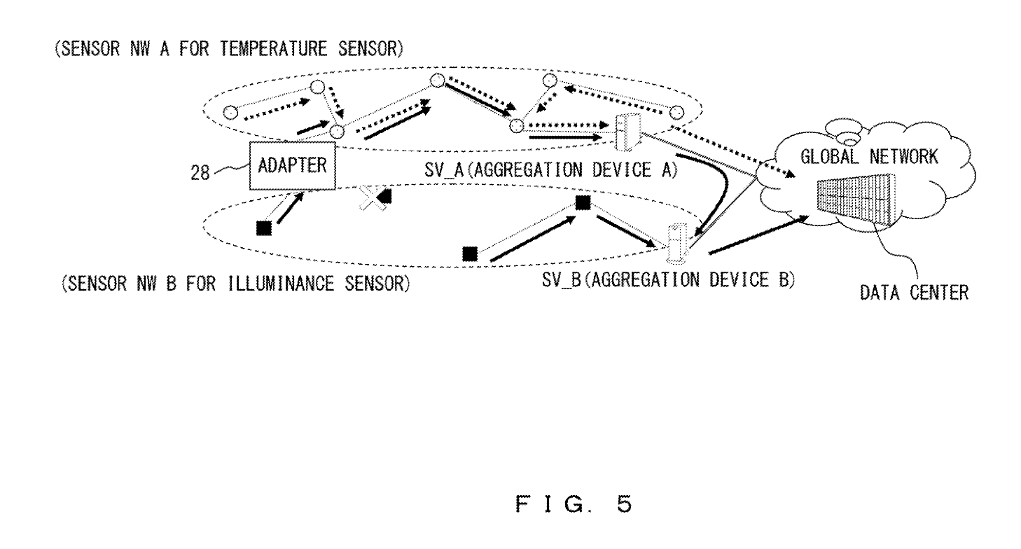

FIG. 5 is an explanatory view of the first mode for embodying the present invention. In the present mode for embodying the invention, an adapter 28 connected to a plurality of sensor NWs is provided among the sensor NWs to communicate sensor data among them. To the aggregation device, a transfer function is added for transferring sensor data to the aggregation device of another sensor NW using a global network.

The sensor data in the sensor NW_B in which an abnormal condition has occurred is transmitted to the aggregation device SV_A of another sensor NW_A through the adapter 28. After the sensor data has reached the aggregation device SV_A of the other sensor NW_A is transferred to the original aggregation device SV_B (aggregation device of the sensor NW in which an abnormal condition has occurred) through the global network. Thus, the sensor data can be continuously collected even when the abnormal condition has occurred in the sensor NW.

The adapter 28 manages the identifier on the sensor NW side (=LAN (local area network) side) and the identifier (IP address) on the global network side (=WAN (wide area network) side) of each aggregation device. The adapter 28 can be connected to a plurality of sensor NWs (a plurality of adapters 28 can also be connected to one sensor NW).

When there occurs an abnormal condition in a sensor NW, the adapter 28 makes one or more sensors in the network change the destination of the sensor data to itself (adapter). When the sensor NW recovers to its normal state, the adapter 28 makes the sensor change the destination to the original aggregation device.

When there are a plurality of candidates for a sensor NW to which sensor data is to be transferred, the adapter 28 selects the optimum sensor NW for the sensor data to be transferred.

To transfer sensor data, the adapter 28 performs a protocol conversion (communication layer) and a data conversion/wrapping (by application layer) based on the sensor NW to which sensor data is to be transferred. In this case, the adapter 28 adds the information about the sensor data of another sensor NW, that is, the original destination (WAN side IP address of the aggregation device of the sensor NW in which an abnormal condition has occurred), to the converted sensor data.

The sensor NW from which sensor data is transferred and the sensor NW to which the sensor data is transferred may have different data formats (message formats) and protocols for transmitting sensor data.

To successfully transmit the sensor data in the situation, it is necessary to convert the data format based on the sensor NW to which the data is to be transferred. Then, the adapter 28 converts the data format of the sensor data according to the preset rule information.

According to the present mode for embodying the invention, a plurality of sensor NWs having different communication systems are connected to one another as necessary using the adapter 28 so that the sensor data can be transferred using another sensor NW. Furthermore, according to the present mode for embodying the invention, the sensor data can be transferred through another sensor NW even if the communication quality of the sensor NW has been degraded.

The aggregation device has the following function. The aggregation device receives sensor data, and determines whether the received sensor data is the sensor data to be managed or the sensor data not to be managed (the sensor data to be managed by another sensor NW).

When the received sensor data is the sensor data of another sensor NW, the aggregation device extracts the original destination (WAN side IP address of the aggregation device of the sensor NW in which an abnormal con has occurred) from the sensor data. The aggregation device transfers the received sensor data to the original aggregation device using the global network.

With the above-mentioned configuration, sensor data can be transferred using an adjacent sensor NW when there occur a fault or a removal of a sensor, a division of a sensor NW by a theft, and the degradation of the quality of the sensor NW. Therefore, the collection of sensor data can be prevented from being stopped for a long time, and the delay of sensor data collecting timing due to the congestion of a specific sensor NW can be avoided.

Since the necessary sensor data is transferred to the adjacent sensor NW, the effect on the sensor NW to which the sensor data is to be transferred can be minimized.

Since the sensor which has divided a network due to a fault etc. can be specified, it is not necessary to search for the sensor, and a sensor can immediately be a replacing or an additional sensor, thereby maintaining a continuous operation. On the other hand, the range of the effect of the faulty sensor on another sensor can be specified using an alternative path. Therefore, for example, in a sensor intensive environment, it can be determined that the replacement of a sensor is not required if the sensor data of an adjacent sensor can be collected through an alternative path.

Furthermore, since it is not necessary to determine the contents of different types of sensor data in an aggregation device, it is also not necessary to make a development based on the contents of sensor data or to make a development depending on the increase or decrease of the number of sensors, thereby successfully reducing the development cost.

In addition, for example, it is also possible to transfer sensor data using a sensor NW having enough room in the network having a sensor not collecting sensor data at night, having congestion, etc. on a priority basis.

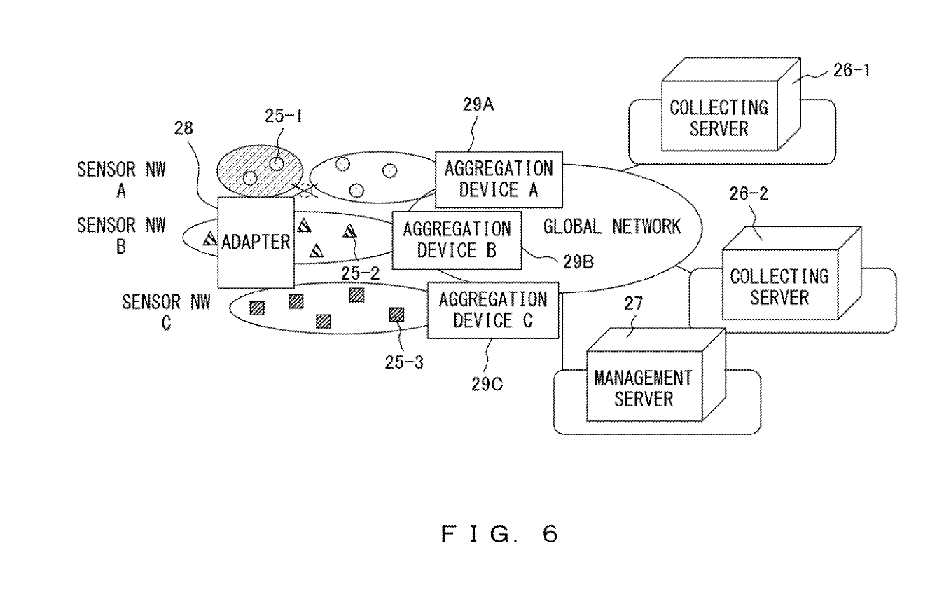

FIG. 6 is a configuration of the entire system according to the first mode for embodying the present invention. The system according to the present mode for embodying the invention includes a sensor 25 (25-1, 25-2, 25-3), a collecting server 26 (26-2, 26-2), a management server 27 (adapter 28), and aggregation devices A through C (29A through 29C).

In FIG. 6, the sensor NW A is formed by the sensor 25-1. The sensor NW B is formed by the sensor 25-2. The sensor NW C is formed by the sensor 25-3. The aggregation devices A through C are provided respectively for the sensors NW A, NW B, and NW C.

The sensor 25 (25-1, 25-2, 25-3) collects sensor data by sensing the data through the sensor NW, and transmits the collected sensor data to the aggregation device of the specified identifier. The collected sensor data can be various types of data such as the temperature, the humidity, the illuminance, etc. In addition, a sensor 25 has the function of transferring the sensor data transmitted from another sensor 25. Furthermore, the sensor 25 has the function of receiving from an external unit a change of the destination (identifier of an aggregation device) to which sensor data is to be transmitted. Additionally, the sensor 25 has the function of receiving from an external unit an instruction to start and terminate the transmission of sensor data.

The collecting server 26 (26-2, 26-2) receives aggregated sensor data transmitted from an aggregation device 29, and accumulates, processes, and provides the sensor data.

The management server 27 receives sensor management information transmitted from the aggregation device, and manages the sensor 25.

The adapter 28 is connected to a plurality of sensor NWs, and performs polling of a path to an aggregation device in each sensor NW, thereby managing the connection of the sensor NW. The adapter 28 acquires and manages the list of the sensors belonging to a specific aggregation device, and the communication state of the sensor NW by the polling of the path to the aggregation device. Additionally, when a sensor NW is divided and the communication quality is degraded, the adapter 28 transfers the sensor data of the sensor NW to the aggregation device of another sensor NW. One or more adapters 28 are arranged in the sensor NW or between the sensor NWs.

The aggregation devices A through C have the function of aggregating (temporarily holding in a storage unit) the sensor data of the sensor NW managed by the devices respectively. The aggregation devices A through C also have the function of notifying the collecting servers 26-2 and 26-2 of the aggregated sensor data. Furthermore, the aggregation devices A through C have the function of managing the communication state of the sensor NW from the collecting state of the sensor data (the amount of received sensor data, the time intervals of the notified sensor data, etc.). In addition, the aggregation devices A through C have the function of transferring the sensor data of another sensor NW received from the adapter 28 to the aggregation device in charge of the sensor NW.

Furthermore, the aggregation devices A through C manage the management information about the state of the sensor managed by the devices respectively in the sensor NW according to the information about whether the sensor data has been directly acquired from the sensor NW managed by the devices respectively or the sensor data has been acquired through another sensor NW and aggregation device. The aggregation devices A through C periodically notify the management server 27 of the management information.

In response to the polling of the adapter 28, the aggregation devices A through C returns the information about the identifier (IP address) of the global network side of the respective devices, a list of the sensors managed by the respective devices, and the state of the communication quality of the sensor NW.

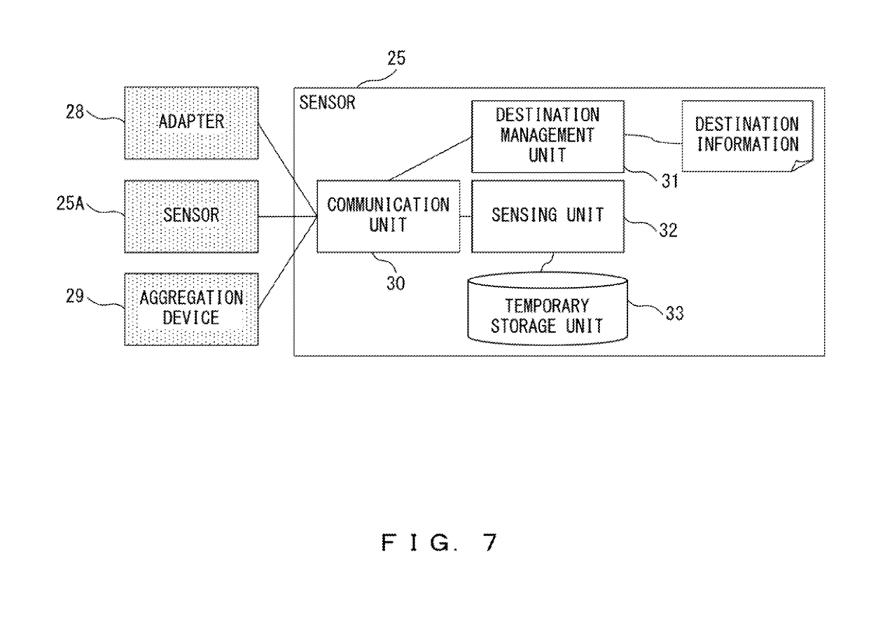

FIG. 7 is a block diagram of the function of the sensor according to the first mode for embodying the present invention. For the sensor 25, the destination of the sensor data can be set through a network.

A communication unit 30 transmits sensor data to the adapter 28 and the aggregation device 29, or transfers the data of another sensor 25A. In addition, the communication unit 30 accepts the change message of the destination of the sensor data.

A destination management unit 31 manages the destination information about the sensor data sensed by a sensing unit 32. The change of the destination information can be performed through a network.

The sensing unit 32 performs sensing on the amount of observation. An object to be sensed depends on the type of the sensor 25. The sensed sensor data is held by a temporary storage unit 33 until it is transmitted to the adapter 28, another sensor 25A, or the aggregation device 29.

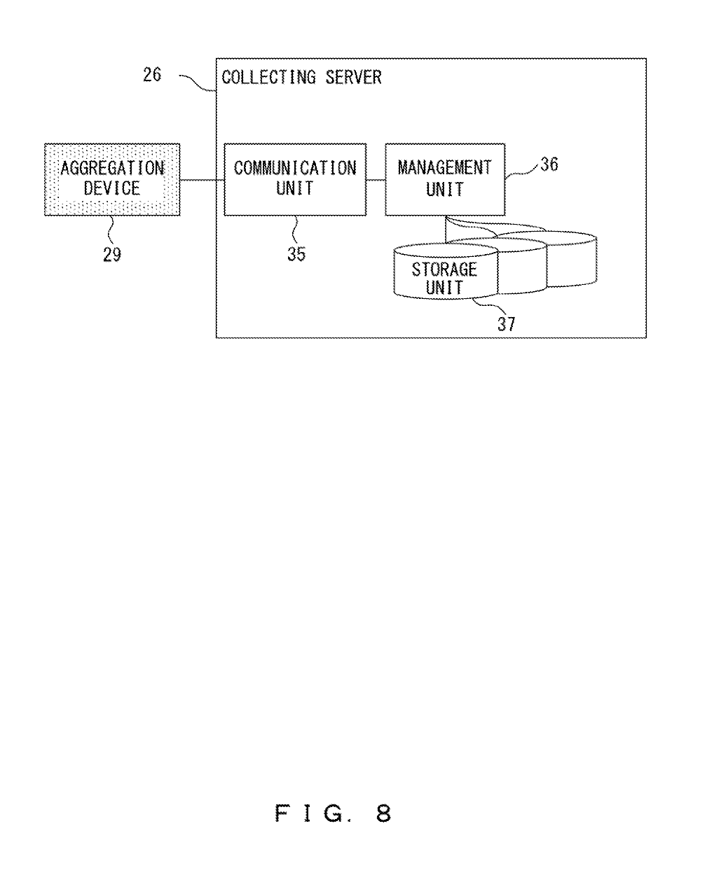

FIG. 8 is a block diagram of the function of the collecting server according to the first mode for embodying the present invention. A communication unit 35 receives aggregated sensor data from the aggregation device 29, and notifies a management unit 36 of the received data. The communication unit 35 also receives a request to acquire sensor data, and issues a sensor data acquire request to the management unit 36.

The management unit 36 stores the sensor data notified from the communication unit 35 in a storage unit 37. The management unit 36 also acquires the sensor data requested by the communication unit 35 from the storage unit 37, and returns the data to the communication unit 35.

The storage unit 37 is a database for management of the sensor data. The storage unit 37 can also be configured for distributed storage using a plurality of databases.

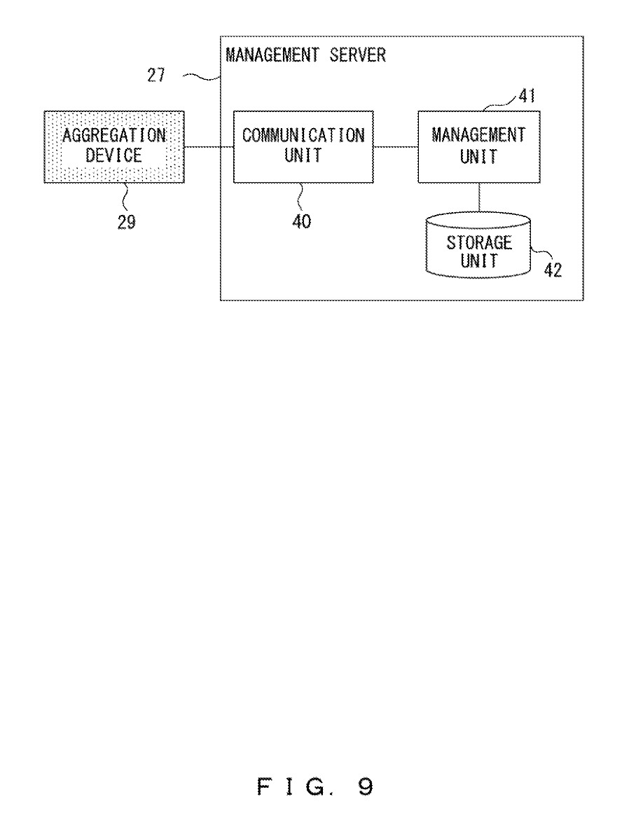

FIG. 9 is a block diagram of the function of the management server according to the first mode for embodying the present invention. A communication unit 40 receives the sensor management information aggregated by the aggregation device 29, and notifies a management unit 41 of the reception of the information. The management unit 41 stores the sensor management information notified from the communication unit 40 in a storage unit 42. The storage unit 42 is a database for management of the sensor management information.

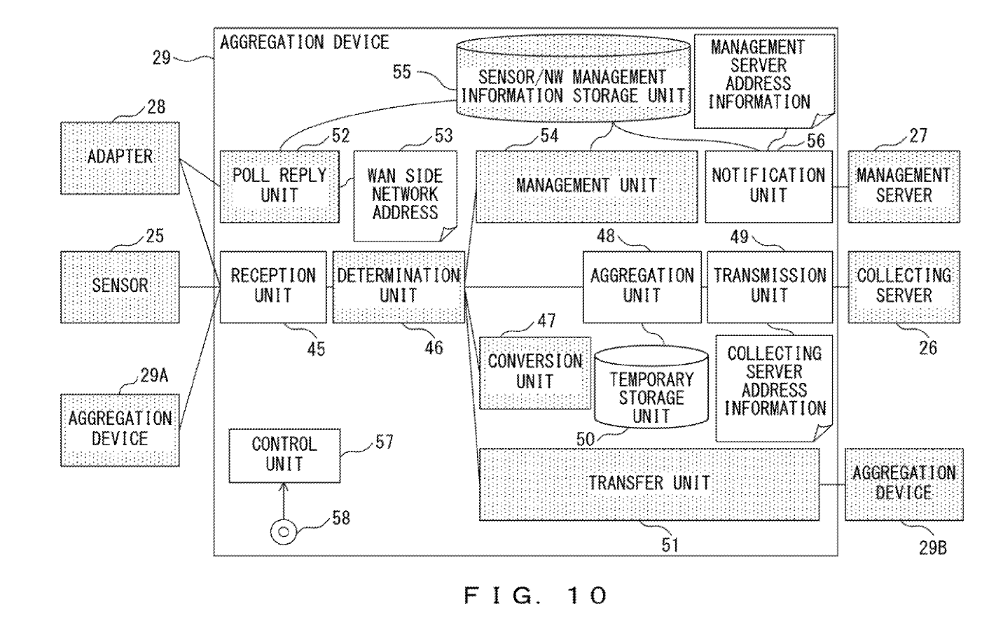

FIG. 10 is a block diagram of the function of the aggregation device according to the first mode for embodying the present invention (embodiment 1). The aggregation device 29 includes the function blocks of a reception unit 45, a determination unit 46, a conversion unit 47, an aggregation unit 48, a transmission unit 49, a temporary storage unit 50, a transfer unit 51, a poll reply unit 52, a management unit 54, a sensor/NW management information storage unit 55, a notification unit 56, and a control unit 57.

The poll reply unit 52 receives a poll request message (poll request) from the adapter 28, and transmits a poll response message (poll reply) to the adapter 28. The poll response message includes the global network side IP address of the aggregation device 29, a sensor list, and the communication quality of the sensor NW.

The reception unit 45 receives sensor data from the sensor 25, the adapter 28, or another aggregation device 29A, and notifies the determination unit 46 of the received sensor data.

The determination unit 46 determines the sensor data received from the reception unit 45, and determines the next process. If the sensor data received from the reception unit 45 is the sensor data of the sensor NW managed by the determination unit 46 itself (if the sensor data is received from the sensor of the sensor NW managed by the unit itself), then the determination unit 46 passes the sensor data to the aggregation unit 48. If the sensor data received from the reception unit 45 is the sensor data of the sensor NW managed b the unit itself, and received from another aggregation device 29A, the determination unit 46 passes the sensor data to the conversion unit 47. If the sensor data received from the reception unit 45 is the sensor data of the sensor NW not managed by the unit itself (but received from the adapter 28), the determination unit 46 passes the sensor data to the transfer unit 51. The determination unit 46 passes a copy of the sensor data to the management unit 54 regardless of the determination result on the sensor data.

The conversion unit 47 converts the sensor data from the data format used in the aggregation device 29 into the data format of the sensor NW managed by the unit itself.

The transfer unit 51 extracts from the sensor data the IP address of the aggregation device to which the data is to be transferred, and transfers the sensor data to another aggregation device 29B using the global network.

The aggregation unit 48 aggregates the sensor data collected from the sensor NW, temporarily stores the sensor data in the temporary storage unit 50, and then passes the data to the transmission unit 49.

The transmission unit 49 notifies the collecting server 26 of the sensor data aggregated by the aggregation unit 48 by referring to the address information about the collecting server 26.

The management unit 54 manages the operation state of each sensor in the sensor NW based on the acquired sensor data. The management unit 54 performs the state management as follows. When the sensor data is directly acquired from the sensor NW managed by the management unit 54 itself, it manages the sensor by assuming that the sensor 25 which has transmitted the sensor data is normally operating. If the sensor data is acquired through another aggregation device, the management unit 54 manages the sensor by assuming that the sensor 25 which has transmitted the sensor data is normally operating. If no sensor data is acquired, the management unit 54 manages the sensor by assuming that the sensor 25 is not normally operating.

The management unit 54 manages the communication quality state of the sensor NW based on the acquired sensor data. The management unit 54 manages the state of the communication quality of the sensor NW as follows. If the amount of the sensor data directly acquired from the sensor NW managed by the management unit 54 itself is larger than the expected amount, the management unit 54 manages the sensor NW by assuming that the communication quality of the sensor NW has been degraded. When the time interval of the notice of the sensor data from the sensor managed by the unit itself is longer than the estimated value, the management unit 54 manages the sensor NW by assuming that the communication quality of the sensor NW has been degraded. When the amount of the sensor data and the time interval of the notice of the sensor data are higher than the estimated values, the management unit 54 compares the threshold preset by the system designer with the values, and determines the communication quality state of the sensor NW.

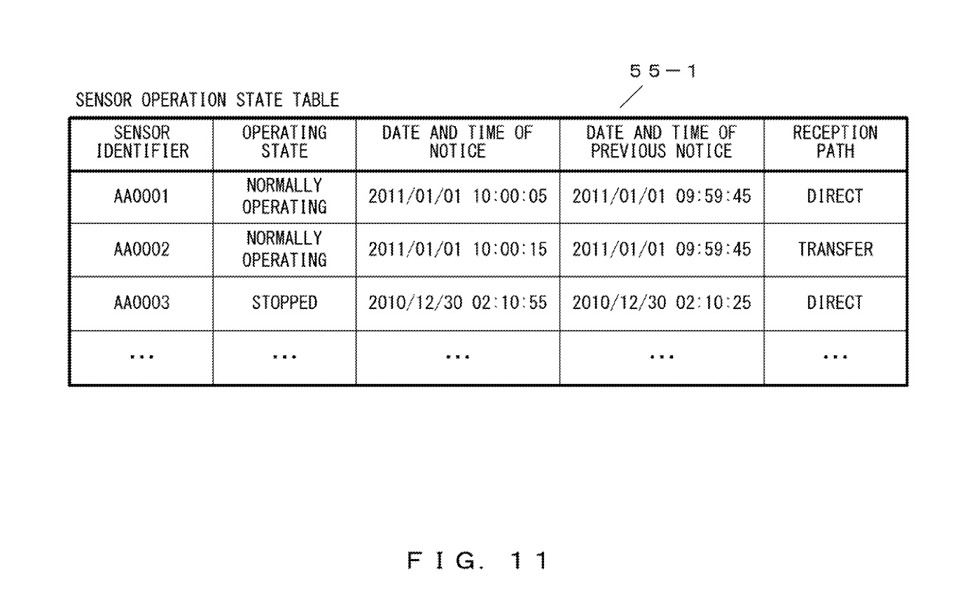

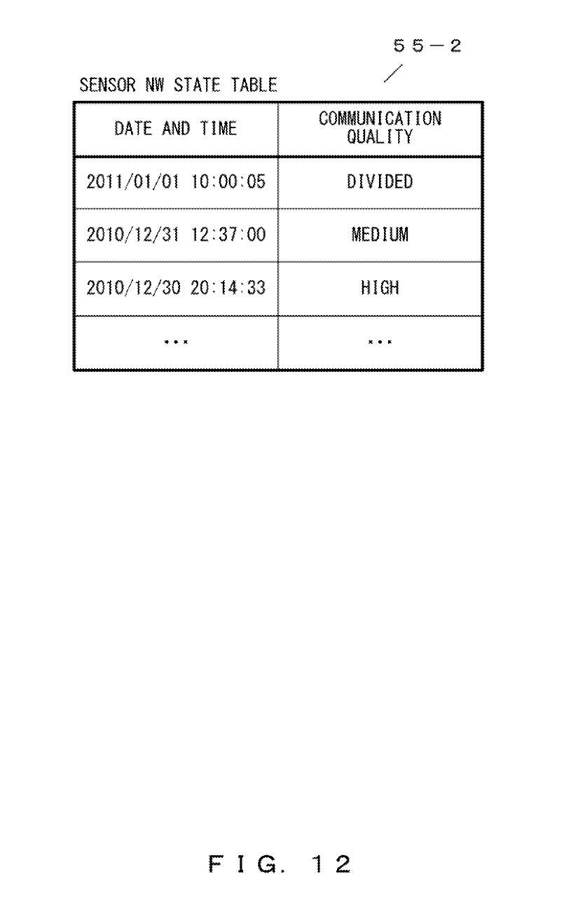

FIGS. 11 and 12 are examples of the sensor/NW management information held by the sensor/NW management information storage unit 55. The sensor/NW management information storage unit 55 is a database storing sensor/NW management information (sensor operation state table 55-1, sensor NW state table 55-2).

FIG. 11 is an example of a sensor operation state table according to the first mode for embodying the present invention (embodiment 1). The sensor operation state table 55-1 holds the data of the operating state of a sensor. The data of the operating state of a sensor indicates, as illustrated in FIG. 11, the sensor identifier, the operating state, the date and time of notice, the previous date and time of notice, and the reception path. The operating state indicates whether or not the sensor 25 is normally operating in the operation of itself, whether or not an error has occurred, etc. The reception path indicates whether the sensor data has been transferred through another aggregation device or directly transmitted from the sensor 25. The date and time of notice indicates the date and time of notice of sensor data. The previous date and time of notice indicates the date and time of the previous notice of the sensor data. The notice time interval of the sensor data can be obtained by referring to the date and time of notice and the date and time of the previous notice.

FIG. 12 is an example of the sensor NW state table according to the first mode for embodying the present invention (embodiment 1). The sensor NW state table 55-2 holds the communication quality of the sensor NW. The data of the sensor NW state includes the date and time and the communication quality as illustrated in FIG. 12. The date and time indicates the date and time of notice of the sensor data. The communication quality indicates the quality of the communication on the sensor NW. The communication quality is used when it is determined whether or not the communication quality has been degraded etc. when the amount of sensor data of the sensor NW is large. In this case, the determination of the communication quality as medium or high is made by a system designer comparing the threshold appropriately set by a system designer with the amount of sensor data.

The description is continued as follows with reference back to FIG. 10. The notification unit 56 periodically notifies the management server 27 of the sensor/NW management information (sensor operation state table, sensor NW state table) managed by the management unit 54. The notification unit 56 transmits the information with reference to the address information about the management server held in advance.

The operation of each unit illustrated in FIG. 10 can be realized by a program. In this case, the control unit 57 which controls the entire system can realize the operation by executing a program. The program can be stored in a portable recording medium 58 such as CD-ROM, DVD, Blu-ray, IC memory, a flexible disk, etc. In this case, the control unit 57 reads the program from the portable recording medium 58 and executes it.

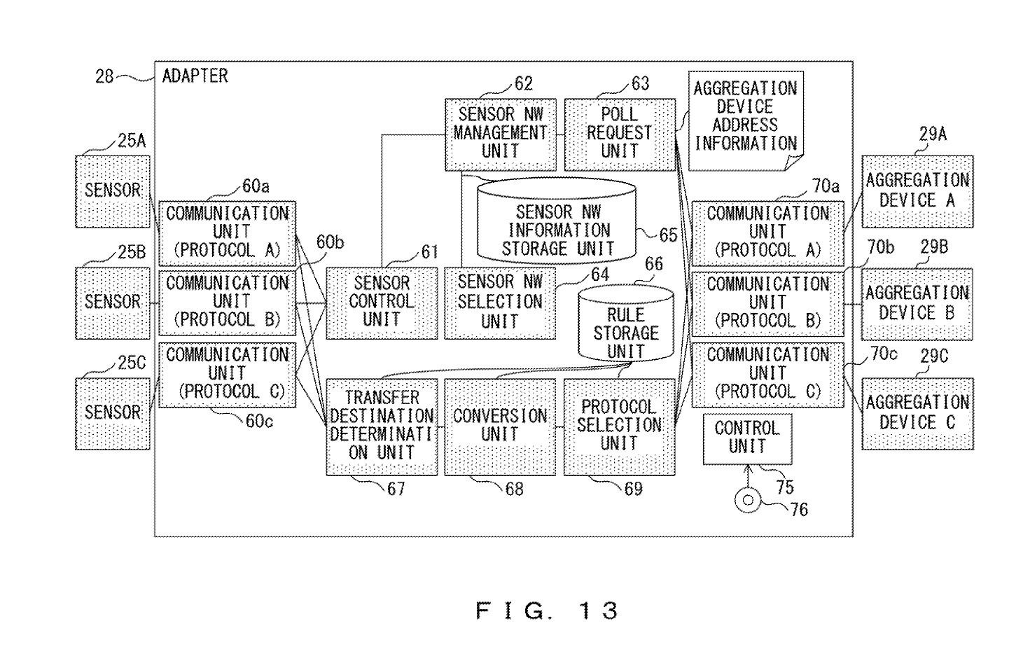

FIG. 13 is a block diagram of the function of the adapter according to the first mode for embodying the present invention (embodiment 1). The adapter 28 includes a poll request unit 63, a sensor NW management unit 62, a sensor NW information storage unit 65, a sensor NW selection unit 64, a rule storage unit 66, a sensor control unit 61, a transfer destination determination unit 67, and a conversion unit 68. The adapter 28 also includes a protocol selection unit 69 and communication units 60a through 60c, and 70a through 70c.

the poll request unit 63 periodically performs polling to the aggregation devices A through C of each sensor NW capable of communicating (being connected to) the adapter 28, and confirms the reception of sensor data at the aggregation devices A through C. The poll request unit 63 notifies the sensor NW management unit 62 of the poll result.

When the polling can be normally performed, the poll request unit 63 notifies the sensor NW management unit 62 of the global network side IP address of the aggregation device, a sensor list, and the communication quality of the sensor NW as the poll reply information. If the polling fails, the poll request unit 63 notifies the sensor NW management unit 62 of the abnormal polling.

The sensor NW management unit 62 updates the sensor NW information about the sensor NW information storage unit 65 based on the poll result received from the poll request unit 63. Thus, the sensor NW management unit 62 grasps the state of the sensor NW connected to the adapter 28. If a sensor NW is divided, and the polling fails to reach the aggregation device 29 (an abnormal polling notice is received), then the sensor NW management unit 62 notifies the sensor NW selection unit 64 of the result. The sensor NW selection unit 64 specifies another sensor NW to which the sensor data of the divided sensor NW is to be transferred. Furthermore, to control the sensors 25A through 25C in the divided sensor NW, the sensor NW management unit 62 notifies the sensor control unit 61 of a request to change the aggregation device 29.

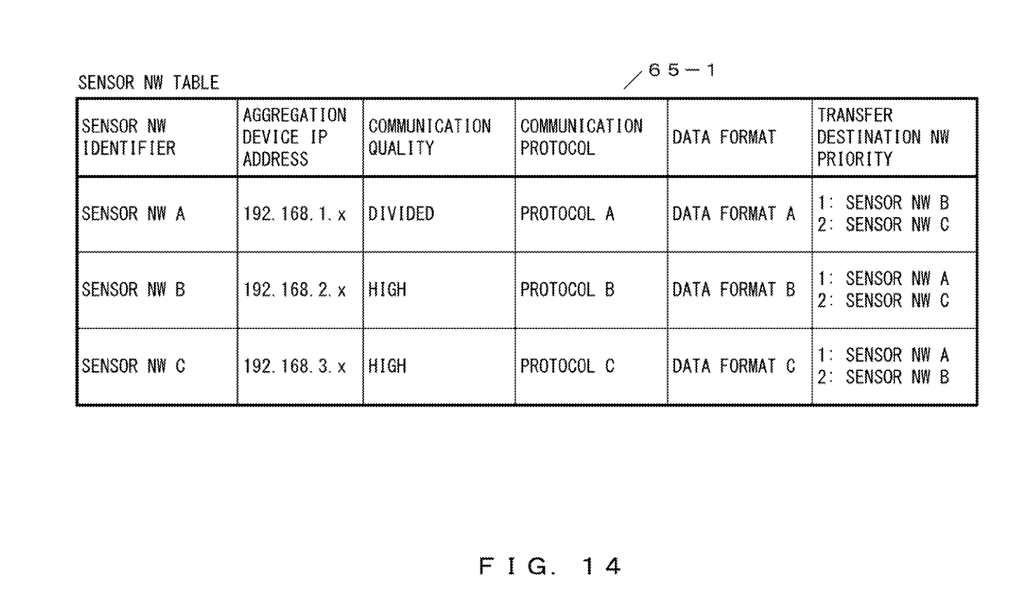

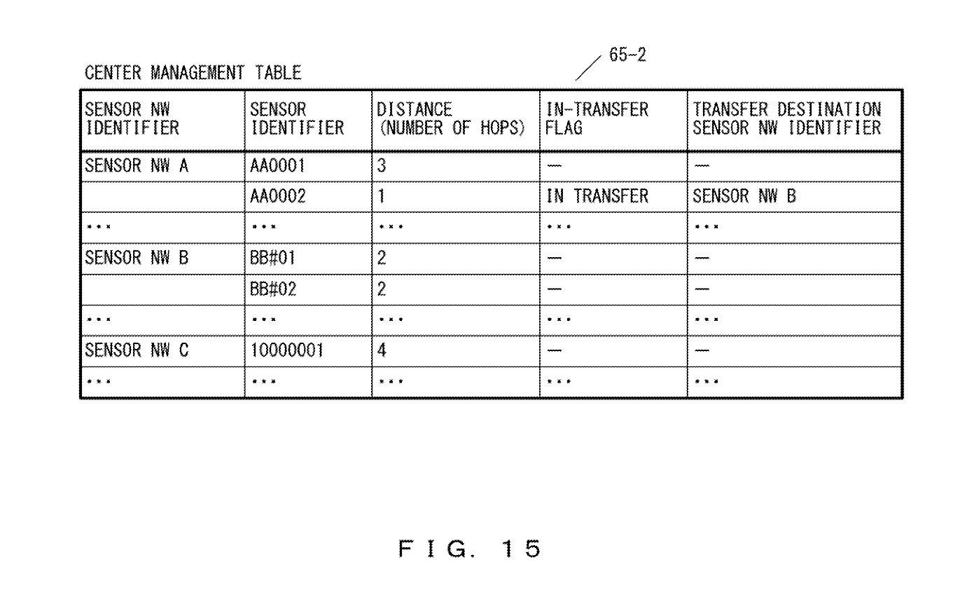

If the communication quality of a sensor NW has been degraded (the communication quality of polling information has been degraded), the sensor NW management unit 62 notifies the sensor NW selection unit 64 of the information. The sensor NW selection unit 64 specifies another sensor NW to which the sensor data of the sensor NW whose quality has been degraded is to be transferred. The sensor NW selection unit 64 specifies the sensor to which the sensor data is to be transferred (to the sensor 25 closer the adapter 28 the data is to be transfer) based on the sensor NW information stored in the sensor NW information storage unit 65. Then, since the sensor NW management unit 62 controls the sensor 25 in the divided sensor NW, it notifies the sensor control unit 61 of a notice of a request to change the aggregation device 29. In addition, the sensor NW management unit 62 updates the sensor NW information based on the sensor data received from the sensor control unit 61. An example of the sensor NW information includes a sensor NW table and a center management table. An example of the sensor NW information stored in the sensor NW information storage unit 65 (sensor NW table, center management table) is described below with reference to FIGS. 14 and 15.

FIG. 14 is an example of the sensor NW table according to the first mode for embodying the present invention (embodiment 1). A sensor NW table 65-1 includes a sensor NW identifier, an IP address, communication quality, a communication protocol, a data format, and a transfer destination NW priority.

The sensor NW identifier identifies a sensor NW. The IP address refers to an aggregation device corresponding to the sensor NW. The communication quality refers to the current communication quality of the sensor NW. The communication protocol refers to the communication protocol used by the sensor NW. The data format refers to the data format used by the sensor NW. The transfer destination NW priority lists the transfer destination NWs assigned the respective priorities. The sensor NW information other than the communication quality is stored in advance by checking each piece of information when a network is set.

FIG. 15 is an example of the sensor management table according to the first mode for embodying the present invention (embodiment 1). A center management table 65-2 includes a sensor NW identifier, a sensor identifier, the number of hops from the adapter to the sensor, an in-transfer flag indicating whether or not the transfer is being performed, and an identifier of the sensor NW to which the data is to be transferred. The in-transfer flag indicates that there is a sensor unavailable in the current sensor NW, and the sensor data is transferred through the divided network.

The following description is given with reference back to FIG. 13. The sensor NW selection unit 64 selects the optimum sensor NW for connection to the divided sensor NW from the sensor NW table 65-1, generates conversion rule information, and stores the information in the rule storage unit 66. When selecting a sensor NW, the sensor NW selection unit 64 determines the sensor NW from the transfer destination NW priority and the communication quality from the sensor NW information.

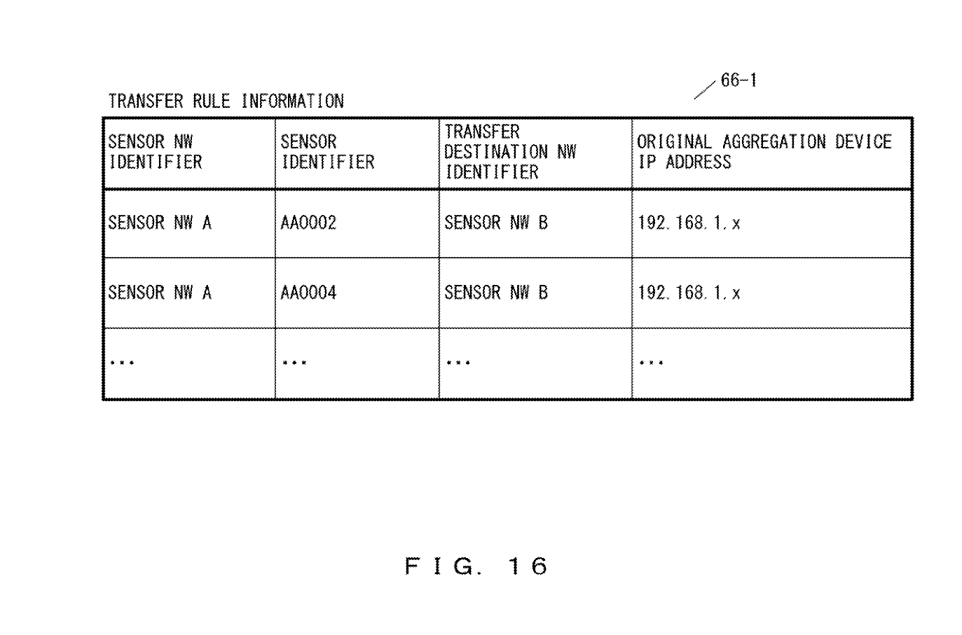

The rule storage unit 66 is a database for management of the transfer rule information for transfer of sensor data and the conversion rule information (template file) for conversion of a data format. The transfer rule information is stored in the transfer rule table. The conversion rule information is stored in the conversion rule table. The transfer rule table and the conversion rule table are described below with reference to FIGS. 16 through 19.

FIG. 16 is an example of the transfer rule table according to the first mode for embodying the present invention (embodiment 1). A transfer rule table 66-1 includes the identifier of a sensor NW, the identifier of a sensor, the identifier of a transfer destination NW, and the IP address of the original aggregation device. The aggregation device which is to collect and aggregate the sensor data of the sensor NW in which a fault has occurred is referred to as an original aggregation device.

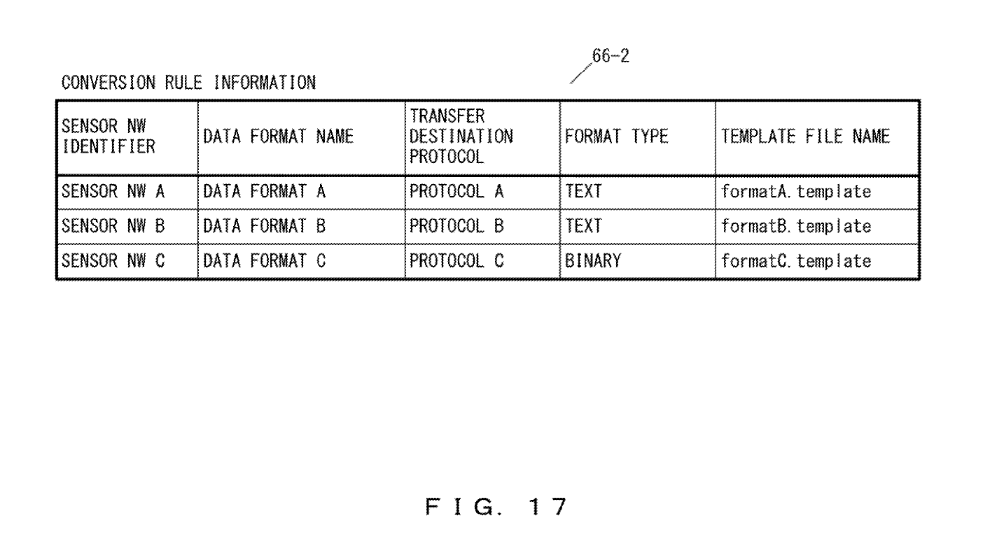

FIG. 17 is an example of the conversion rule table according to the first mode for embodying the present invention (embodiment 1). As illustrated in FIG. 17, a conversion rule table 66-2 includes the identifier of a sensor NW, the name of the data format being used, the protocol of the transfer destination device, the type of a format, and the template file name for conversion of the format.

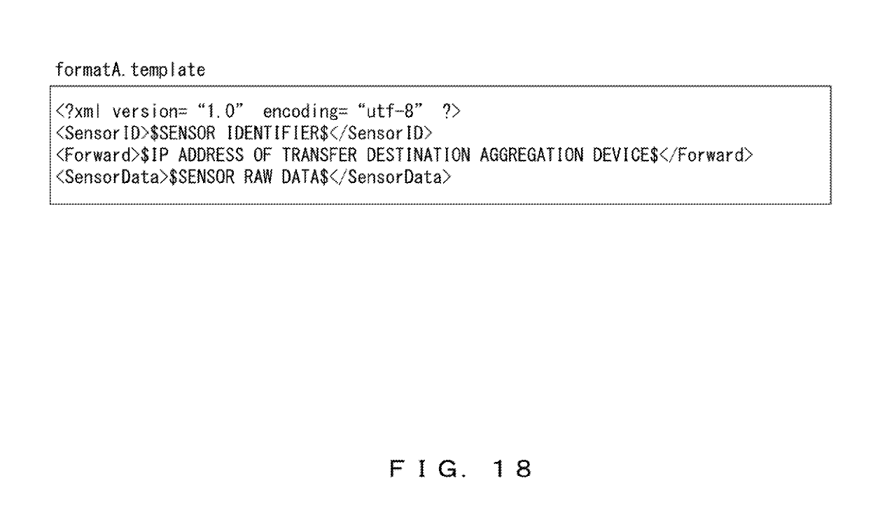

As an example of a template file, an example in format A is illustrated in FIG. 18, and an example in format B is illustrated in FIG. 19. The format A is described in XML as enclosing a sensor identifier, the IP address of a transfer destination aggregation device, and a sensor raw data by tags. The format B is described in text form of a sensor identifier, the IP address of a transfer destination aggregation device, and sensor raw data in more direct form than the format A. Since the format C refers to binary data, and is not specifically described here.

Although the format of data is exemplified here, but the designer of the system is to appropriately set it.

The description is given with reference back to FIG. 13. The sensor control unit 61 periodically collects the topology information about each sensor NW (the number of hops from the adapter 28 of each sensor 25), and notifies the sensor NW management unit 62 of the information. When an aggregation device change request is received from the sensor NW management unit 62, the sensor control unit 61 transmits an aggregation device change message to the sensor 25, and changes the identifier of the aggregation device 29 of each sensor 25. When the change of the identifier of the aggregation device 29 of each sensor 25 is normally performed, the sensor control unit 61 notifies the sensor NW management unit 62 of the identifier of the sensor 25 in which a change has been completed.

The transfer destination determination unit 67 determines the transfer destination of the sensor data according to the transfer rule table 66-1.

The conversion unit 68 converts the data format of the sensor data according to the conversion rule table 66-2. The conversion unit 68 notifies the protocol selection unit 69 of the converted sensor data.

Upon receipt of the sensor data from the conversion unit 68, the protocol selection unit 69 selects the communication protocol for transmitting the sensor data according to the conversion rule table 66-2. The protocol selection unit 69 issues a sensor data transmit request to the communication units 70a through 70c in charge of the selected communication protocol.

The communication units 70a through 70c communicate sensor data and control information with the aggregation device 29 (29A, 29B, 29C).

The operation of each unit illustrated in FIG. 13 can be realized by a program. In this case, a control unit 75 for controlling the entire system can realize the operation by executing the program. The program can be stored in a portable recording medium 76 such as CD-ROM, DVD, Blu-ray, IC memory, a flexible disk, etc. In this case, the control unit 75 reads the program from the portable recording medium 76 and executes it.

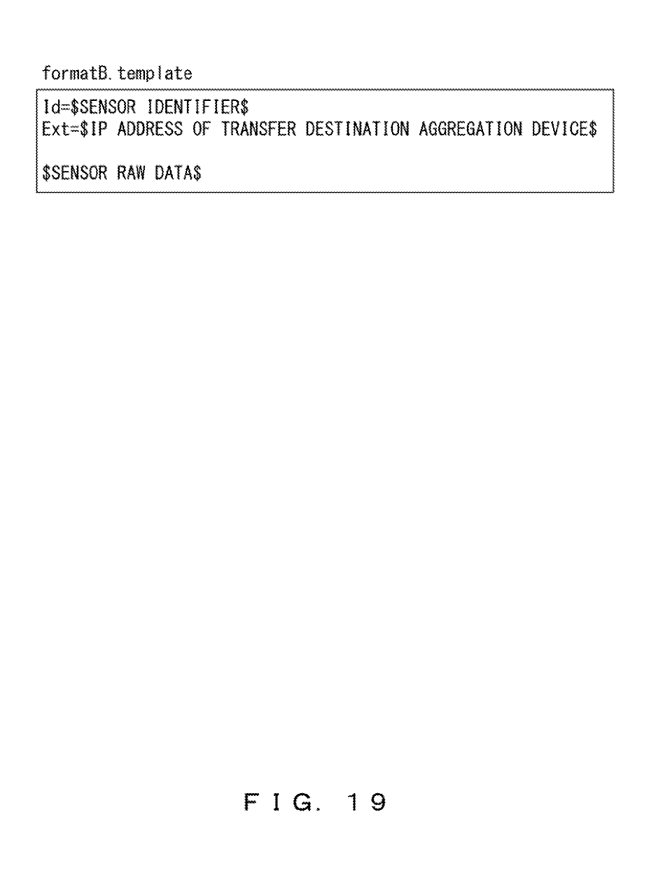

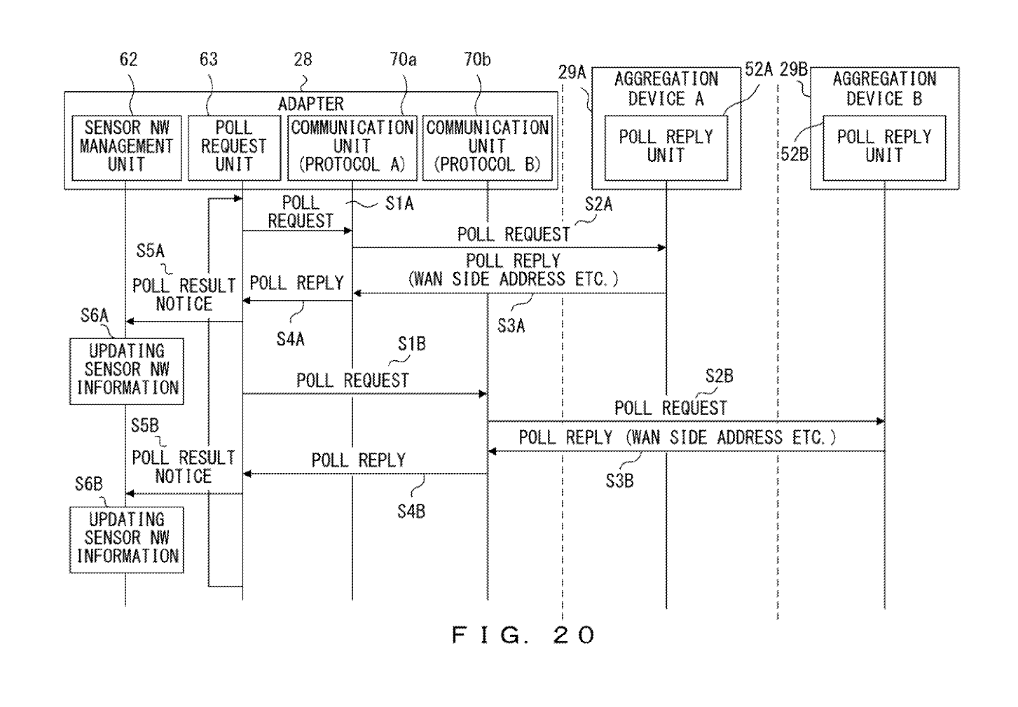

FIG. 20 is an example of the sensor NW monitor sequence according to the first mode for embodying the present invention (embodiment 1). FIG. 20 illustrates the sequence of the adapter 28 detecting (monitoring the sensor NW) an abnormal condition of the sensor NW based on the poll reply result from the aggregation device 29. The adapter 28 monitors the state of the sensor NW by periodically performing polling to the aggregation device 29 capable of communicating with the adapter 28.

The poll request unit 63 of the adapter 28 transmits the information (poll request) about a poll request to the aggregation device A (29A) (S1A, S2A). In this example, since the aggregation device A (29A) uses a protocol A, the communication unit 70a for the protocol A is used.

Upon receipt of the poll request transmitted from the adapter 28, the poll reply unit 52A of the aggregation device A (29A) returns the reply information (poll reply) in response to the poll request (S3A).

Upon receipt of the poll reply from the aggregation device A (29A), the communication unit 70a of the adapter 28 notifies the poll request unit 63 of the poll reply (S4A). According to the poll reply, the poll request unit 63 notifies the sensor NW management unit 62 of the poll result (S5A). Based on the poll result, the sensor NW management unit 62 updates the sensor NW information (S6A). The same holds true with the poll request unit 63 when it transmits the poll request to the aggregation device B (29B) (S1B through S6B). In this case, since the aggregation device B (29B) uses the protocol B, the poll request is transmitted and the poll reply is received using the communication unit 70b for the protocol B.

Thus, the adapter 28 periodically performs polling to the aggregation device 29 capable of communicating with the adapter 28. When the adapter 28 cannot receive a poll reply, it determines that the sensor NW between the adapter 28 and the aggregation device 29 is divided.

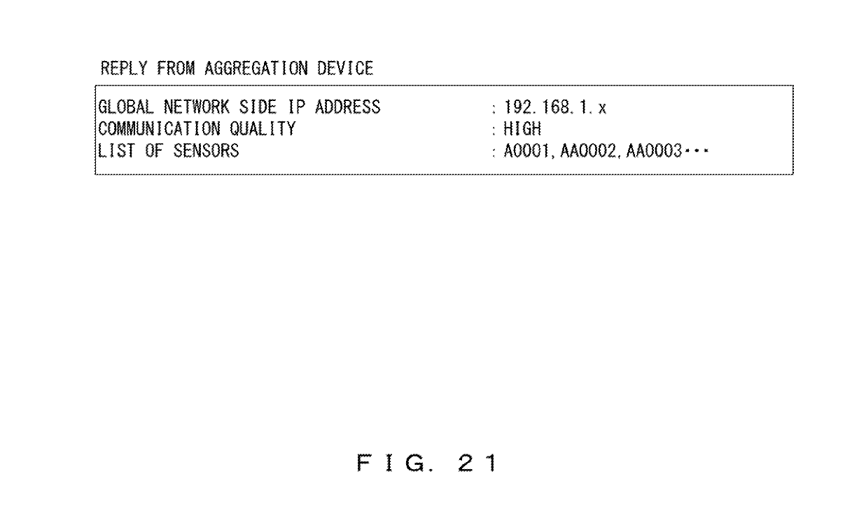

FIG. 21 is an example of the contents of the poll reply transmitted from the aggregation device according to the first mode for embodying the present invention (embodiment 1). The poll reply includes the IP address on the global network side of the aggregation device 29, communication quality, and a list of sensors belonging to the sensor NW managed by the aggregation device.

The sensor NW management unit 62 updates the sensor NW table 65-1 (aggregation device IP address, communication quality) and the center management table 65-2 (sensor NW identifier, sensor identifier) in FIG. 14 using the poll reply. It is assumed that the communication protocol of the sensor data, the data format, and the transfer destination NW priority are preset.

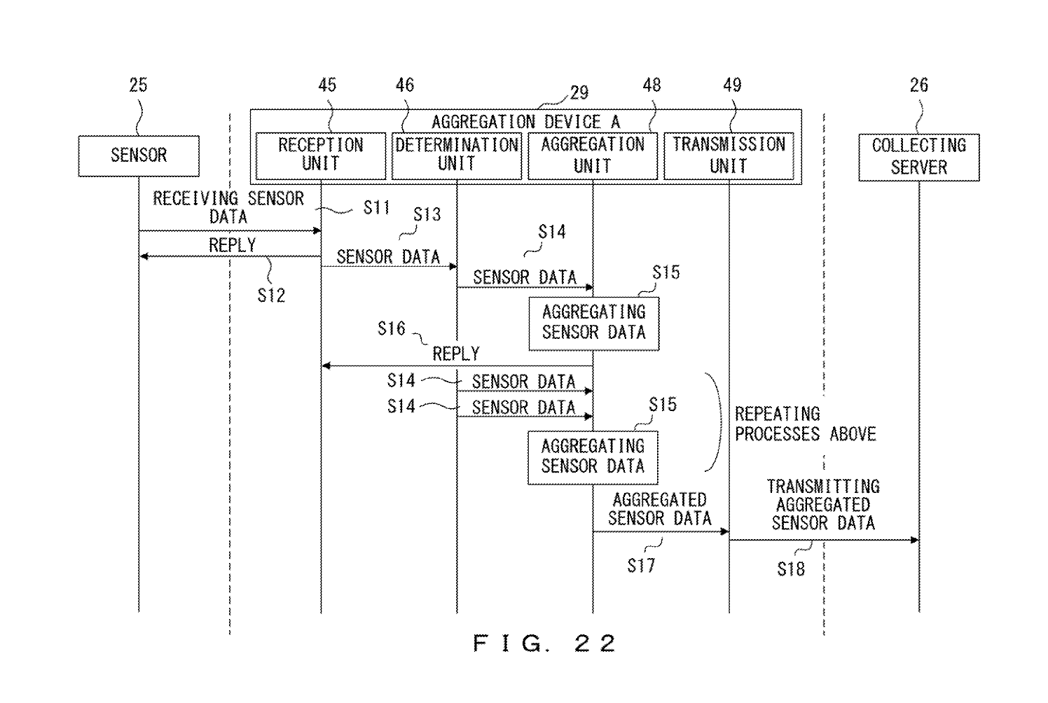

FIG. 22 is an example of the sensor data collection sequence in the normal state according to the first mode for embodying the present invention (embodiment 1). FIG. 22 illustrates the sensor data collection sequence in the normal state (without a fault in the sensor NW). In FIG. 22, the aggregation device 29 receives and aggregates the sensor data from the sensor 25 in the sensor NW managed by the aggregation device 29, and transmits the aggregated sensor data to the collecting server 26.

The sensor 25 transmits the sensor data to the aggregation device 29 (S11). Upon receipt of the sensor data from the sensor 25, the reception unit 45 of the aggregation device 29 returns to the sensor 25 a reply that the sensor data has been received (S12). In addition, the reception unit 45 notifies the aggregation unit 48 of the received sensor data through the determination unit 46 (S13, S14), and allows the aggregation unit 48 to aggregate the sensor data (S15). Practically, the aggregation refers to collectively storing data. When the aggregation of the sensor data is completed, the aggregation unit 48 returns the reply about the aggregation to the reception unit 45 (S16). Each time the aggregation unit 48 receives the sensor data, it aggregates the sensor data (holding the data in a temporary storage) (S14, S15). The aggregation unit 48 transmits the data (aggregated sensor data) obtained by collecting the aggregated sensor data to the collecting server 26 through the transmission unit 49 (S17, S18).

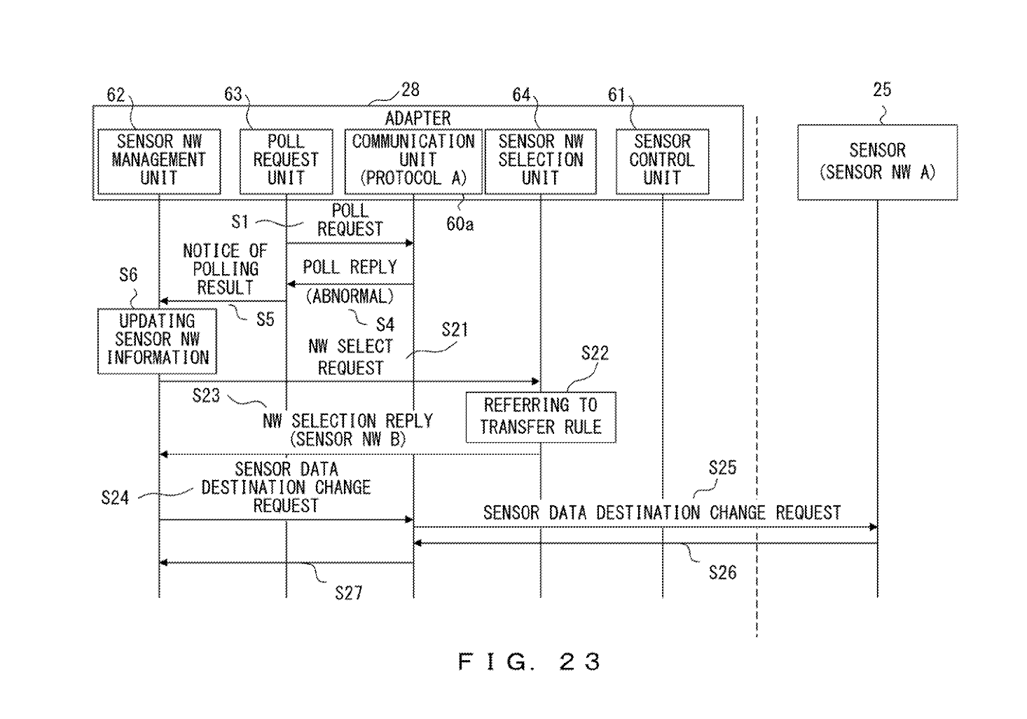

FIG. 23 is an example of the sequence from detecting a fault (division of sensor NW) to changing the destination of sensor data according to the first mode for embodying the present invention (embodiment 1). FIG. 23 illustrates the sequence of the adapter 28 detecting an abnormal condition of the sensor NW by monitoring the poll reply in FIG. 20, and then changing the destination of the sensor data on the sensor 25 in the sensor NW in which a fault has occurred.

In FIG. 23, the processes in S1 through S6 are performed. Since S1 through S6 are the same as S1A (S1B) through S6A (S6B) in FIG. 20, the explanation is omitted here. In S6, when the poll reply is abnormal, the sensor NW management unit changes the communication quality of the sensor NW information (sensor NW table 65-1 in FIG. 14) into “divided”. The sensor NW management unit 62 notifies the sensor NW selection unit 64 of the NW select request including the sensor NW identifier (sensor NW A) (S21).

The sensor NW selection unit 64 selects the sensor NW to which the sensor data is to be transferred from the sensor NW table 65-1 in FIG. 14 using the sensor NW identifier (sensor NW A) included in the NW select request as a key, and refers to the transfer rule table 66-1 in FIG. 16 (S22). In FIG. 14, the destinations of the transfer of the sensor NW A can be the sensor NW B (high communication quality) and the sensor NW C (high communication quality), but the sensor NW B has a higher transfer destination NW priority. Therefore, the sensor data is transferred to the sensor NW B.

The sensor NW selection unit 64 issues a notification to the 62 that a specific sensor NW is selected as a NW selection reply after referring to the transfer rule table 66-1 (S23). The sensor NW management unit 62 notifies the sensor 25 of the sensor data destination change request, and allows the sensor 25 to change the setting of the destination aggregation device of the sensor data (S24 through S27).

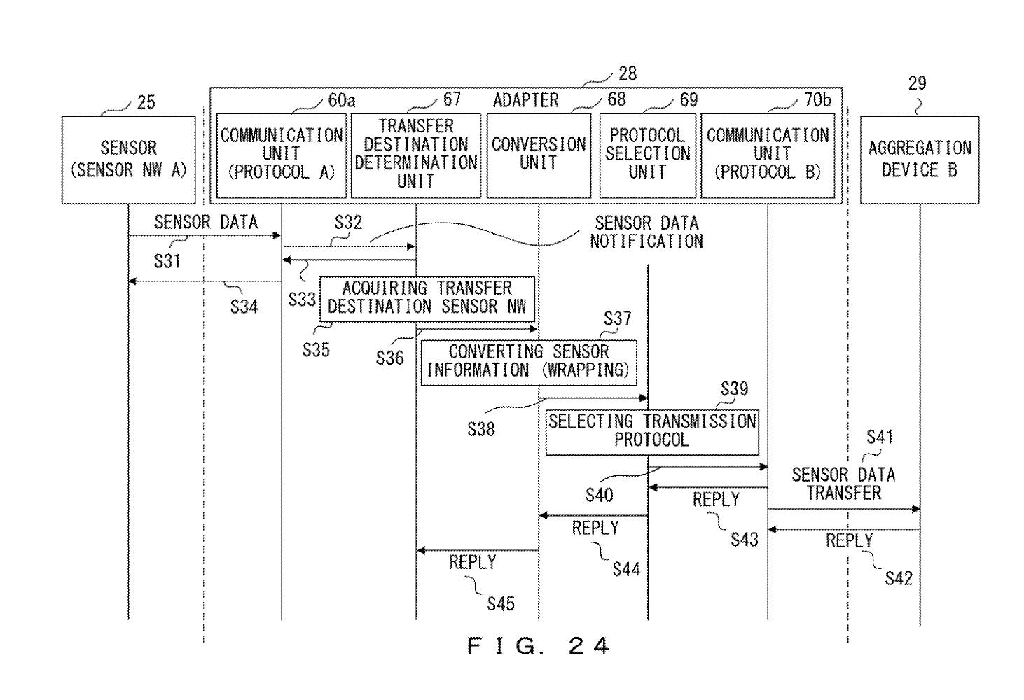

FIG. 24 is an example of the sensor data transfer sequence in the adapter according to the first mode for embodying the present invention (embodiment 1). FIG. 24 illustrates the sequence of the adapter 28 from receiving the sensor data from the sensor 25 to transferring the data to the aggregation device 29.

Upon receipt of sensor data from the sensor 25 (identifier: AA0002 in FIG. 16) of the sensor NW A (S31), a communication unit 60a notifies the transfer destination determination unit 67 of the reception of the sensor data, and returns the reply information to the sensor 25 (S32 through S34).

The transfer destination determination unit 67 extracts the transfer destination sensor NW (sensor NW B) from the transfer rule table 66-1 in FIG. 16 (S35). Furthermore, the conversion unit 68 refers to the conversion rule table 66-2, and converts the data format corresponding to the transfer destination sensor NW (sensor NW B) (S36, S37).

Thus, if the adapter 28 determines that the sensor data cannot be aggregated by the aggregation device 29A through the sensor NW A, it transfers the sensor data to the aggregation device 29B through the sensor NW B. The adapter 28 can transmit the sensor data from the 29B to the aggregation device 29A through the global network.

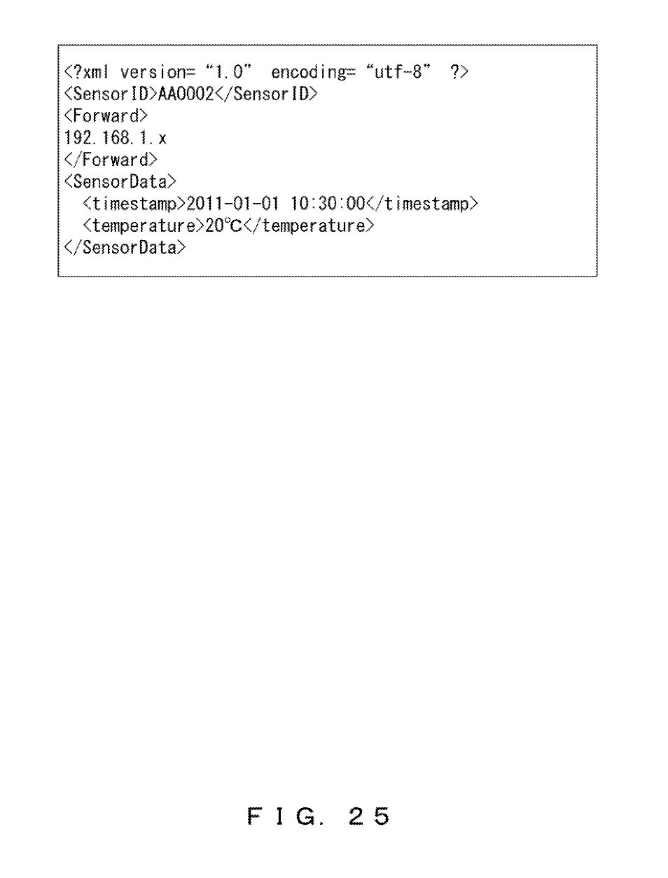

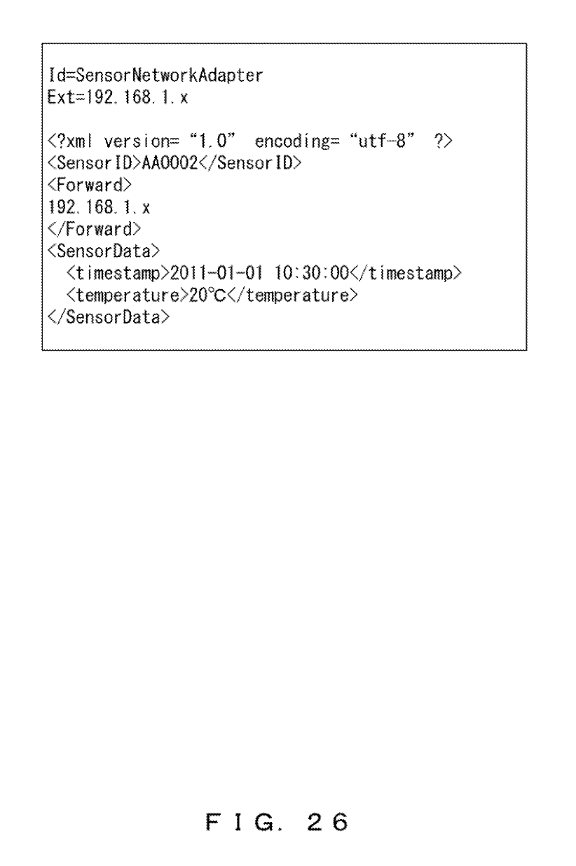

FIG. 25 is an example of sensor data before a conversion according to the first mode for embodying the present invention (embodiment 1). FIG. 26 is an example of sensor data after a conversion according to the first mode for embodying the present invention (embodiment 1). FIG. 25 illustrates the sensor data of the format A in FIG. 18. The identifier of the sensor 25 included in the sensor data is AA0002. The time at which the sensing is performed is Jan. 1, 2011 at 10:30:00. The sensor 25 is a temperature sensor, senses the temperature, and record the sensor raw data of 20° C. FIG. 26 illustrates the state in which the sensor data in format A is converted into the sensor data in format B. In FIG. 26, the sensor data in format A is copied as is to the record area of the sensor raw data in format B. Thus, when the format A is converted into the format B, the data in format A is embedded into the data in format B, which is called “wrapping”.

The description is given below with reference back to FIG. 24. The protocol selection unit 69 refers to the data conversion rule information in FIG. 17, selects a protocol at the destination (protocol B) (S38, S39), and issues a sensor data transmit request to the communication unit 70b in which the protocol B is used (S40). Thus, the adapter 28 can transmit the sensor data of the sensor NW A to the aggregation device B.

The communication unit 70b transmits the sensor data to the aggregation device B (S41). Upon receipt of the sensor data, the aggregation device B notifies the communication unit 70b of the reply. The communication unit 70b notifies the transfer destination determination unit 67 of the reply from the aggregation device B through the protocol selection unit 69 and the conversion unit 68 (S43 through S45).

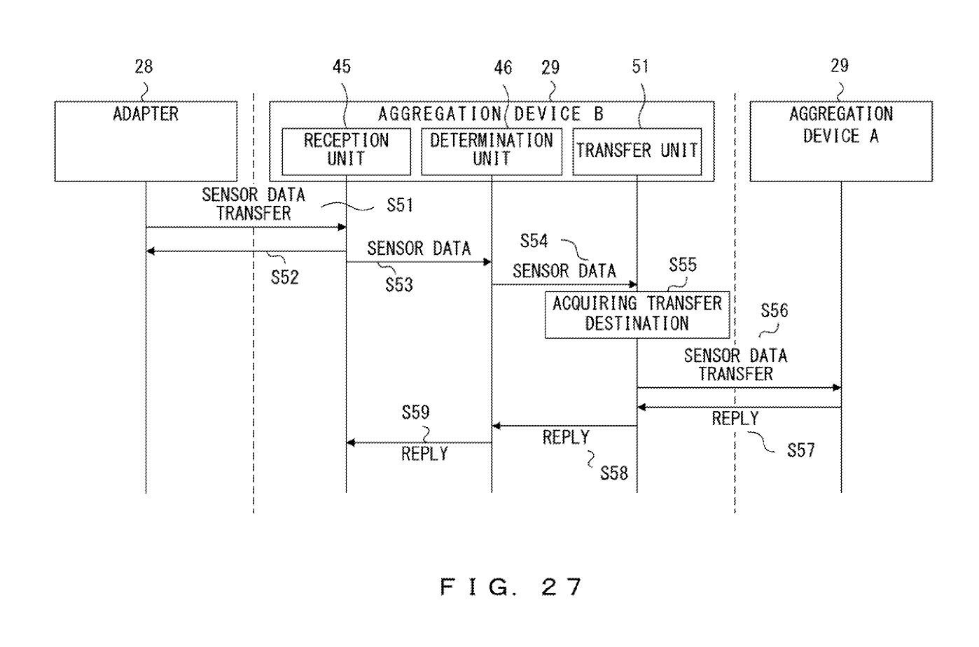

FIG. 27 is an example of the sensor data transfer sequence in the aggregation device according to the first mode for embodying the present invention (embodiment 1). FIG. 27 illustrates the sequence of the aggregation device B (29B) from receiving the sensor data from the adapter 28 to transferring the sensor data to the original aggregation device A (29A).

When the sensor data is transferred from the adapter 28 to the reception unit 45 of the aggregation device B (S51), the reception unit 45 returns the reply to the adapter 28 (S52). The reception unit 45 transmits the sensor data to the transfer unit 51 through the determination unit 46 (S53, S54). The aggregation device B is an aggregation device of the sensor NW to which the sensor 25 that has transmitted the sensor data does not belong. The transfer unit 51 of the aggregation device B acquires the transfer destination of the sensor data (S55), and transfers the sensor data to the aggregation device A (S56). The aggregation device A is an aggregation device of the sensor NW to which the sensor that has transmitted the sensor data belongs, and is called an original aggregation device.

Upon receipt of the sensor data, the aggregation device A transmits the reply that the sensor data has been received to the aggregation device B (S57). The reply message is reported to the reception unit 45 through the transfer unit 51 and the determination unit 46 (S58, S59).

FIG. 28 is an example of the collecting sequence up to the transmission of sensor data from the aggregation device to the collecting server according to the first mode for embodying the present invention (embodiment 1). The sequence illustrated in FIG. 28 is the aggregation device A receiving the sensor data transferred from another aggregation device B, aggregating the data, and transmitting the data to the collecting server 26.

Upon receipt of the sensor data from the aggregation device B (S61), the reception unit 45 of the aggregation device A returns the reply that the sensor data has been received to the aggregation device B (S62). Simultaneously, the reception unit 45 transmits the sensor data to the conversion unit 47 through the determination unit 46 (S63, S64). The conversion unit 47 converts the format of the sensor data (S65), and transmits the converted sensor data to the aggregation unit 48 (S66). The conversion of the format of the sensor data is a process of releasing the wrapping of the data.

When the aggregation unit 48 receives the converted sensor data and holds it in the temporary storage unit 50 (S67), the reply that the sensor data has been received is reported to the reception unit 45 through the conversion unit 47 and the determination unit 46 (S68 through S70). The aggregation unit 48 receives the converted sensor data (S66), and receives the sensor data not converted because it is not necessary to convert the data (S71). The aggregation unit 48 aggregates (holds in the temporary storage unit 50) the converted and held sensor data and the sensor data not converted because it is not necessary to convert the data. The aggregation unit 48 transmits the aggregated sensor data to the collecting server 26 through the transmission unit 49 (S73, S74). The collecting server 26 returns to the aggregation device B (transmission unit 49, aggregation unit 48) the reply that the aggregated sensor data (sensor data held in the temporary storage unit 50) has been received (S75, S76).

### Embodiment 2

In the first mode for embodying the present invention (embodiment 1), the sensor data converted by the adapter 28 is restored by the original aggregation device (aggregation device A). On the other hand, according to the first mode for embodying the present invention (embodiment 2), restoring the sensor data by the relaying aggregation device (aggregation device B) is described. In the first mode for embodying the present invention (embodiment 2), the same configuration and function as in the first mode for embodying the present invention (embodiment 1) are assigned the same reference numerals, and the explanation is omitted here.

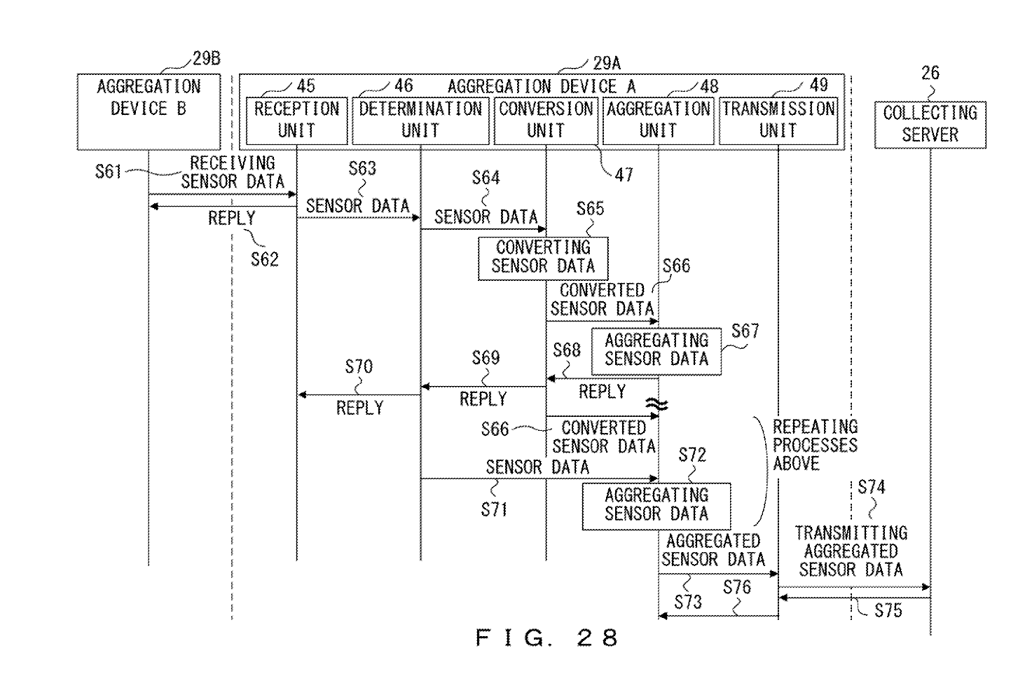

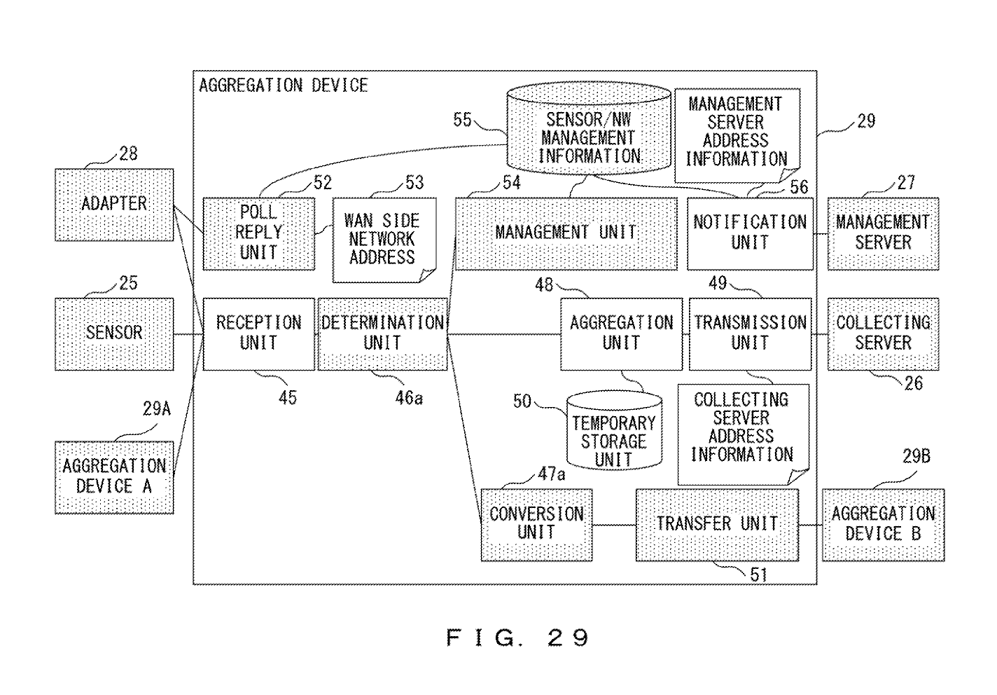

FIG. 29 is a block diagram of the function of the aggregation device according to the first mode for embodying the present invention (embodiment 2).

A determination unit 46a determines the sensor data received from the reception unit 45, and determines the next process. When the sensor data received from the reception unit is the sensor data of the sensor NW managed by the determination unit 46a, the determination unit 46a passes the sensor data to the aggregation unit 48. If the sensor data received from the reception unit 45 is the sensor data of the sensor NW not managed by the determination unit 46a (but received from the adapter 28), the determination unit 46a passes the sensor data to the conversion unit 47. Furthermore, the determination unit 46a passes a copy of the sensor data to the management unit 54 regardless of the determination result on the sensor data.

The conversion unit 47a converts into the data format (restores to the original data format) of the sensor NW managed by the aggregation device 29B to which the data is transferred the sensor data converted by the adapter 28 into the data format of the sensor NW managed by the conversion unit 47a. Then, the conversion unit 47a passes the converted sensor data to the transfer unit 51, and transfers the data to the aggregation device 29B.

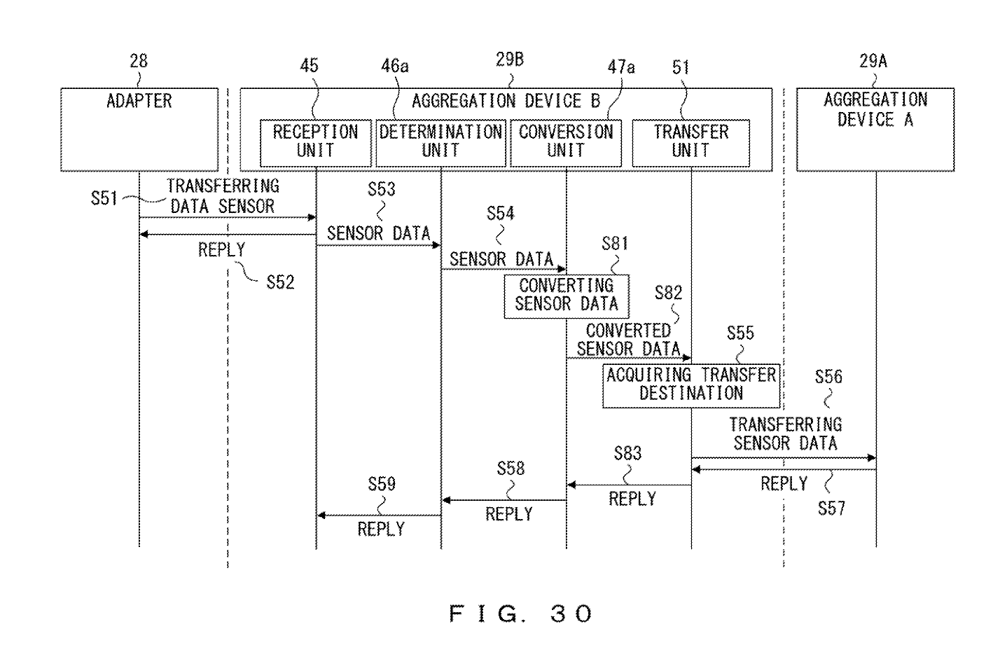

FIG. 30 is an example of the sensor data transfer sequence in the aggregation device according to the first mode for embodying the present invention (embodiment 2). In FIG. 30, the aggregation device B receives the sensor data from the adapter 28, and transfers the sensor data to the original aggregation device A. FIG. 30 is obtained by adding S81 through S83 to the flowchart in FIG. 27.

Upon receipt of the sensor data transmitted from the adapter 28 (S51), the reception unit 45 of the aggregation device B returns a reply to the adapter 28 (S52). Simultaneously, the reception unit 45 transmits the sensor data to the conversion unit 47a through the determination unit 46a (S53, S54). The conversion unit 47a converts the sensor data (S81), and transmits the converted sensor data to the transfer unit 51 (S82). The transfer unit 51 acquires the transfer destination of the converted sensor data (S55), and transmits the sensor data to the aggregation device A (S56). The aggregation device B is an aggregation device of the sensor NW to which the sensor 25 that has transmitted the sensor data does not belong. The aggregation device A is an aggregation device of the sensor NW to which the sensor 25 belongs, and is called an original aggregation device. Upon receipt of the sensor data, the aggregation device A transmits the reply that the sensor data has been received to the aggregation device B (S57). The reply is transmitted to the reception unit 45 through the transfer unit 51, the conversion unit 47a, and the determination unit 46a (S57, S83, S58, S59).

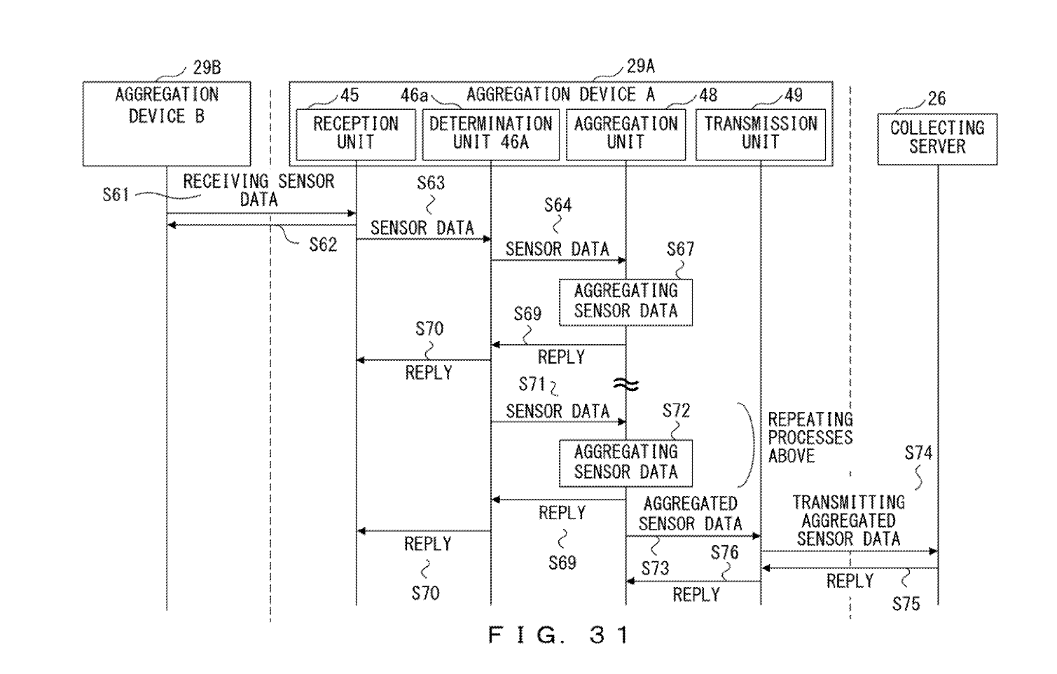

FIG. 31 is an example of the sensor data collection sequence from the aggregation device according to the first mode for embodying the present invention (embodiment 2). In FIG. 31, the aggregation device A receives the sensor data transferred from another aggregation device B, aggregates the data, and transmits the data to the collecting server 26. FIG. 31 illustrates the sequence obtained by removing S65 and S66 from the sequence illustrated in FIG. 28.

Upon receipt of the sensor data from the aggregation device B (S61), the reception unit 45 of the aggregation device A issues a reply that the sensor data has been received to the aggregation device B (S62). The reception unit 45 transmits the sensor data to the aggregation unit 48 through the determination unit 46a (S63, S64). The aggregation unit 48 receives and aggregates the sensor data (S67). When the aggregation unit 48 aggregates (holds in the temporary storage unit 50) the sensor data, it transmits a reply that the sensor data has been received to the reception unit 45 through the determination unit 46a (S69, S70). Each time the determination unit 46a notifies the aggregation unit 48 of the sensor data, the sensor data is aggregated, and a reply is returned to the determination unit 46a etc. The aggregation unit 48 transmits the aggregated sensor data to the collecting server 26 through the transmission unit 49 (S73, S74). The aggregation device A receives from the collecting server 26 the reply that the aggregated sensor data has been received. The reply is transmitted to the aggregation unit 48 through the transmission unit 49 (S75, S76).

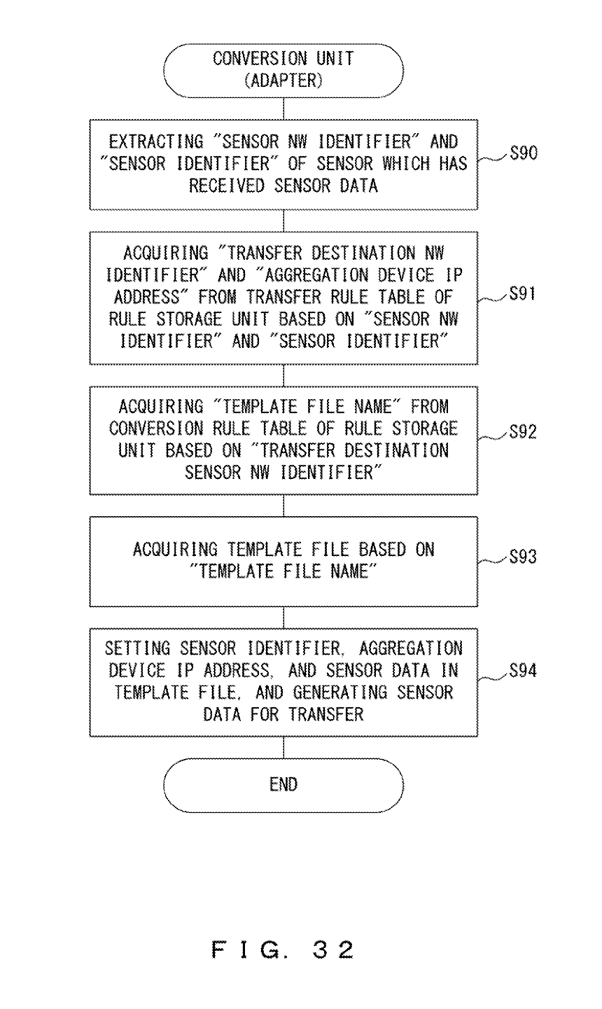

FIGS. 32, 33, and 34 are flowcharts of the process performed when the transfer rule table 66-1 and the conversion rule table 66-2 stored in the rule storage unit 66, which are common in the configuration examples according to the first mode for embodying the present invention, are referred to.

FIG. 32 is an example of the operation of the conversion unit of the adapter according to the first mode for embodying the present invention (embodiments 1 and 2). The conversion unit 68 extracts the identifier of the sensor NW and the identifier of the sensor of the sensor 25 which has received the sensor data from the center management table 65-2 (S90). The conversion unit 68 refers to the transfer rule table 66-1 of the rule storage unit 66, and acquires the identifier of the transfer destination NW corresponding to the identifier of the extracted sensor NW and the identifier of the sensor, and the IP address of the original aggregation device (S91). The conversion unit 68 acquires from the conversion rule table 66-2 of the rule storage unit 66 the template file name corresponding to the identifier of the sensor NW matching the acquired identifier of the transfer destination NW (S92). The conversion unit 68 acquires from a specified storage device a template file corresponding to the acquired template file name (S93). The conversion unit 68 sets the identifier of the sensor, the IP address of the aggregation device, and the sensor data in the acquired template file, and generates the sensor data for transfer (S94).

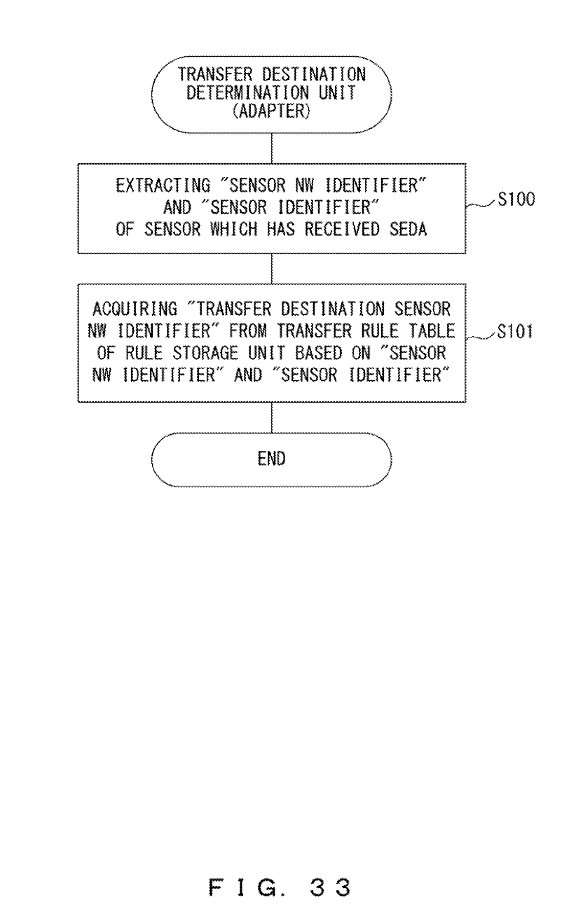

FIG. 33 is an example of the operation of the transfer destination determination unit of the adapter according to the first mode for embodying the present invention (embodiments 1 and 2). The transfer destination determination unit 67 extracts from the center management table 65-2 the identifier of the sensor NW and the identifier of the sensor which has received the sensor data (S100). The transfer destination determination unit 67 acquires the identifier of the transfer destination NW from the transfer rule table 66-1 of the rule storage unit 66 using the extracted identifier of the sensor NW and the identifier of the sensor (S101).

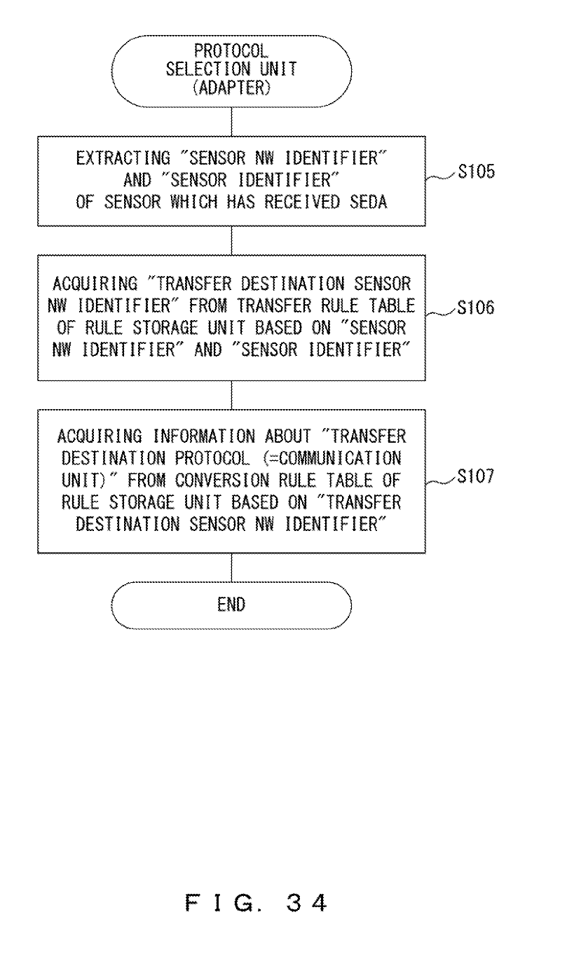

FIG. 34 is an example of the operation of the protocol selection unit of the adapter according to the first mode for embodying the present invention (embodiments 1 and 2). The protocol selection unit 69 extracts the identifier of the sensor NW and the identifier of the sensor of the sensor 25 which has received the sensor data from the center management table 65-2 (S105). The protocol selection unit 69 acquires the identifier of the transfer destination NW from the transfer rule table 66-1 of the rule storage unit 66 using the identifier of the sensor NW and the identifier of the sensor as a key (S106). The protocol selection unit 69 acquires the information about the transfer destination protocol (corresponding communication unit) from the conversion rule table 66-2 of the rule storage unit 66 using the identifier of the transfer destination NW as a key (S107).

Thus, the sensor data converted by the adapter 28 can be restored not by the sensor data requesting aggregation device, but by the aggregation device (aggregation device B) which relays the sensor data.

### Second Mode for Embodying the Present Invention

According to the first mode for embodying the present invention, the adapter performs polling to the aggregation device capable of communicating with the adapter, and determines the state of the sensor NW between the adapter and the aggregation device depending on the result of a poll reply. In addition, the sensor transmits the sensor data to the aggregation device. When the state of the sensor NW is abnormal, the adapter allows the sensor to change the destination of the sensor data. On the other hand, according to the second mode for embodying the present invention, the aggregation device performs polling to the adapter capable of communicating with the aggregation device, and determines the state of the sensor NW between the adapter and the aggregation device depending on the result of the poll reply. In addition, the aggregation device transmits a sensor data acquire request to the sensor in the local sensor NW by the polling, and acquires the sensor data from each sensor. When the state of the sensor NW is abnormal, the aggregation device determines the transfer destination of the request depending on the received request. According to the present mode for embodying the invention, the configuration and the function similar to those according to the first mode for embodying the present invention are assigned the same reference numeral, and the explanation is omitted here.

According to the second mode for embodying the present invention, an adapter to be connected to a plurality of sensor NWs is arranged, thereby allowing the sensor data to be communicated between the sensor NWs. In this case, if the sensor data cannot be collected from a certain sensor, or if a certain sensor takes a long time to collect the sensor data, the aggregation device performs the following process. The aggregation device issues by polling a request to collect the sensor data to the adapter arranged near a target sensor through another sensor NW. The adapter which has received the request to collect the sensor data collects the sensor data from the target sensor, and returns the sensor data to the requesting aggregation device.

Thus, although there occurs a fault that, for example, a part of the sensor NW has been divided, the adapter can dynamically change the substitute path, thereby successfully collecting the sensor data at any time.

Furthermore, not only when the quality of the network is degraded, but also when the information is collected in a sensor-specific environment, another sensor can use the sensor NW as a communication path in a time period in which scheduling is appropriately performed and there is sufficient communication capacity. In this case, the case in which the quality of a network has been degraded refers to, for example, the case in which it takes some time to divide a sensor NW or transmit the sensor data. The sensor-specific environment refers to, for example, there is a constant rule in collecting the sensor data using sensors such as an illuminance sensor, a water level sensor, etc. The constant rule refers to, for example, a rule according to which information is not to be frequently collected in a time period in which a change is rarely detected at nighttime etc.

Additionally, there is the following two sensor data collecting methods when the aggregation device requests the adapter of another sensor NW to collect sensor data. The first collecting method is to return data to an aggregation device each time an adapter acquires data from a sensor. The second collecting method is to collectively return data to the aggregation device after the adapter acquires data from the sensor for a specified time period. In the case of the second collecting method in which data is acquired at a lower frequency, communication can be narrowed to a minimal target, thereby reducing the communication effect on other sensor NWs.

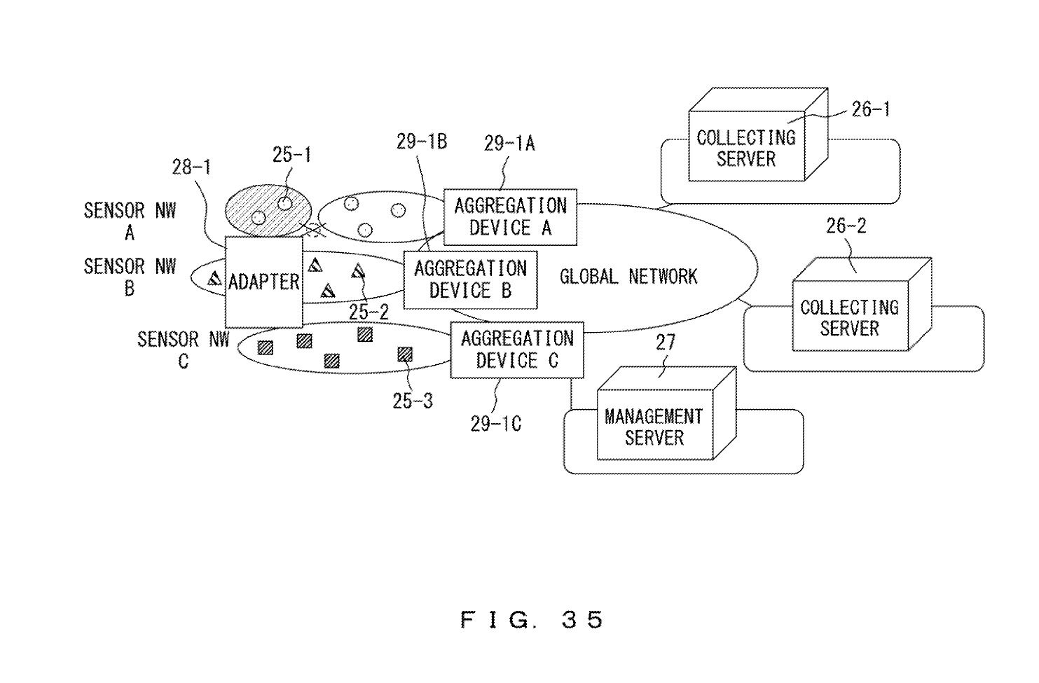

FIG. 35 is a configuration of the entire system according to the second mode for embodying the present invention. The system according to the present mode for embodying the invention includes the sensor 25 (25-1, 25-2, 25-3), the collecting server 26 (26-1, 26-2), the management server 27, the adapter 28-1, the aggregation devices A through C (29-1A, 29-1B, 29-1C). The entire system according to the present mode for embodying the invention is similar to that according to the first mode for embodying the present invention (FIG. 6).

The sensor 25 (25-1, 25-2, 25-3) transmits the sensor data sensed through the sensor NW to the requesting device. The sensor data collected by the sensor 25 relates to various types of information such as temperature, humidity, illuminance, etc. The sensor data is collected at an acquire request by polling issued by the aggregation devices A through C. The sensor 25 also transfers the sensor data transmitted from another sensor. The sensor 25 accepts the sensor data acquire request message from the aggregation devices A through C. The details of the sensor 25 are the same as those described according to the first mode for embodying the present invention.

The collecting server 26 (26-1, 26-2) receives the sensor data collected as transmitted from the aggregation devices A through C, and accumulates, processes, and provides the sensor data. The details of the collecting server 26 are similar to those described according to the first mode for embodying the present invention.

The management server 27 receives the management information about the sensor transmitted from the aggregation devices A through C, and manages the sensor. The details of the management server 27 are similar to those described according to the first mode for embodying the invention.

The aggregation devices A through C (29-1A, 29-1B, 29-1C) include the function of temporarily aggregating the sensor data in the sensor NWs A through C. The aggregation devices A through C include the function of collecting the sensor data through another aggregation device connected to the global network although there occurs an abnormal condition in the local sensor NW.

The adapter 28-1 includes the function of communicating the sensor data by connection to a plurality of sensor NWs different in communication system.

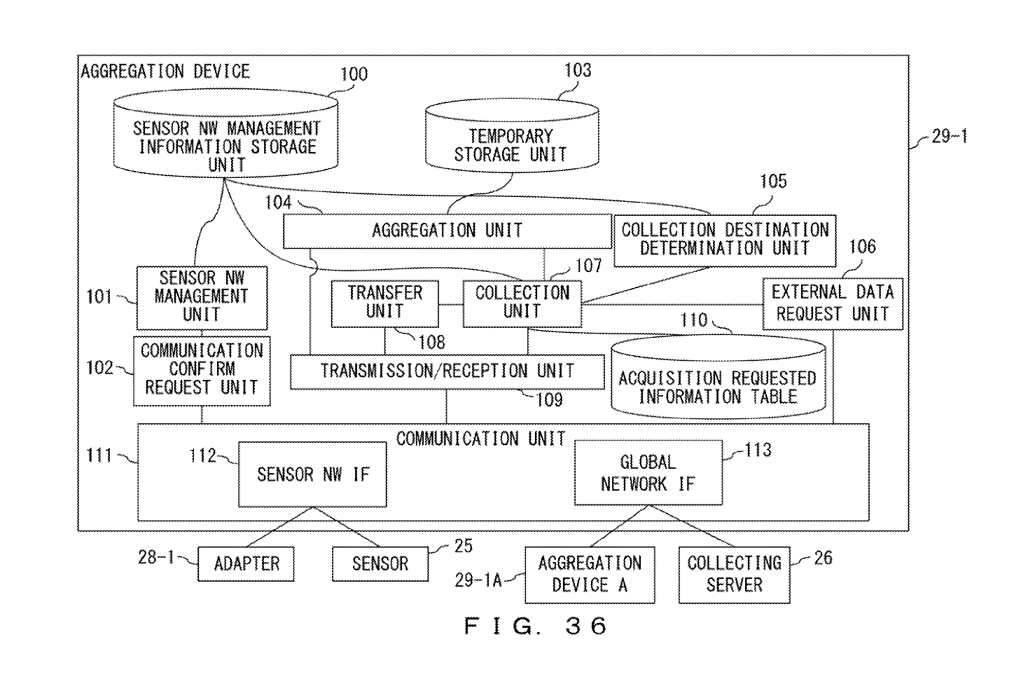

FIG. 36 is a block diagram of the function of the aggregation device according to the second mode for embodying the present invention. The aggregation device 29-1 includes a sensor NW management unit 101, a communication confirm request unit 102, an aggregation unit 104, a collection destination determination unit 105, an external data request unit 106, a collection unit 107, a transfer unit 108, a transmission/reception unit 109, and a communication unit 111. The devices also include a sensor NW management information storage unit 100, a temporary storage unit 103, and an acquisition requested information table 110.

The sensor NW management unit 101 stores the sensor information about the sensor 25 in the local sensor NW, the information about the sensor 25 near the adapter 28-1, and the adapter information relating to the adapter 28-1 in the sensor NW management information storage unit 100, and manage the information. The sensor NW management unit 101 measures and manages the time required to acquire the sensor data and the average value.

The collection unit 107 calls the collection destination determination unit 105 to collect the sensor data by periodically using the local sensor NW. When the collection destination determination unit 105 determines that the sensor data can be collected using the local sensor NW, the collection unit 107 stores the information about the sensor data acquire request in the acquisition requested information table 110, and collects the sensor data through the transmission/reception unit 109.

When the collection destination determination unit 105 determines that the sensor data cannot be collected using the local sensor NW, or that the data collection takes a long time (largely deviating from the average value), it performs the following process. The collection destination determination unit 105 stores the information about the sensor data acquire request in the acquisition requested information table 110, and calls the external data request unit 106.

The external data request unit 106 issues a sensor data acquire request to another aggregation device 29-1 using the global network.

When a reply (return of sensor data) is received from an external aggregation device 29-1A as a result of the sensor data acquire request, the transmission/reception unit 109 receives the sensor data. The transmission/reception unit 109 transmits the received sensor data to the aggregation unit 104 through the collection unit 107. The aggregation unit 104 stores the sensor data in the temporary storage unit 103.

The transmission/reception unit 109 also receives a sensor data acquire request from the external aggregation device 29-1A. In this case, the transmission/reception unit 109 calls the collection destination determination unit 105 through the collection unit 107. The collection destination determination unit 105 determines whether or not the sensor data acquire request can be issued to the target adapter 28-1 using the sensor 25 in the local sensor NW. Furthermore, the collection destination determination unit 105 determines whether or not there is room enough to pass the other sensor data in the local sensor NW.

When the 105 determines that the sensor data acquire request can be issued to the adapter 28-1, the collection unit 107 requests the adapter 28-1 to acquire the sensor data using the local sensor NW through the transmission/reception unit 109. When the sensor data acquire request is issued, the collection unit 107 adds to the issued sensor data acquire request the identifier for identifying the sensor data acquire request, and holds in the acquisition requested information table 110 the identifier as associated with the information about the requester.

In addition, when the sensor data acquire request is issued, the method for acquiring the information from the sensor can be specified, the first collecting method or the second collecting method. The first collecting method is to specify the aggregation device 29-1 as a destination each time the adapter 28-1 acquires the information from the sensor 25. The second method is to specify the aggregation device 29-1 to which data is to be collectively returned after the adapter 28-1 acquires the information from the sensor for a specified time period.

When the collection destination determination unit 105 determines that the sensor data acquire request cannot be issued to the adapter 28-1, the collection unit 107 calls the external data request unit 106. The external data request unit 106 transfers the sensor data acquire request to the next aggregation device 29-1A using the global network.

The adapter 28-1 returns the sensor data corresponding to the sensor data acquire request, and the transmission/reception unit 109 receives the sensor data. In this case, the collection unit 107 extracts the original destination from the request identifier held in advance and the information about the aggregation device 29-1 as the source corresponding to the request identifier based on the request identifier for identifying the sensor data acquire request included in the sensor data. The original destination refers to the WAN side IP address of the aggregation device 29-1 of the sensor NW in which an abnormal condition has occurred. The collection unit 107 transfers the sensor data to the original aggregation device 29-1 through the transmission/reception unit 109 using the global network.

The communication confirm request unit 102 periodically performs polling to the adapter 28-1 connected to the aggregation device 29-1, and makes arrival confirmation to the adapter 28-1. With the result of the arrival confirmation, the communication confirm request unit 102 acquires from the adapter 28-1 the sensor information near the adapter 28-1.

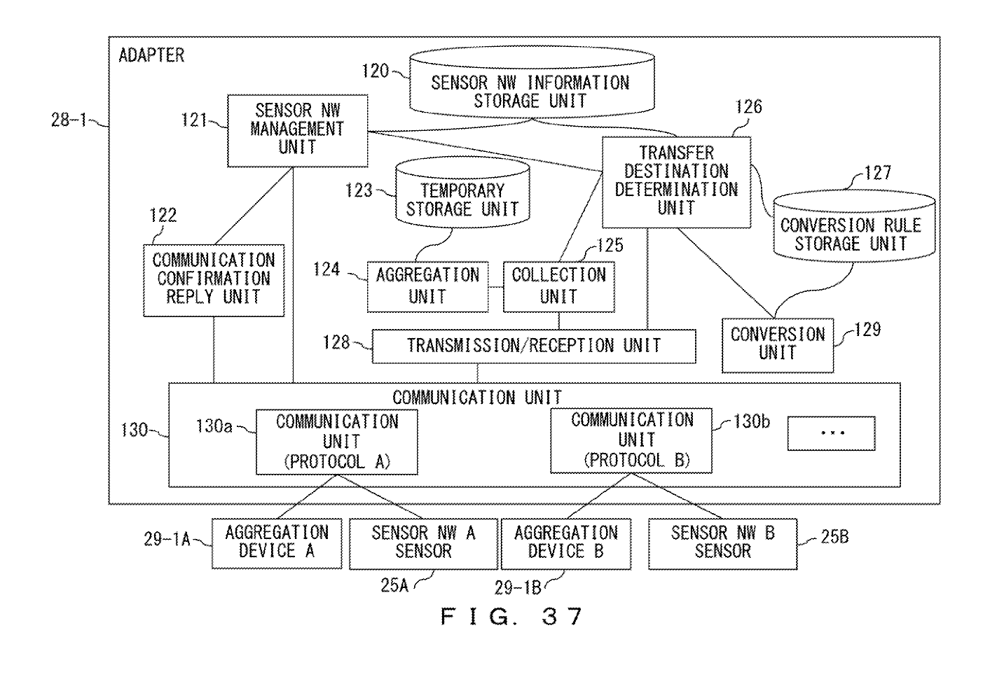

FIG. 37 is a block diagram of the function of the adapter according to the second mode for embodying the present invention. The adapter 28-1 includes a sensor NW management unit 121, a communication confirmation reply unit 122, an aggregation unit 124, a collection unit 125, a transfer destination determination unit 126, a transmission/reception unit 128, a conversion unit 129, and a communication unit 130. Furthermore, the adapter 28-1 includes a sensor NW information storage unit 120, a temporary storage unit 123, and a conversion rule storage unit 127.

The sensor NW management unit 121 manages a list of the sensor 25 near the adapter 28-1 as sensor NW information.

Upon receipt of the sensor data acquire request, the transmission/reception unit 128 transmits the request to the collection unit 125. The collection unit 125 calls the transfer destination determination unit 126, and the transfer destination determination unit 126 determines the sensor NW as the destination of the sensor data acquire request and the sensor 25. The transmission/reception unit 128 issues a sensor data acquire request to the determined sensor 25.

When the sensor data acquire request is issued, the conversion unit 129 refers to the conversion rule storage unit 127, and performs protocol conversion (communication layer) based on the sensor NW of the determined sensor 25 and performs the data conversion wrapping (application layer). The conversion unit 129 changes the destination of the sensor data acquire request into the destination of the determined sensor 25. Furthermore, the conversion unit 129 internally holds the request identifier for identification of the issued sensor data acquire request, and the information about the source aggregation device 29-1 corresponding to the request identifier.

When the transmission/reception unit 128 receives the sensor data from the sensor 25, the collection unit 125 calls the aggregation unit 124, and the aggregation unit 124 stores the received sensor data in the temporary storage unit 123.

As a method for acquiring information from the sensor 25, when specification is made to acquire information from the sensor 25 for a specified time period (second collecting method), the collection unit 125 issues again the sensor data acquire request. In this case, the transmission/reception unit 128 receives again the sensor data from the sensor 25.

When the condition of transmitting data to aggregation device 29-1 is satisfied, the conversion unit 129 performs the following process. The aggregation device 29-1 performs the protocol conversion (communication layer) and data conversion/wrapping (application layer) based on the local sensor NW on the sensor data aggregated by the aggregation unit 124 using the conversion rule storage unit 127 through the conversion unit 129. The conversion unit 129 acquires the information about the aggregation device corresponding to the request identifier of the sensor data acquire request based on the request identifier included in the sensor data, changes the destination of the sensor data into the aggregation device, and returns the sensor data.

In response to the polling for communication confirmation by the aggregation device 29-1 (29-1A, 29-1B), the communication confirmation reply unit 122 returns the vicinal sensor information.

Thus, when a fault or removal of a sensor, the division of a sensor NW due to a theft, or the degradation of the quality of a sensor NW occur, the aggregation device 29-1 and the adapter 28-1 dynamically change the path using the adjacent sensor NW to issue a sensor data acquire request. As a result, the sensor data can be collected. Therefore, the trouble that the sensor data cannot be collected for a long time or that the collecting timing of the sensor data is delayed due to the congestion of a specific sensor NW can be avoided.

In addition, the sensor NW in which the sensor data is not frequently collected such as a nighttime illuminance sensor, a water level sensor after the harvest season, etc. can be used as a communication path by other sensor NWs through data and protocol conversion. As a result, the fastness to faults and efficiency of the sensor NW can be improved without reinforcing the sensor.

Described below are embodiments of the present mode for embodying the invention.

### Embodiment 1

In the embodiment 1, the sensor data of a divided polling sensor NW is collected using another sensor NW. In the embodiment 1, an adapter connected to a plurality of sensor NW in different systems is arranged. In the environment in which sensor data can be communicated among sensor NWs, an aggregation device collects and aggregates sensor data through polling. In this case, the aggregation device selects and relays the optimum path (another sensor NW) although a data acquire request is issued to each sensor or the communication quality of a sensor NW has been degraded, thereby successfully aggregating the sensor data.

The entire system in the second mode for embodying the present invention (embodiment 1) is similar to that in FIG. 35. The sensor 25, the collecting server 26, the management server 27, the adapter 28-1, and the aggregation device 29-1 in the second mode for embodying the present invention (embodiment 1) are described below with reference to FIG. 35.

The sensor 25 transmits the sensor data sensed through the sensor NW to a requester. The collected sensor data includes, for example, a temperature, humidity, illuminance, etc. The sensor 25 starts collecting the sensor data by polling in which an acquire request is issued. Furthermore, the sensor includes the function of transferring the sensor data transmitted from another sensor.

The collecting server 26 receives the aggregated sensor data transmitted from the aggregation device 29-1, and accumulates, processes, and provides the sensor data.

The management server 27 receives the sensor management information transmitted from the aggregation device 29-1, and manages the sensor.

The aggregation device 29-1 aggregates (holds in the temporary storage unit 103) the sensor data of the sensor NW managed by the device. Then, the aggregation device 29-1 notifies the collecting server 26 of the aggregated sensor data. In addition, the aggregation device 29-1 manages the sensor information and the adapter 28-1 in the local sensor NW, and manages the communication state of the sensor NW from the collection state of the sensor data.

Furthermore, when the sensor data can be collected using the local sensor NW from the communication state of the local sensor NW, the aggregation device 29-1 collects the sensor data using the local sensor NW. When the sensor data cannot be collected using the local sensor NW, the aggregation device 29-1 issues a sensor data acquire request to the aggregation device of another sensor NW using the global network.

Upon receipt of the sensor data acquire request from the aggregation device 29-1, the aggregation device 29-1 determines whether or not the sensor data can be acquired using the local sensor NW. If the sensor data can be acquired using the local sensor NW, the aggregation device 29-1 requests the adapter 28-1 to acquire the sensor data. If the sensor data cannot be acquired, the aggregation device 29-1 further transfers a sensor data acquire request to the aggregation device 29-1 of another sensor NW.

If the aggregation device 29-1 receives the sensor data of another sensor NW from the adapter 28-1 as a result of the request to the adapter 28-1, the device has the function of transferring the sensor data to the aggregation device 29-1 which manages the sensor NW.

The aggregation device 29-1 periodically confirms the communication by polling to the adapter 28-1, manages the connection environment of the sensor NW, and manages the information about the vicinal sensor to the adapter 28-1 which has received the confirmation.

The adapter 28-1 is connected to a plurality of sensor NWs, and returns a reply in response to the communication confirm request transmitted from the aggregation device 29-1 of each sensor NW. Then, the adapter 28-1 transmits the information about the vicinal sensor. One or more adapters 28-1 are arranged in the sensor NWs or between the sensor NWs.

When a sensor NW is divided or the communication quality of the sensor NW is degraded, and if the adapter 28-1 receives a sensor data acquire request from the aggregation device 29-1 of the sensor NW, then the adapter 28-1 performs the following process. The adapter 28-1 issues a sensor data acquire request to the sensor 25 in another target sensor NW, and collects the sensor data.

Next, the block diagram of the functions of the adapter 28-1 and the aggregation device 29-1 is described below. Since the block diagram of the functions of the sensor 25, the collecting server 26, and the management server 27 is respectively similar to those illustrated in FIGS. 7, 8, and 9, the explanation is omitted here.

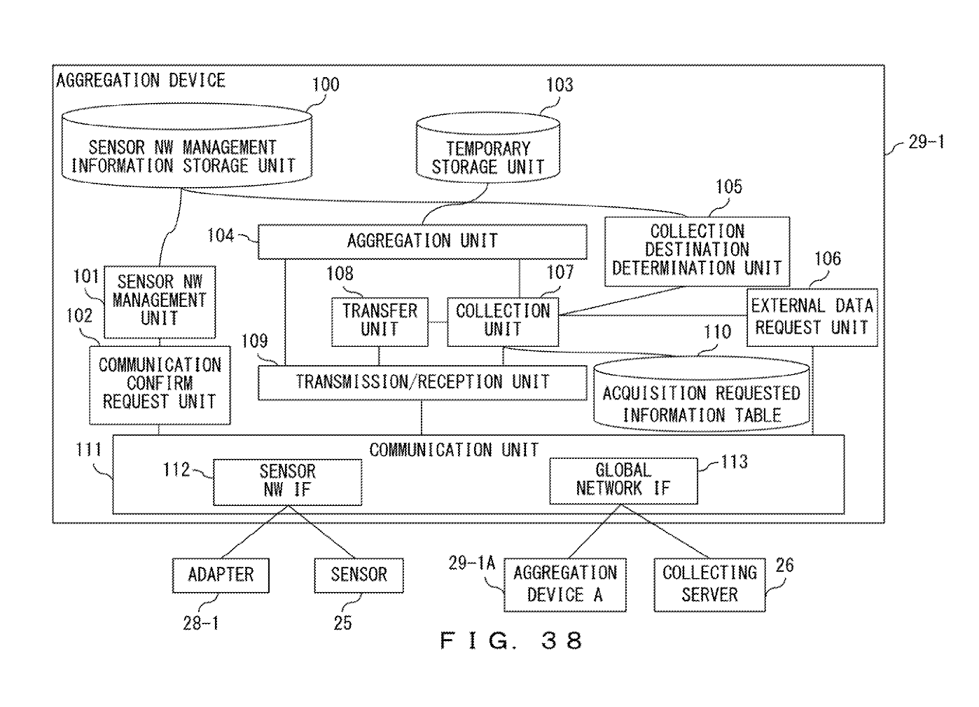

FIG. 38 is a block diagram of the function of the aggregation device according to the second mode for embodying the present invention (embodiment 1). Unlike FIG. 36, FIG. 38 indicates no relation lines between the sensor NW management information storage unit 100 and the collection unit 107.

In FIG. 38, the collection unit 107 performs the polling to the sensor 25 in the local sensor NW to periodically collect the sensor data. In this case, the collection unit 107 requests the collection destination determination unit 105 to determine a collection destination.

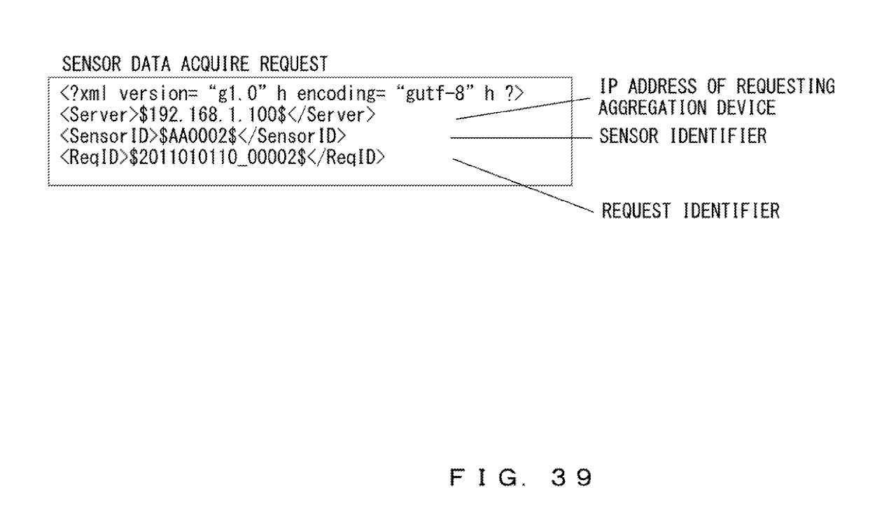

If the collection destination determination unit 105 determines that a sensor data acquire request can be issued to the sensor 25 in the local sensor NW, the collection unit 107 issues a sensor data acquire request to the sensor 25 through the transmission/reception unit 109. If it is determined that the sensor data acquire request cannot be issued, the collection unit 107 calls the external data request unit 106, and issues a sensor data acquire request to another sensor NW. The contents of the sensor data acquire request to another sensor NW are described with reference to FIG. 39.

FIG. 39 is an example of the contents of the sensor data acquire request to another sensor NW according to the second mode for embodying the present invention (embodiment 1). The sensor data acquire request to another sensor NW includes an “IP address”, a “sensor identifier”, and a “request identifier”. The “IP address” refers to an IP address of the requesting aggregation device 29-1. The “sensor identifier” refers to identification information identifying the sensor 25 at which the sensor data is to be acquired. The “request identifier” refers to identification information identifying the request.

When the collection destination determination unit 105 determines the destination where the sensor data is to be acquired, the collection unit 107 describes the information about the acquisition destination on the acquisition requested information table 110.

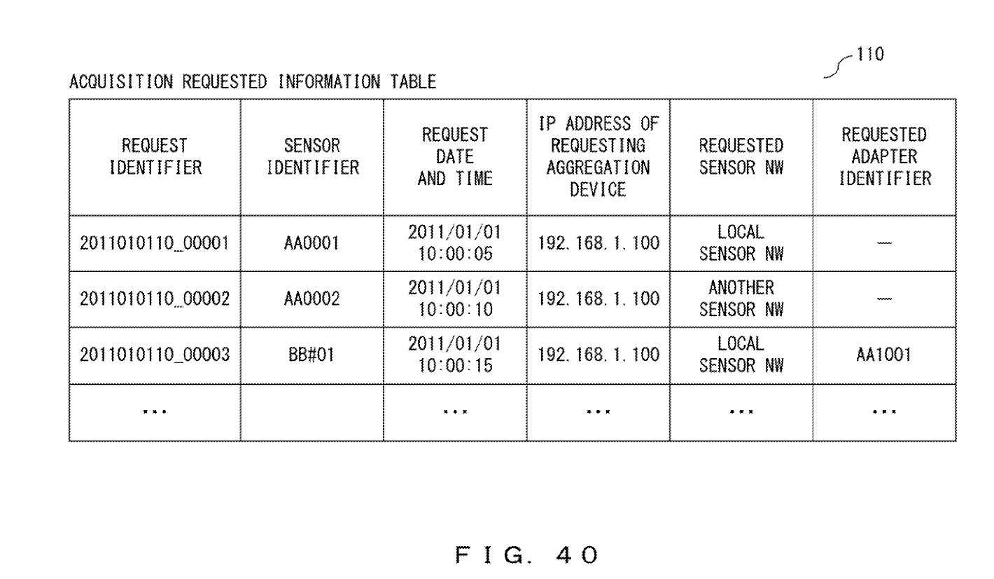

FIG. 40 is an example of the acquisition requested information table according to the second mode for embodying the present invention (embodiment 1). The acquisition requested information table includes the data items of a “request identifier”, a “sensor identifier”, a “request date and time”, the “IP address of a requesting aggregation device”, a “requested sensor NW”, and a “requested adapter identifier”.

The “request identifier” refers to the identification information for identification of request information. The “sensor identifier” refers to the identification information for identification of a sensor. The “request date and time” refers to the date and time when the request information is issued. The “IP address of the requesting aggregation device” refers to the IP address of the requesting aggregation device 29-1. The “requested sensor NW” refers to that the requested sensor NW is the local sensor NW or another sensor NW. The “requested adapter identifier” refers to the identification information for identification of the requested adapter 28-1.

Back in FIG. 36, the collection unit 107 is activated when the transmission/reception unit 109 receives the sensor data. In this case, the collection unit 107 determines whether or not the received sensor data is the sensor information about the local sensor NW, and performs the following process.

When the received sensor data is the sensor information about the sensor NW managed by the collection unit 107 (received from the sensor 25), the collection unit 107 passes the sensor data to the aggregation unit 104.

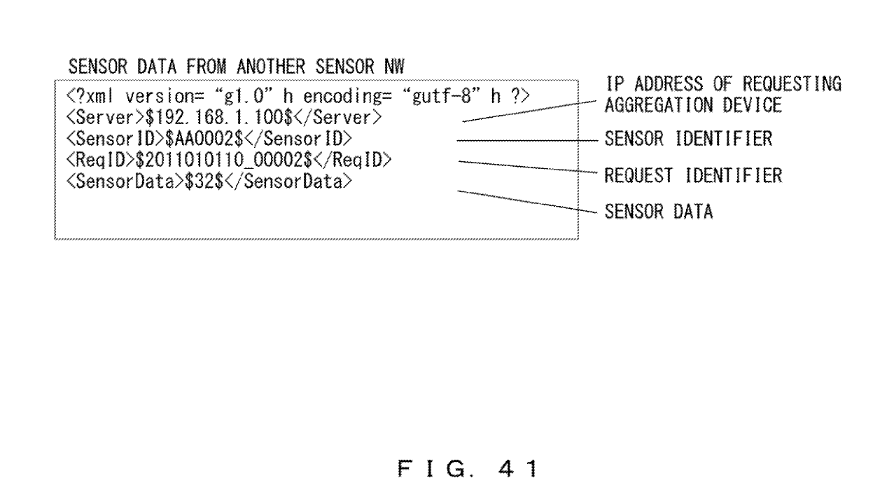

When the received sensor data is the sensor information about the sensor NW not managed by the collection unit 107 (received from another aggregation device), the collection unit 107 converts the format of the sensor data and passes the resultant data to the aggregation unit 104. FIG. 41 is an example of the sensor data from another sensor NW received from another aggregation device.

FIG. 41 illustrates an example of the sensor data transmitted from another sensor NW in the second mode for embodying the present invention (embodiment 1). The sensor data transmitted from the other sensor NW includes the “IP address of a requesting aggregation device”, a “sensor identifier”, a “request identifier”, “sensor data”.

The “IP address of a requesting aggregation device” refers to the IP address of the requesting aggregation device 29-1. The “sensor identifier” refers to the identification information for identification of the sensor to be acquired. The “request identifier” refers to the identification information for identification of a request. The “sensor data” refers to the contents of the data acquired from the sensor 25 from which the sensor data has been acquired.

If the received sensor data is the sensor information about the sensor NW not managed by the collection unit 107 (if the data is received from the adapter 28-1), the collection unit 107 extracts the request identifier from the sensor data. Then, the collection unit 107 extracts from acquisition requested information table 110 the IP address of the aggregation device to which the data is to be transferred based on the extracted request identifier. The collection unit 107 passes the sensor data to the transfer unit 108 together with the IP address of the aggregation device to which the data is to be transferred.

The collection unit 107 is activated when the transmission/reception unit 109 receives the sensor data acquire request from the external aggregation device 29-1. In this case, the collection unit 107 notifies the collection destination determination unit 105 of a collection destination determine request.

When the collection destination determination unit 105 determines in response to the notified determine request that a sensor data acquire request can be issued using the local sensor NW, the collection unit 107 issues the sensor data acquire request to the adapter 28-1 through the transmission/reception unit 109. When the collection destination determination unit 105 determines that the sensor data acquire request cannot be issued using the local sensor NW, the collection unit 107 calls the external data request unit 106. Upon receipt of the call from the collection unit 107, the external data request unit 106 transfers the sensor data acquire request to another sensor NW.

The transmission/reception unit 109 is periodically activated by the collection unit 107, transmits the sensor data acquire request to the sensor 25 in the local sensor NW, and transmits the sensor data acquire request to the adapter 28-1 and another aggregation device 29-1A.

The aggregation device 29-1 receives sensor data and a sensor data acquire request from the sensor 25, the adapter 28-1, and another aggregation device 29-1A. The received sensor data and request are reported to the aggregation unit 104. Upon completion of the aggregation of the sensor data, the transmission/reception unit 109 is activated by the aggregation unit 104, and transmits the aggregated sensor data to the collecting server 26.

The aggregation unit 104 aggregates the collected sensor data, that is, sequentially stores the data, in the temporary storage unit 103. Upon completion of the aggregation, the aggregation unit 104 notifies the collecting server 26 of the sensor data through the transmission/reception unit 109.

The transfer unit 108 transfers the sensor data to the aggregation device 29-1 using the global network.

The collection destination determination unit 105 is activated by the collection unit 107, receives a sensor data acquire request to the local sensor NW and an external sensor data acquire request, and determines the communication state in the local sensor NW. When the collection destination determination unit 105 determines whether or not the received request is a sensor data acquire request in the local sensor NW, and if the sensor data can be acquired using the local sensor NW, then the collection destination determination unit 105 notifies the collection unit 107 that the local sensor NW is available. When the sensor data cannot be acquired using the local sensor NW or the state of the communication quality of the local sensor NW is not good, the collection destination determination unit 105 notifies the collection unit 107 that the local sensor NW is not available. When the collection destination determination unit 105 determines whether or not the received request has been issued externally, and if the sensor data acquire request can be transmitted to the adapter 28-1 through the local sensor NW, then it notifies the collection unit 107 that the local sensor NW is available. Simultaneously, the collection destination determination unit 105 notifies the collection unit 107 of the available adapter 28-1. If the local sensor NW is not available, the collection destination determination unit 105 notifies the collection unit 107 that the local sensor NW is not available.

The external data request unit 106 is activated by the collection unit 107, and issues a sensor data acquire request to the external aggregation device 29-1A.

The acquisition requested information table 110 is used to manage the information about the request identifier assigned for each request, the aggregation device 29-1, etc.

The communication confirm request unit 102 periodically performs polling to the adapter 28-1 connected to the aggregation device 29-1, and confirms the arrival of a specified message. The communication confirm request unit 102 notifies the sensor NW management unit 101 of the poll result (successful or erroneous polling). When the polling is successfully performed, the communication confirm request unit 102 notifies the sensor NW management unit 101 of the vicinal sensor information acquired from the adapter 28-1.

The sensor NW management unit 101 manages the operation state of each sensor 25 in the sensor NW and the vicinal adapter 28-1 based on the acquired sensor data. If the sensor data is directly acquired from the local sensor NW, then the sensor NW management unit 101 manages the sensor 25 by assuming that the sensor 25 which has transmitted the sensor data is normally operating. If the sensor data is acquired through another aggregation device 29-1A, then the sensor NW management unit 101 manages the sensor by assuming that the sensor 25 which has transmitted the sensor data is normally operating. If the sensor data cannot be acquired, the sensor NW management unit 101 manages the sensor 25 that the sensor 25 is not normally operating.

The sensor NW management unit 101 manages the communication quality state of the sensor NW according to the acquired sensor data. When the acquisition time of the sensor data directly acquired from the sensor NW managed by the sensor NW management unit 101 largely exceeds the average time, the sensor NW management unit 101 manages the communication quality state of the sensor NW by assuming that the communication quality of the sensor NW has been degraded.

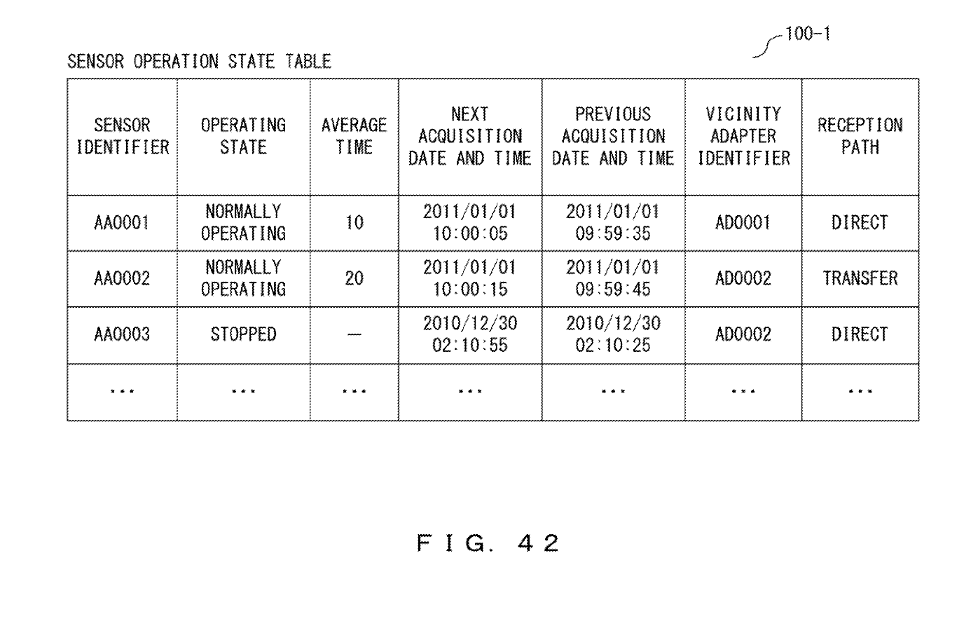

The sensor NW management information storage unit 100 is a database for holding the operating state of the sensor and the communication quality of the sensor NW. The sensor NW management information storage unit 100 stores the sensor operation state table, the sensor NW state table, and the adapter vicinity sensor information table. The sensor operation state table, the sensor NW state table, and the adapter vicinity sensor information table are described below with reference to FIGS. 42 through 44.

FIG. 42 is a sensor operation state table in the local sensor NW according to the second mode for embodying the present invention (embodiment 1). An operation state table 100-1 is a table for management of the operating state of the sensor in the local sensor NW. The operation state table 100-1 includes the data items of a “sensor identifier”, an “operating state, an “average time”, a “next acquisition date and time”, a “previous acquisition date and time”, a “vicinity adapter identifier”, and a “reception path”.

The “sensor identifier” refers to the identification information for identification of the sensor in the local sensor NW (the sensor 25 managed by the aggregation device 29-1). The “operating state” refers to the operating state (in a normally operating state, in an inactive state, etc.) of the sensor 25. The “average time” refers to the average value of the time required from the transmission of the sensor data acquire request by the aggregation device 29-1 to the reception of the response. The “next acquisition date and time” refers to the next acquisition time and date of the sensor data. The “previous acquisition time” refers to the previous acquisition date and time of the sensor data. The “previous acquisition date and time” refers to the previous acquisition date and time of the sensor data. The “vicinity adapter identifier” refers to the identifier for identification of the adapter 28-1 in the vicinity of the sensor 25. The “reception path” refers to a path indicating that the sensor data has been directly received, that the transferred sensor data has been received, etc.

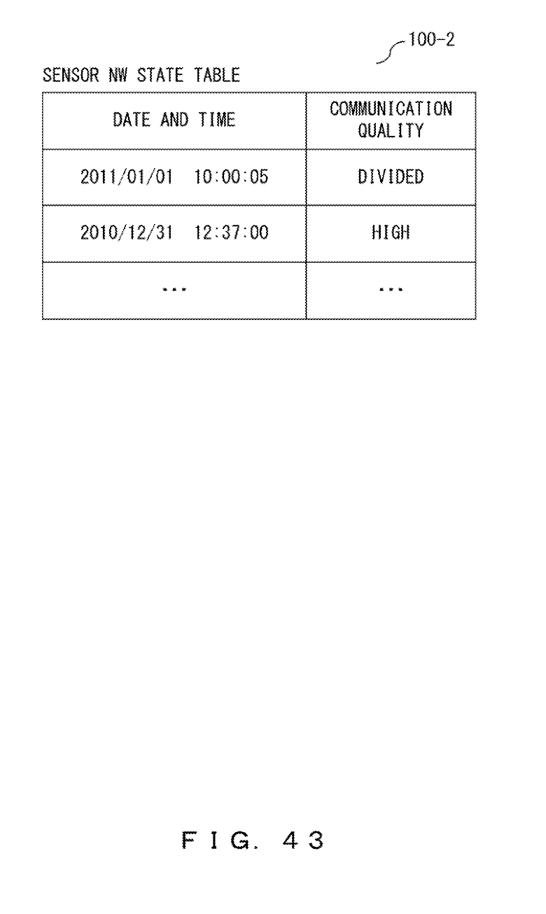

FIG. 43 is a sensor NW state table in the local sensor NW according to the second mode for embodying the present invention (embodiment 1). A sensor NW state table 100-2 manages the communication quality (division, high, medium, low, etc.) of each date and time of the sensor NW of the local sensor NW.

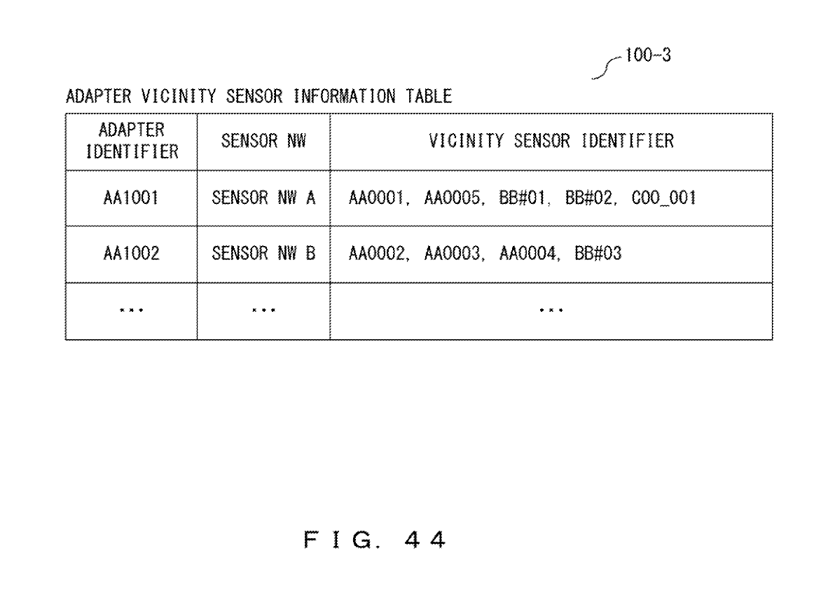

FIG. 44 is the adapter vicinity sensor information table according to the second mode for embodying the present invention (embodiment 1). An adapter vicinity sensor information table 100-3 includes the data items of an “adapter identifier”, a “sensor NW”, and a “vicinity sensor identifier”. The “adapter identifier” refers to the identification information for identification of the adapter 28-1 capable of communicating with the aggregation device 29-1. The “sensor NW” refers to a sensor NW with which the adapter 28-1 can communicate. The “vicinity sensor identifier” refers to the identification information for identification of the sensor 25 capable of communicating with the adapter 28-1.

Back in FIG. 36, the communication unit 111 includes a sensor NW interface (IF) 112 and a global network interface (IF) 113. The communication unit 111 communicates sensor data and a sensor data acquire request with the adapter 28-1, the sensor 25, the aggregation device 29-1, and the collecting server 26.

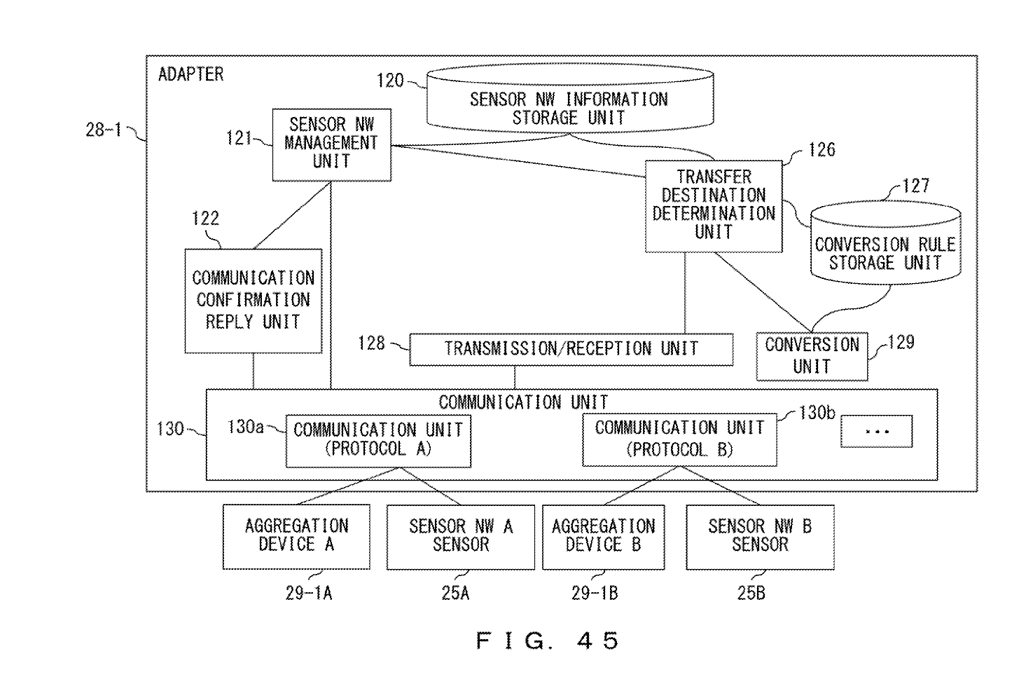

FIG. 45 is a block diagram of the function of the adapter according to the second mode for embodying the present invention (embodiment 1). The adapter 28-1 includes the sensor NW management unit 121, the communication confirmation reply unit 122, the sensor NW information storage unit 120, the transmission/reception unit 128, the transfer destination determination unit 126, the conversion unit 129, the conversion rule storage unit 127, and the communication unit 130.

The communication confirmation reply unit 122 issues a response to the communication confirm request transmitted from the aggregation devices 29-1A and 29-1B of each sensor NW connected to the adapter 28-1. The communication confirmation reply unit 122 reports the sensor information about the vicinity of the adapter 28-1 as a poll request.

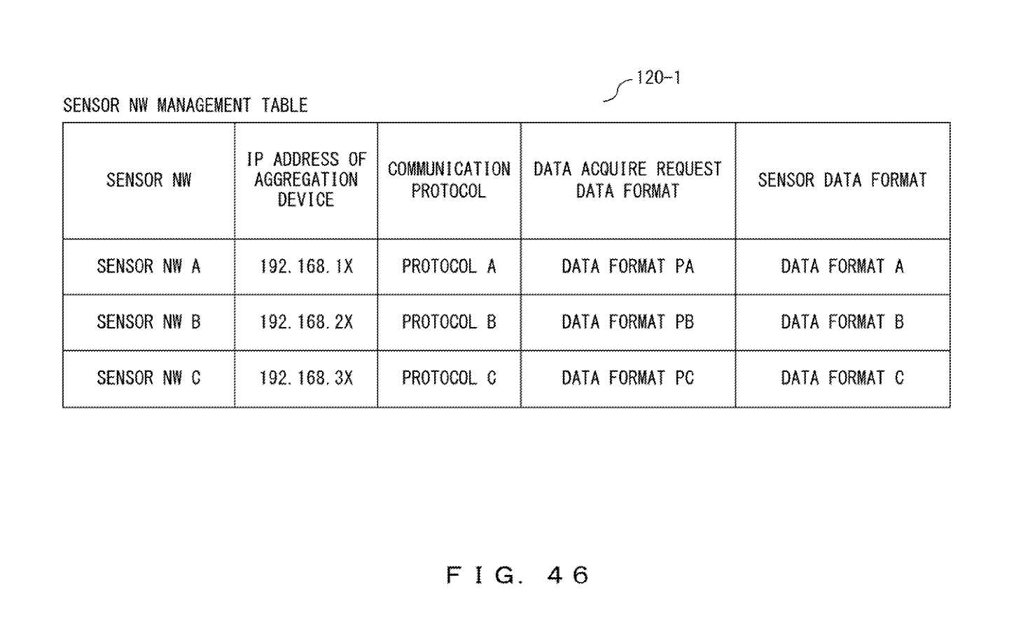

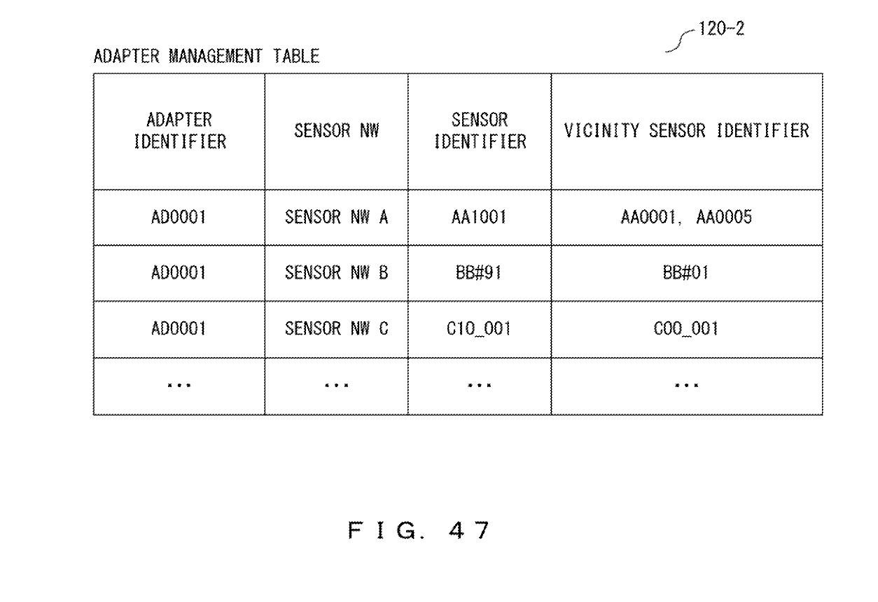

The sensor NW management unit 121 manages the sensor information about the vicinity of the adapter 28-1. The sensor NW information storage unit 120 is a database for holding the sensor NW information such as the communication protocol of each sensor NW, a data format, etc., and the sensor information such as the sensor identifier etc. belonging to each sensor NW. The sensor NW information storage unit 120 stores the sensor NW management table 120-1 and the adapter management table 120-2. The sensor NW management table 120-1 and the adapter management table 120-2 are described below with reference to FIGS. 46 and 47.

FIG. 46 FIG. 46 is an example of the sensor NW management table according to the second mode for embodying the present invention (embodiment 1). The sensor NW management table 120-1 is used to manage the information about the sensor NW such as the communication protocol, the data format of each sensor NW. The sensor NW management table 120-1 includes the data items of a “sensor NW”, the “IP address of an aggregation device”, a “communication protocol”, a “data acquire request data format”, and a “sensor data format”.

The “sensor NW” refers to the identifier of a sensor NW. The “IP address of an aggregation device” refers to the IP address of the aggregation device 29-1 corresponding to the sensor NW. The “communication protocol” refers to the communication protocol used by the sensor NW. The “data acquire request data format” refers to the identification information for identification of the format used in the data acquire request. The “sensor data format” refers to the identification information for identification of the data format used in communicating sensor data.

FIG. 47 is an example of the adapter management table according to the second mode for embodying the present invention (embodiment 1). The adapter management table 120-2 includes the data items of an “adapter identifier”, a “sensor NW”, a “sensor identifier”, and a “vicinity sensor identifier”.

The “adapter identifier” refers to the identifier for identification of an adapter. The “sensor NW” refers to the identification information for identification of the sensor NW of the sensor 25 capable of communicating with the adapter 28-1. The “sensor identifier” refers to the sensor identifier of the adapter 28-1 in the “sensor NW”. The “vicinity sensor identifier” refers to the identifier of a sensor in the vicinity of the adapter specified by the “adapter identifier”.

Back in FIG. 45, the transmission/reception unit 128 receives a sensor data acquire request or sensor data. The transmission/reception unit 128 notifies the transfer destination determination unit 126 of the received sensor data acquire request or sensor data.

The transfer destination determination unit 126 determines the transfer destination of the sensor data acquire request or the sensor data based on the sensor data acquire request or the sensor data. After determining the transfer destination, the transfer destination determination unit 126 notifies the conversion unit 129 of a data format convert request. The transfer destination determination unit 126 transmits to the determined transfer destination the sensor data whose data format has been converted by the conversion unit 129.

The conversion unit 129 converts the data format (sensor data acquire request or acquired sensor data) based on the communication protocol of the sensor NW according to the rule information stored in the conversion rule storage unit 127.

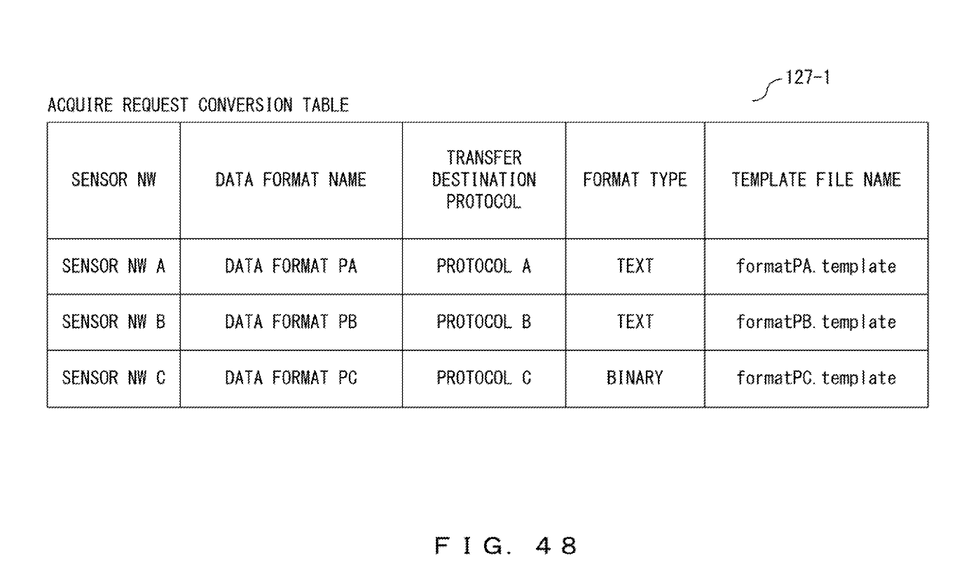

The conversion rule storage unit 127 is a database for management of the data format conversion rule (template file) to transfer the sensor data acquire request or the sensor data. The conversion rule storage unit 127 includes an acquire request conversion table 127-1 and a transmission data conversion rule table 127-2. The acquire request conversion table 127-1 and the transmission data conversion rule table 127-2 are described with reference to FIGS. 48 through 51.

FIG. 48 is an example of the acquire request conversion rule table according to the second mode for embodying the present invention (embodiment 1). The acquire request conversion table 127-1 includes the data items of a “sensor NW”, a “data format name”, a “transfer destination protocol”, a “format type”, and a “template file name”.

The “sensor NW” refers to the identifier of a sensor NW. The “data format name” refers to the name of the data format being used in the sensor NW. The “transfer destination protocol” refers to the communication protocol also being used in the sensor NW. The “format type” refers to the type of format such as text, binary, etc. The “template file name” refers to the template file name for format conversion.

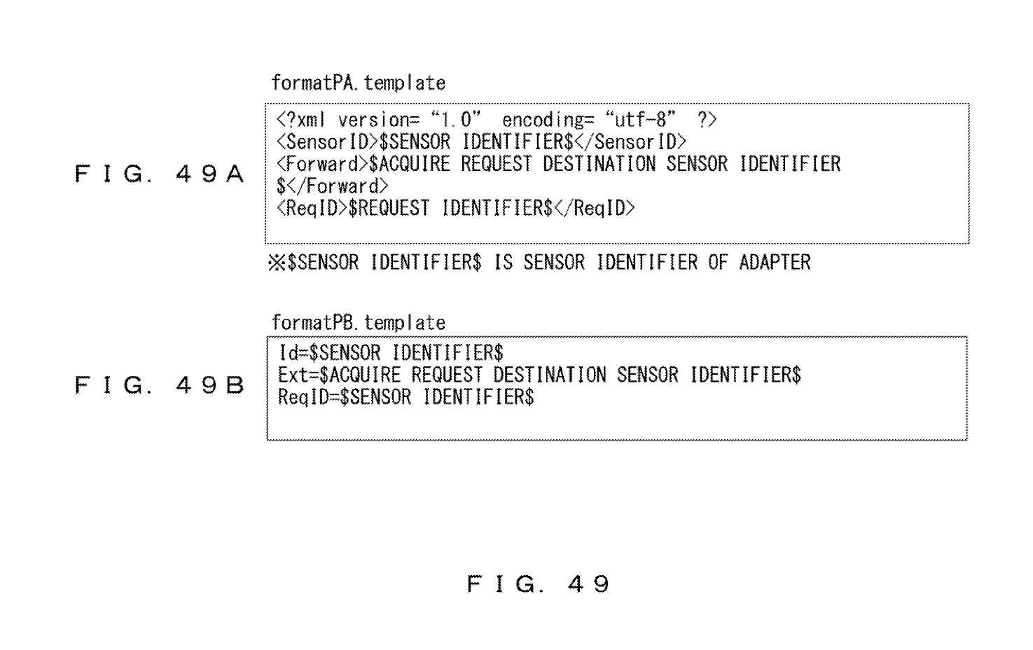

As an example of the template file used in issuing the sensor data acquire request, an example of the format PA is illustrated in FIG. 49A, and an example of the format PB is illustrated in FIG. 49B. The format PA is described in XML, and is described by enclosing a sensor identifier (sensor identifier of the adapter), a sensor identifier at the acquire request destination, and a request identifier. The format PB is described more directly than the format PA in the text format for the sensor identifier, the sensor identifier at the acquire request destination, and the request identifier. Since the format PC is binary data, it is not specifically described here. In this embodiment, the format of the data is exemplified, but a system designer is to appropriately set the format of the data.

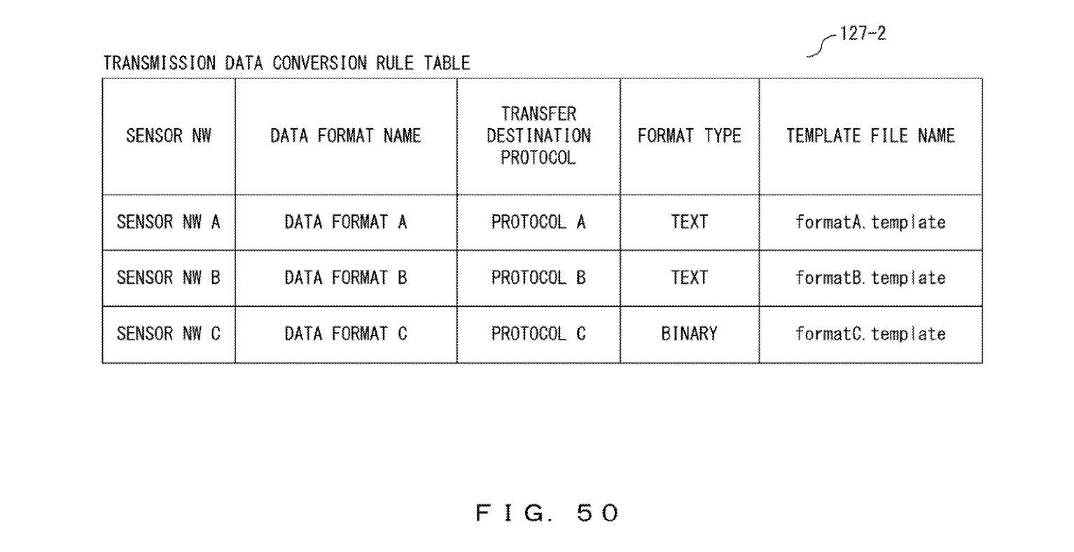

FIG. 50 is an example of the transmission data conversion rule table according to the second mode for embodying the present invention (embodiment 1). The transmission data conversion rule table 127-2 includes the data items of a “sensor NW”, a “data format name”, a “transfer destination protocol”, a “format type”, and a “template file name”.

The “sensor NW” refers to the identifier of a sensor NW. The “data format name” refers to the name of the data format being used in the sensor NW. The “transfer destination protocol” refers to the communication protocol also being used in the sensor NW. The “format type” refers to the type of format such as text, binary, etc. The “template file name” refers to the template file name for format conversion.

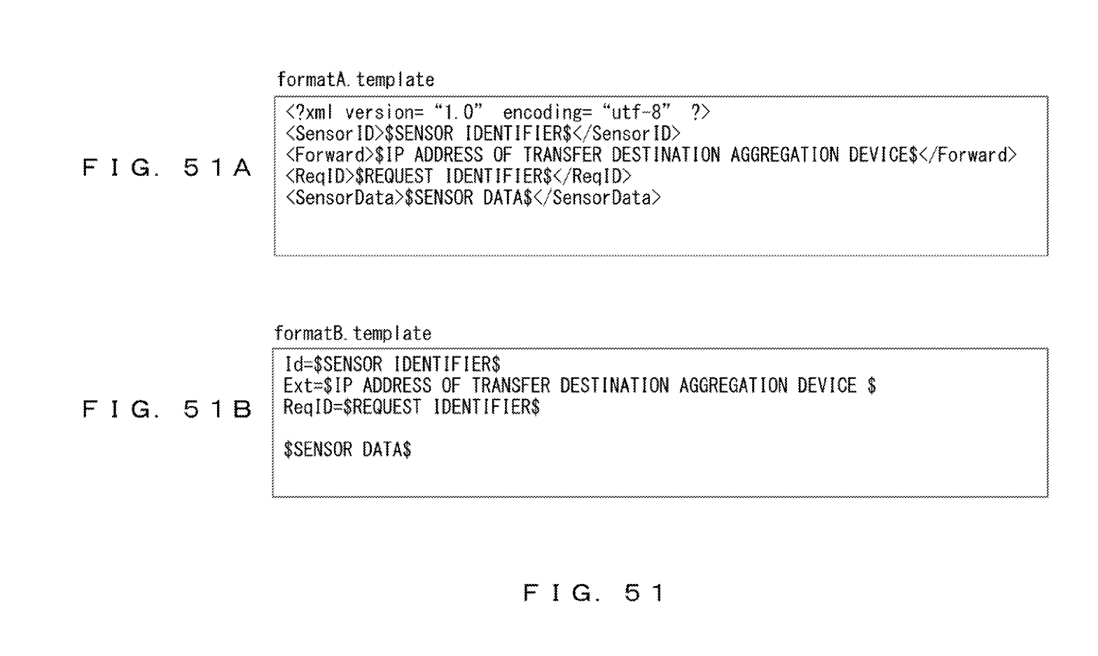

As an example of the template file, an example of the format A is illustrated in FIG. 51A, and an example of the format B is illustrated in FIG. 51B. The format A is described in XML, and described by enclosing with a tag the sensor identifier, the IP address of the aggregation device of the transfer destination, the request identifier, and the sensor data (raw data). The format B is described more directly than the format A in text format for the sensor identifier, the IP address of the transfer destination aggregation device, the request identifier, and the sensor data (raw data). Since the format PC is binary data, it is not specifically described here. In this embodiment, the format of the data is exemplified, but a system designer is to appropriately set the format of the data.

Back in FIG. 45, the communication unit 130 communicates the sensor data acquire request or the sensor data with the sensor 25. The communication unit 130 manages the topology information about the sensor NW, and notifies the sensor NW management unit 121 of the vicinal sensor information.

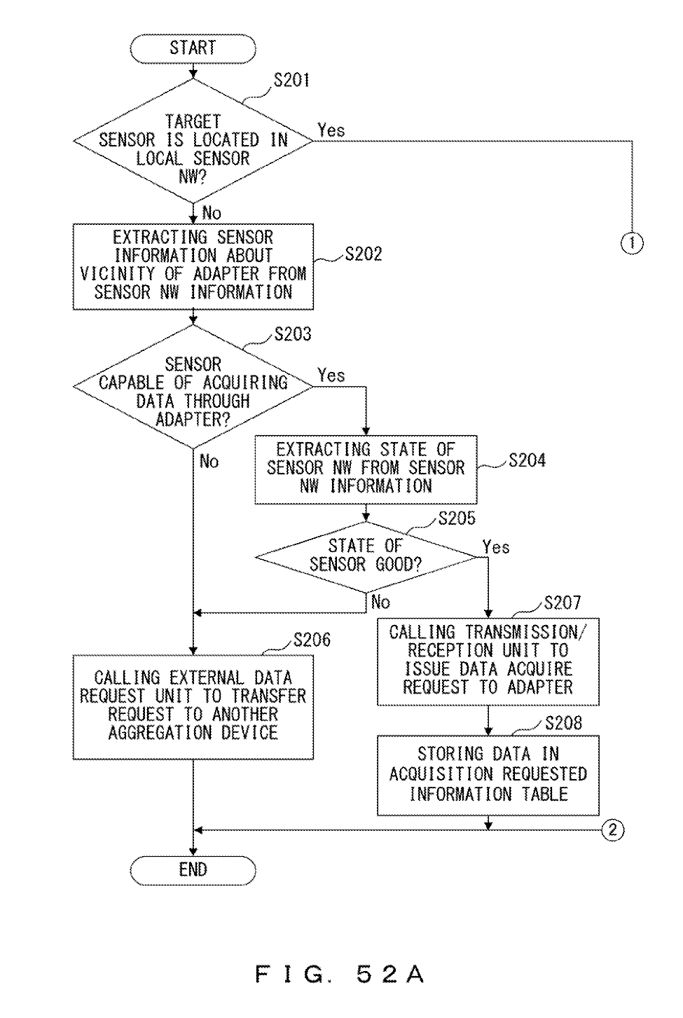

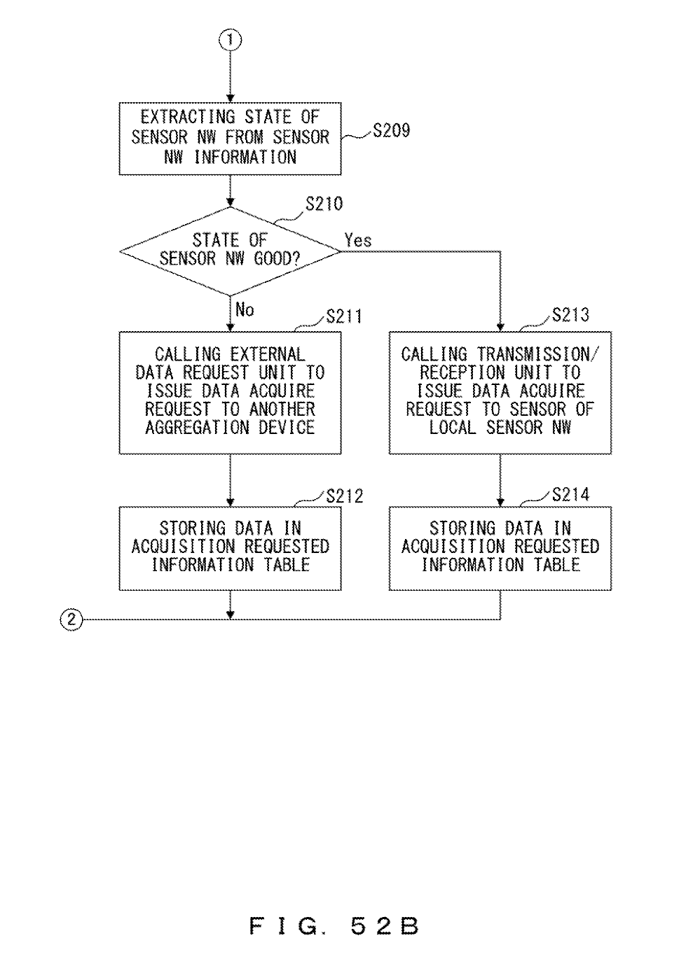

FIGS. 52A and 52B are an example of the flowchart of determining the collection destination of the aggregation device according to the second mode for embodying the present invention (embodiment 1). The collection unit 107 performs polling to the sensor 25 in the local sensor NW to periodically collect the sensor data. In this case, the collection unit 107 issues to the collection destination determination unit 105 a request to determine the destination of the identifier of the sensor 25 in the local sensor NW and the sensor data acquire request for each polling operation.

Upon receipt of the determine request notification, the collection destination determination unit 105 determines whether or not the target sensor (sensor identifier reported from the collection unit 107) for acquiring the sensor data is the sensor in the local sensor NW using the operation state table 100-1 (FIG. 42) (S201). When there is no target sensor in the operation state table 100-1 (target sensor is not located in the local sensor NW) (NO in S201), the collection destination determination unit 105 performs the following process. The collection destination determination unit 105 extracts the “vicinity sensor identifier” of the adapter 28-1 from the adapter vicinity sensor information table 100-3 (FIG. 44) (S202).

The collection destination determination unit 105 determines through which adapter 28-1 the target sensor can acquire data (S203). In this embodiment, the collection destination determination unit 105 determines whether or not the identifier of the target sensor is included in the “vicinity sensor identifier” extracted in S202.

If the collection destination determination unit 105 determines that target sensor is not included in the “vicinity sensor identifier” extracted in S202 (NO in S203), the collection unit 107 performs the following process. The collection unit 107 calls the external data request unit 106 to transfer the sensor data acquire request to the aggregation device 29-1 (S206).

If the collection destination determination unit 105 determines that the identifier of the target sensor is included in the “vicinity sensor identifier” extracted in S202 (YES in S203), then the collection destination determination unit 105 performs the following process. The collection destination determination unit 105 extracts the state (communication quality) of the local sensor NW from the sensor NW state table 100-2 (FIG. 43) (S204). The collection destination determination unit 105 determines whether or not the state (communication quality) of the local sensor NW is good (S205). For example, if the “communication quality” of the latest time of the sensor NW state table 100-2 (FIG. 43) is “high” or “medium”, then the collection destination determination unit 105 determines that the state (communication quality) of the local sensor NW is good. For example, if the “communication quality” of the latest time of the sensor NW state table 100-2 (FIG. 43) is “low” or “divided”, then the collection destination determination unit 105 determines that the state (communication quality) of the local sensor NW is not good.

If the state (communication quality) of the local sensor NW extracted in S205 is not good (NO in S205), then the collection unit 107 calls the external data request unit 106 to transfer the sensor data acquire request to another aggregation device 29-1 (S206).

If the state (communication quality) of the local sensor NW extracted in S205 is good (YES in S205), then the collection destination determination unit 105 acquires the “adapter identifier” corresponding to the “vicinity sensor identifier” extracted in S202 from the adapter vicinity sensor information table 100-3. The collection destination determination unit 105 notifies the collection unit 107 of the acquired adapter identifier. The collection unit 107 calls the transmission/reception unit 109 to issue a data acquire request to the adapter 28-1 identified by the notified adapter identifier (S207). The collection unit 107 stores the data corresponding to the data acquire request to be issued to the adapter 28-1 in the acquisition requested information table 110 (FIG. 40) (S208).

If the target sensor is stored in the operation state table 100-1 (FIG. 42) (if the target sensor is located in the local sensor NW) (YES in S201), then the collection destination determination unit 105 performs the following process. The collection destination determination unit 105 extracts the state (communication quality) of the sensor NW from the sensor NW state table 100-2 (FIG. 43) (S209). The collection destination determination unit 105 determines whether or not the extracted state (communication quality) of the local sensor NW is good (S210).

When the state (communication quality) of the sensor NW extracted in S209 is not good (NO in S210), the collection unit 107 calls the external data request unit 106 to issue the data acquire request to another aggregation device (S211). The collection unit 107 stores the data corresponding to the data acquire request issued to another aggregation device in the acquisition requested information table 110 (FIG. 40) (S212).

If the state of the sensor NW extracted in S209 is good (YES in S210), the collection unit 107 calls the transmission/reception unit 109 to issue the data acquire request to the local sensor NW (S213). The collection unit 107 stores the data corresponding to the data acquire request issued to the sensor of the local sensor NW in the acquisition requested information table 110 (FIG. 40) (S214).

Thus, if the aggregation device 29-1 determines that the sensor data of the sensor in the local sensor NW cannot be collected through the local sensor NW, then the aggregation device 29-1 can transmit the sensor data acquire request for acquiring the sensor data to another aggregation device. Furthermore, when the aggregation device 29-1 receives the sensor data acquire request transferred from another aggregation device, the aggregation device 29-1 can transmit the sensor data acquire request depending on the communication quality of the local sensor NW.

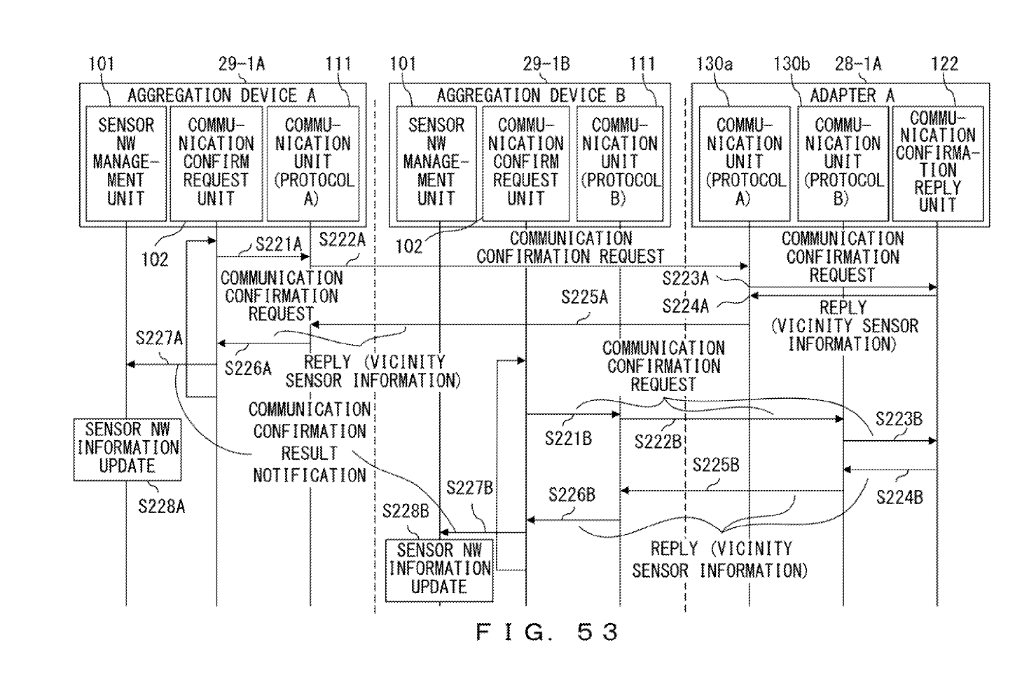

FIG. 53 is an example of the sequence of detecting (monitoring the sensor NW) the abnormal condition of the sensor NW by confirming the connection between the aggregation device and the adapter according to the second mode for embodying the present invention (embodiment 1). The aggregation device 29-1 monitors the state of the sensor NW by periodically performing polling to the adapter 28-1.

The communication confirm request unit 102 of the aggregation device A (29-1A) issues a communication confirm request to the adapter A (28-1A) through the communication unit 111 (S221A, S222A). Since the protocol A is used between the aggregation device A (29-1A) and the adapter A (28-1A), the communication unit 111 for the protocol A is used.

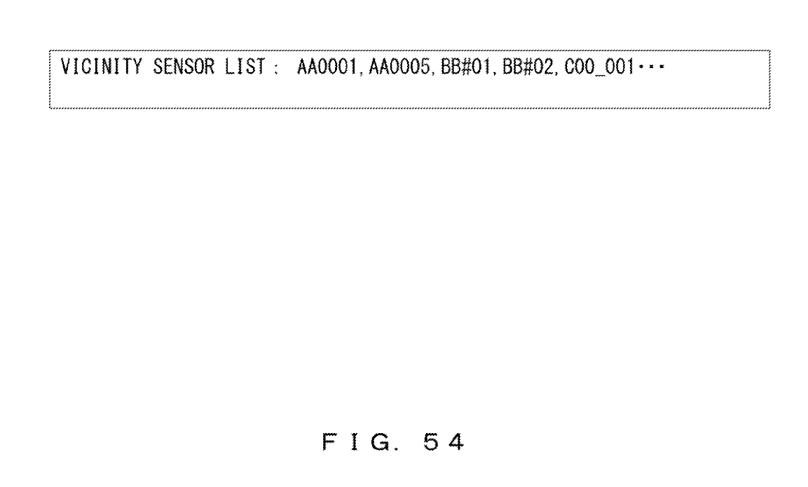

The communication confirmation reply unit 122 of the adapter A (28-1A) receives the communication confirm request through a communication unit 130a for the protocol A (S223A). The adapter A (28-1A) transmits the vicinity sensor information to the aggregation device A (29-1A) through the communication unit 130a (S224A, S225A). The response (vicinity sensor information) to the communication confirm request is described with reference to FIG. 54.

FIG. 54 is an example of the vicinity sensor information according to the second mode for embodying the present invention (embodiment 1). The vicinity sensor information includes the identifier list information about the sensor 25 in the vicinity of the adapter 28-1 itself, that is, the sensor 25 capable of communicating with (being connected to) the adapter 28-1.

Back in FIG. 53, upon receipt of the response (vicinity sensor information) to the communication confirm request from the adapter A (28-1A), the communication unit 111 of the aggregation device A (29-1A) notifies the communication confirm request unit 102 of the response (vicinity sensor information) (S226A). The communication confirm request unit 102 notifies the sensor NW management unit 101 of the response (vicinity sensor information) reported as a communication confirmation result (S227A). Upon receipt of the communication confirmation result, the sensor NW management unit 101 updates the sensor NW management information storage unit 100 using the notified response (vicinity sensor information) (S228A). Practically, the sensor NW management unit 101 enters the pair of the adapter 28-1 which has returned the response and the list of the sensors 25 included in the vicinity sensor information in the adapter vicinity sensor information table 100-3 using the vicinity sensor information in the response.

When the communication confirmation result is not received, the sensor NW management unit 101 determines that the sensor NW between the adapter 28-1 and the aggregation device 29-1 has been divided. In this case, the sensor NW management unit 101 enters the date and time when the communication confirm request is transmitted and the “divided” as the communication quality in the sensor NW state table 100-2.

When the time required to receive the communication confirmation result is longer than the preset time, the sensor NW management unit 101 determines that the communication state of the sensor NW between the adapter 28-1 and the aggregation device 29-1 is not good. In this case, the sensor NW management unit 101 enters in the sensor NW state table 100-2 the date and time when the communication confirm request is transmitted, and “low” as the communication quality.

Also when the communication confirm request unit 102 of the aggregation device B (29-1B) transmits the communication confirm request to the adapter A (28-1A), the same process is performed as in the case of the aggregation device A (29-1A) (S221B through S228B).

Thus, the aggregation device 29-1 transmits the communication confirm request to the adapter 28-1, and can detect the abnormal condition of the local sensor NW depending on the reply from the adapter 28-1 in response to the communication confirm request.

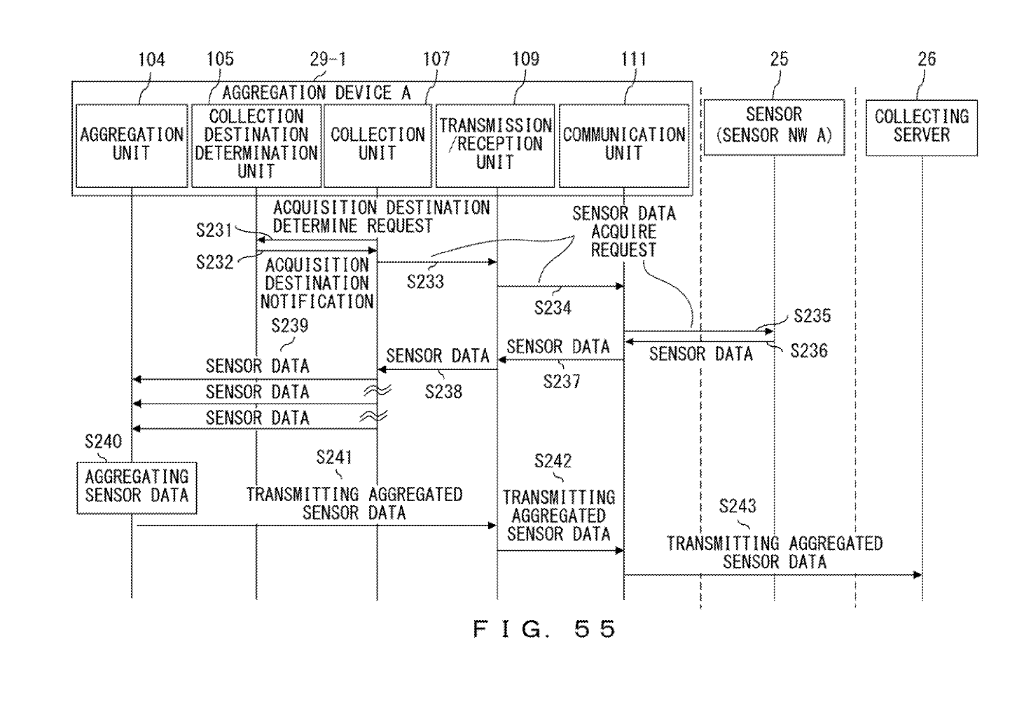

FIG. 55 is an example of the sensor data collection sequence in a normal state (without a fault with the sensor NW) according to the second mode for embodying the present invention (embodiment 1). FIG. 55 is the sequence performed when “YES” is selected in S210 in FIGS. 52A and 52B.

The aggregation device 29-1 periodically performs polling to the sensor 25 in the local sensor NW, and acquires the sensor data. In this case, the aggregation device 29-1 receives and aggregates the sensor data from the sensor 25 in the sensor NW, and transmits the aggregated sensor data to the collecting server 26.

Practically, the collection unit 107 of the aggregation device 29-1 notifies the collection destination determine unit 105 of the acquisition destination determine request (S231). The collection destination determination unit 105 notifies the collection unit 107 of the acquisition destination of the sensor data based on the process in FIGS. 52 A and 52B (S232). The collection unit 107 notifies the sensor of the sensor data acquire request through the transmission/reception unit 109 and the communication unit 111 (S233 through S235). Upon receipt of the sensor data acquire request, the sensor 25 transmits the sensor data to the aggregation device A (S236).

The collection unit 107 receives the sensor data through the communication unit 111 and the transmission/reception unit 109 (S237, S238). The collection unit 107 transmits the received sensor data to the aggregation unit 104 (S239). Thus, the sensor data transmitted from each sensor 25 is transmitted to the aggregation unit 104 by performing the processes in S231 through S239 by the polling operation.

The aggregation unit 104 aggregates the sensor data transmitted from each sensor 25, that is, stores the data in the temporary storage unit 103 (S240). The aggregation unit 104 transmits the aggregated sensor data (stored in the temporary storage unit 103) to the collecting server 26 through the transmission/reception unit 109 and the communication unit 111 (S241 through S243).

The sensor NW management unit 101 measures the time and the average value to acquire the sensor data, and stores the data in the storage device. When there occurs an error during the acquisition of the sensor data, or when it is determined that a long time is required (the average value is largely deviated), the sensor NW management unit 101 enters in the sensor NW state table 100-2 the determined date and time and “divided” or “low” for the communication quality.

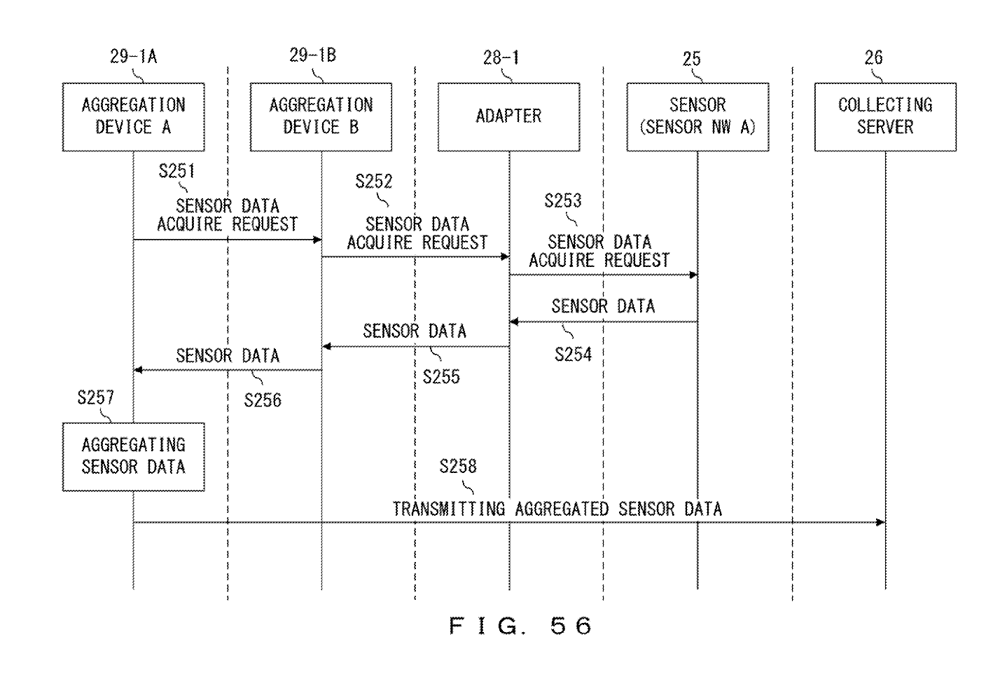

FIG. 56 is an example of the sequence among the function blocks of the aggregation device collecting the sensor data through the aggregation device which manages another sensor NW and transmitting the sensor data aggregated in the collecting server according to the second mode for embodying the present invention (embodiment 1). In this embodiment, when the aggregation device cannot collect the sensor data in the local sensor NW, the sensor data is collected through the aggregation device which manages another sensor NW, and the aggregated sensor data is transmitted to the collecting server. That is, in FIG. 53, the sequence is performed when the sensor NW management unit 101 detects an abnormal condition of the sensor NW by the communication confirmation between the aggregation device 29-1 and the adapter 28-1. Practically, FIG. 56 illustrates the sequence performed when “NO” is selected in S205 in FIGS. 52A and 52B, or when “NO” is selected in S210.

The aggregation device A (29-1A) notifies the aggregation device B (29-1B) of the sensor data acquire request illustrated in FIG. 39 (S251). The aggregation device B (29-1B) retrieves the adapter 28-1 corresponding to the sensor identifier included in the sensor data acquire request from each table of the sensor NW management information storage unit 100, and notifies the detected adapter 28-1 of the sensor data acquire request (S252). The adapter 28-1 notifies the target sensor 25 of the sensor data acquire request based on the received sensor data acquire request (S253).

Upon receipt of the sensor data acquire request, the sensor 25 returns the sensor data illustrated in FIG. 41 to the adapter 28-1 (S254). The adapter 28-1 transmits the received sensor data to the aggregation device B (29-1B) (S255). The aggregation device B (29-1B) transmits the sensor data to the aggregation device A (29-1A) (S256).

The aggregation device A (29-1A) aggregates the sensor data transmitted from the aggregation device B (29-1B), that is, stores the data in the temporary storage unit 103 (S257). The aggregation device A (29-1A) transmits the aggregated sensor data (stored in the temporary storage unit 103) to the collecting server 26 (S258).

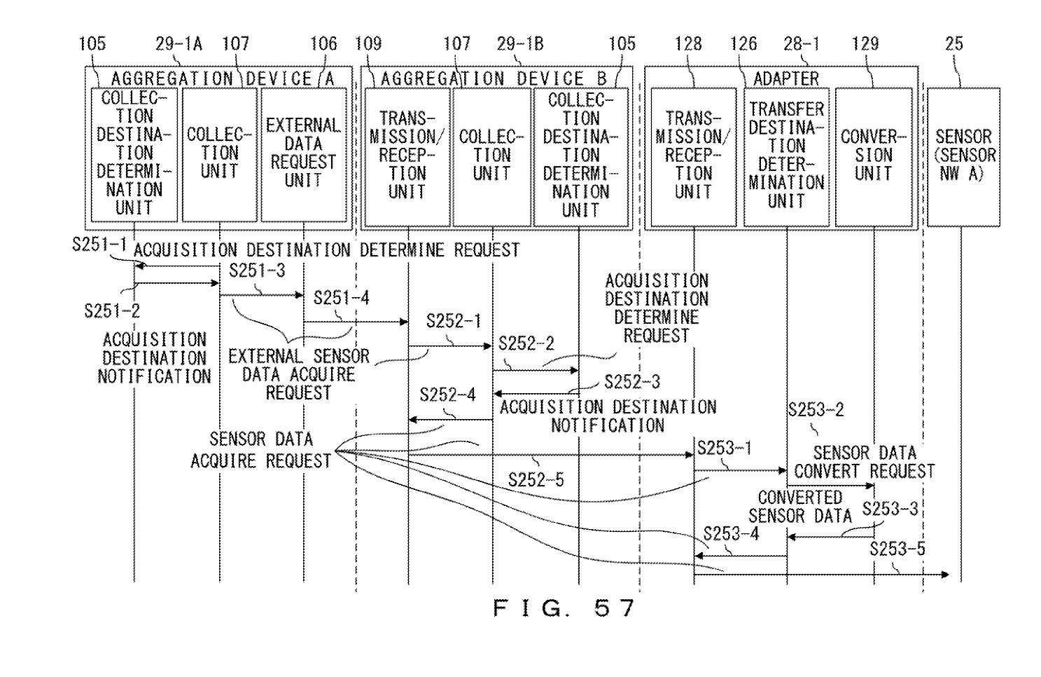

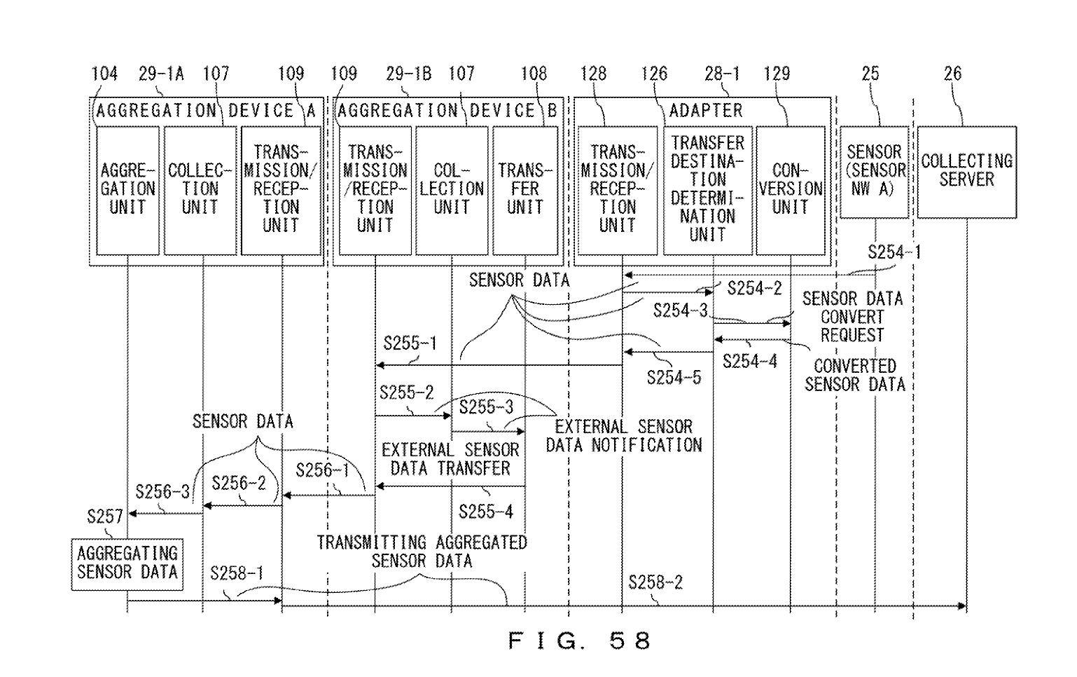

Next, the detailed sequence among the function blocks in FIG. 56 is described with reference to FIGS. 57 and 58 separately for the processes before the sensor data acquire request and the process of collecting sensor data.

FIG. 57 is an example of the detailed sequence in S251 through S253 in FIG. 56. The collection unit 107 of the aggregation device A (29-1A) notifies the collection destination determination unit 105 of the acquisition destination determine request for the sensor data acquired from the target sensor (S251-1). The collection destination determination unit 105 notifies the collection unit 107 that there is no sensor 25 from which the sensor data is to be acquired in the local sensor NW according to the flow in FIGS. 52A and 52B (S251-2). The collection unit 107 notifies the external data request unit 106 that a request to acquire the sensor data is to be issued to the aggregation device B (29-1B) (S251-3). The external data request unit 106 notifies the aggregation device B (29-1B) of the sensor data acquire request illustrated in FIG. 39 (S251-4).

Upon receipt of the sensor data acquire request transmitted from the aggregation device A (29-1A), the transmission/reception unit 109 of the aggregation device B (29-1B) transmits the request to the collection unit 107 (S252-1). Upon receipt of the sensor data acquire request, the collection unit 107 notifies the collection destination determination unit 105 of the acquisition destination determine request including the sensor identifier in the sensor data acquire request (S252-2).

The collection destination determination unit 105 retrieves the adapter corresponding to the sensor identifier of the received acquisition destination determine request from each table of the sensor NW management information storage unit 100 according to the flow in FIGS. 52A and 52B, and notifies the collection unit 107 of the retrieved adapter as an acquisition destination (S252-3). The collection unit 107 notifies the adapter 28-1 of the sensor data acquire request through the transmission/reception unit 109 (S252-4, S252-5).

Upon receipt of the sensor data acquire request from the aggregation device B (29-1B), the transmission/reception unit 128 of the adapter 28-1 transmits the request to the transfer destination determination unit 126 (S253-1). The transfer destination determination unit 126 determines the sensor 25 to which the sensor data acquire request is to be transferred based on the received sensor data acquire request, and notifies the conversion unit 129 of the sensor data format convert request (S253-2). The conversion unit 129 converts the data format of the sensor data acquire request according to the acquire request conversion table 127-1 illustrated in FIG. 48. The conversion unit 129 transmits the format converted sensor data acquire request to the transmission/reception unit 128 through the transfer destination determination unit 126 (S253-3, S253-4). The transmission/reception unit 128 transmits the format converted sensor data acquire request to the sensor 25 determined as a transfer destination (S253-5).

FIG. 58 is an example of the detailed sequence in S254 through S258 in FIG. 56. Upon receipt of the sensor data acquire request transmitted from the adapter 28-1, the sensor 25 transmits the sensor data to the adapter 28-1 (S254-1).

Upon receipt of the sensor data transmitted from the sensor 25, the transmission/reception unit 128 of the adapter 28-1 transmits the data to the transfer destination determination unit 126 (S254-2). The transfer destination determination unit 126 notifies the conversion unit 129 of the sensor data format convert request (S254-3). The conversion unit 129 refers to the transmission data conversion rule table 127-2 in FIG. 50, and converts the received sensor data into the data format corresponding to the transfer destination sensor NW. The conversion unit 129 transmits the format converted sensor data to the transfer destination determination unit 126 (S254-4). The transfer destination determination unit 126 transmits the format converted sensor data to the aggregation device B (29-1B) through the transmission/reception unit 128 (S254-5, S255-1).

Upon receipt of the sensor data transmitted from the adapter 28-1, the transmission/reception unit 109 of the aggregation device B (29-1B) notifies the transfer unit 108 of the acquisition of the sensor data from an external sensor NW through the collection unit 107 (S255-2, S255-3). The transfer unit 108 transfers the sensor data of the external sensor NW to the aggregation device A (29-1A) through the transmission/reception unit 109 (S255-4, S256-1).

Upon receipt of the sensor data transmitted from the aggregation device B (29-1B), the transmission/reception unit 109 of the aggregation device A (29-1A) transmits the data to the aggregation unit 104 through the collection unit 107 (S256-2, S256-3). The aggregation unit 104 aggregates the received sensor data, that is, holds the data in the temporary storage unit 103 (S257). The aggregation unit 104 transmits the aggregated sensor data (the sensor data held in the temporary storage unit 103) to the collecting server 26 through the transmission/reception unit 109 (S258-1, S258-2).

Thus, the aggregation device 29-1A transmits to the adapter 28-1 through the aggregation device 29-1B the sensor data acquire request to acquire the sensor data. The aggregation device 29-1A can acquire the sensor data corresponding to the sensor data acquire request from the adapter 28-1 through the aggregation device 29-1B.

In FIGS. 57 and 58, the communication units 111 and communication unit 130 are omitted. Practically, the communication units 111 and 130 are arranged closer to the network side than the transmission/reception units 109 and 128, and performs the communication of data.

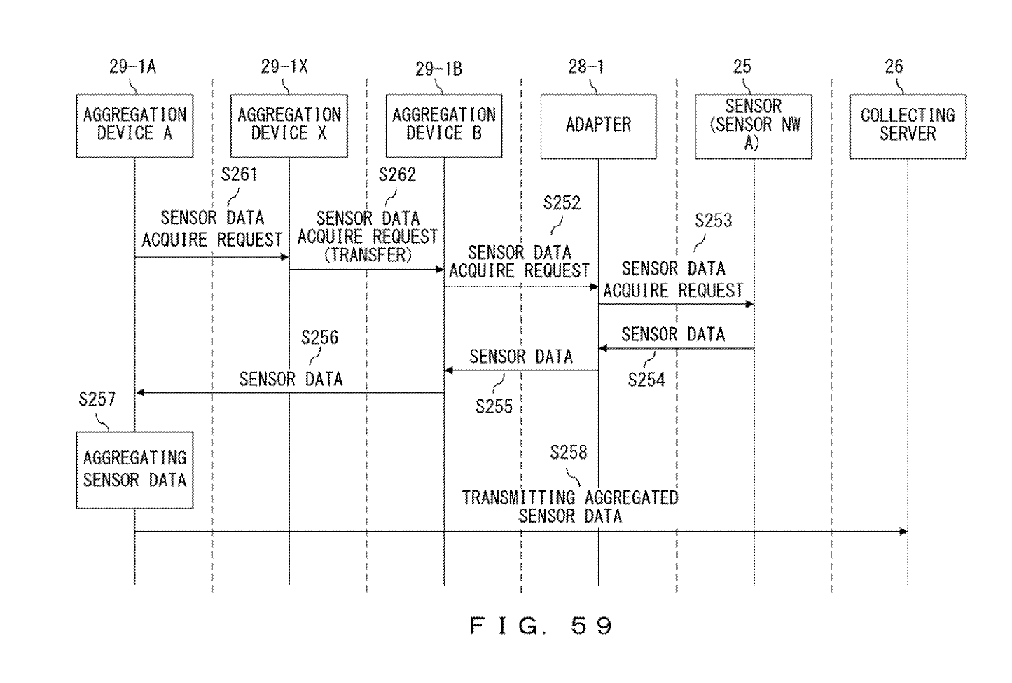

FIG. 59 is an example of the entire sequence of transferring to another aggregation device the sensor data acquire request issued from the external sensor NW according to the second mode for embodying the present invention (embodiment 1). The sequence in FIG. 59 is to add the aggregation device X (29-1X) between the aggregation device A (29-1) and the aggregation device B (29-1B) in the sequence in FIG. 56. FIG. 59 is a sequence performed when “NO” is selected in S203 in FIGS. 52A and 52B.

The aggregation device A (29-1A) issues a sensor data acquire request (S261). Upon receipt of the sensor data acquire request issued from the aggregation device A (29-1A), the aggregation device X (29-1X) transfers the sensor data acquire request to the aggregation device B (29-1B) (S262). Afterwards, the processes in S252 through S258 in FIG. 56 are performed.

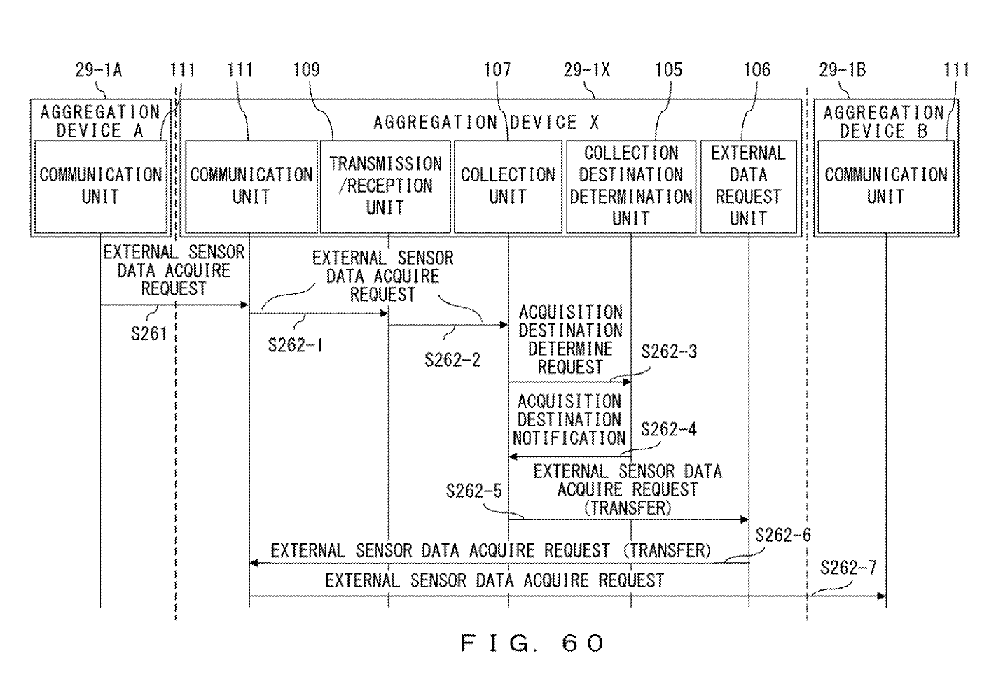

FIG. 60 is an example of the detailed sequence in S261 through S262 in FIG. 59. The aggregation device A (29-1A) notifies the aggregation device X (29-1X) of the sensor data acquire request illustrated in FIG. 39 (S261).

The communication unit 111 of the aggregation device X (29-1X) receives the external sensor data acquire request transmitted from the aggregation device A (29-1A). Then, the communication unit 111 transmits the external sensor data acquire request to the collection unit 107 through the transmission/reception unit 109 (S262-1, S262-2).

Upon receipt of the external sensor data acquire request, the collection unit 107 notifies the collection destination determination unit 105 of the acquisition destination determine request using the sensor identifier included in the external sensor data acquire request (S262-3).

The collection destination determination unit 105 notifies the collection unit 107 according to the flow in FIGS. 52A and 52B that there is no sensor 25 capable of acquiring the sensor data in the local sensor NW (S262-4). The collection unit 107 notifies the external data request unit 106 that the aggregation device B (29-1B) is requested to acquire the sensor data as indicated in S206 or 5211 in FIGS. 52A and 52B (S262-5). The external data request unit 106 transfers the sensor data acquire request illustrated in FIG. 39 to the aggregation device B (29-1B) through the communication unit 111 (S262-6, S262-7).

### Embodiment 2

The second mode for embodying the present invention (embodiment 2) is a method of adding the scheduling function to the second mode for embodying the present invention (embodiment 1) to use another sensor as a communication path in the time period in which there is enough communication capacity. In the present embodiment, the same configuration and function as those in the first mode for embodying the present invention and the second mode for embodying the present invention (embodiment 1) are assigned the same reference numerals, and the explanation is omitted here.

In the second mode for embodying the present invention (embodiment 2), the entire system configuration, the sensor 25, the collecting server 26, the management server 27, and the adapter 28-1 are similar to those in the second mode for embodying the present invention (embodiment 1), and the explanation is omitted here. The aggregation device 29-1 is also similar to that in the second mode for embodying the present invention (embodiment 1).

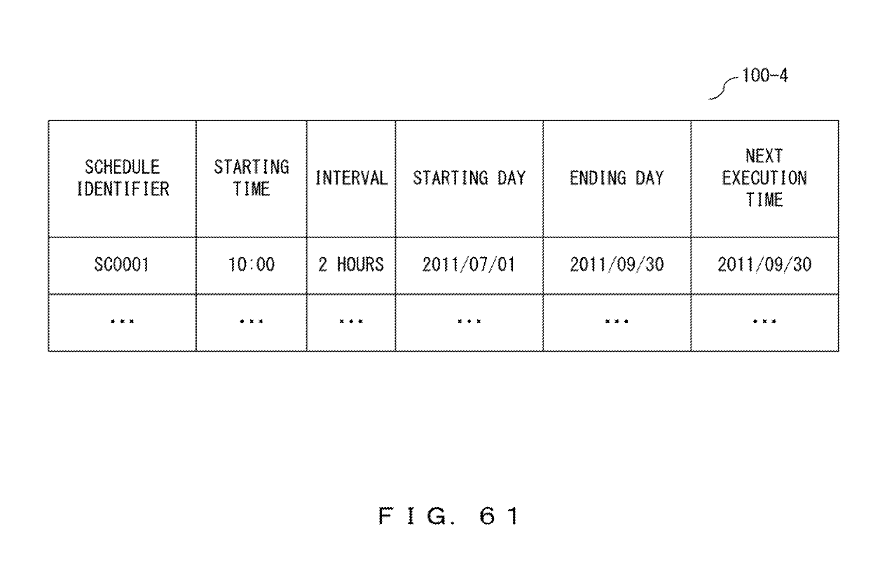

FIG. 61 is an example of the scheduling table according to the second mode for embodying the present invention (embodiment 2). A scheduling table 100-4 includes the data items of a “scheduling identifier”, a “starting time”, an “interval”, a “starting day”, an “ending day”, and a “next execution time”.

The “scheduling identifier” refers to an identifier for identification of the schedule information about the scheduling table 100-4. The “starting time” refers to the starting time of polling. The “interval” refers to the polling interval. The “starting day” refers to the starting day (date) of the period in which the polling is performed. The “ending day” refers to the ending day (date) of the period in which the polling is performed. The “next execution time” refers to the next execution time.

In addition to the process in the second mode for embodying the present invention (embodiment 1), the collection unit 107 refers to the scheduling table 100-4 stored in the sensor NW management information storage unit 100, and if it is activated in the period or time period of the sensor data collection, then it performs the polling process. On the other hand, when the collection unit 107 is activated in the period other than the time period off the sensor data collection, then it does not perform the polling process, but is terminated.

In addition to the process in the second mode for embodying the present invention (embodiment 1), the sensor NW management unit 101 manages the information about the sensor data collection time period. For example, the sensor NW management unit 101 updates the “next execution time” of the scheduling table 100-4 at the time obtained by adding the “interval” to the “starting time”.

In the second mode for embodying the present invention (embodiment 2), the operation example is the same as that in the embodiment 1 although the timing of the polling process of the second mode for embodying the present invention (embodiment 1) is different. Practically, in S231 in FIG. 55 or in S251-1 in FIG. 57, the collection unit 107 is activated according to the schedule information of the scheduling table 100-4.

Thus, since the aggregation device 29-1 can transmit a sensor data acquire request according to the preset time and date information, another sensor can be used as a communication path in a time period other than the present date and time.

### Embodiment 3

In the second mode for embodying the present invention (embodiment 1), the sensor data is collected at any time. On the other hand, in the second mode for embodying the present invention (embodiment 3), the collecting method of collecting data from the sensor 25 for a specified period can be selected, and when the adapter acquires the sensor data for the specified time, the data can be collectively transmitted to the aggregation device as described below. In the present embodiment, the same configuration and function as those in the first and second modes for embodying the present invention (embodiments 1 and 2) are assigned the same reference numerals, and the explanation is omitted here.

In the second mode for embodying the present invention (embodiment 3), since the entire system configuration, the sensor 25, the collecting server 26, and the management server 27 are the same as those in the embodiment 1, the explanation is omitted here.

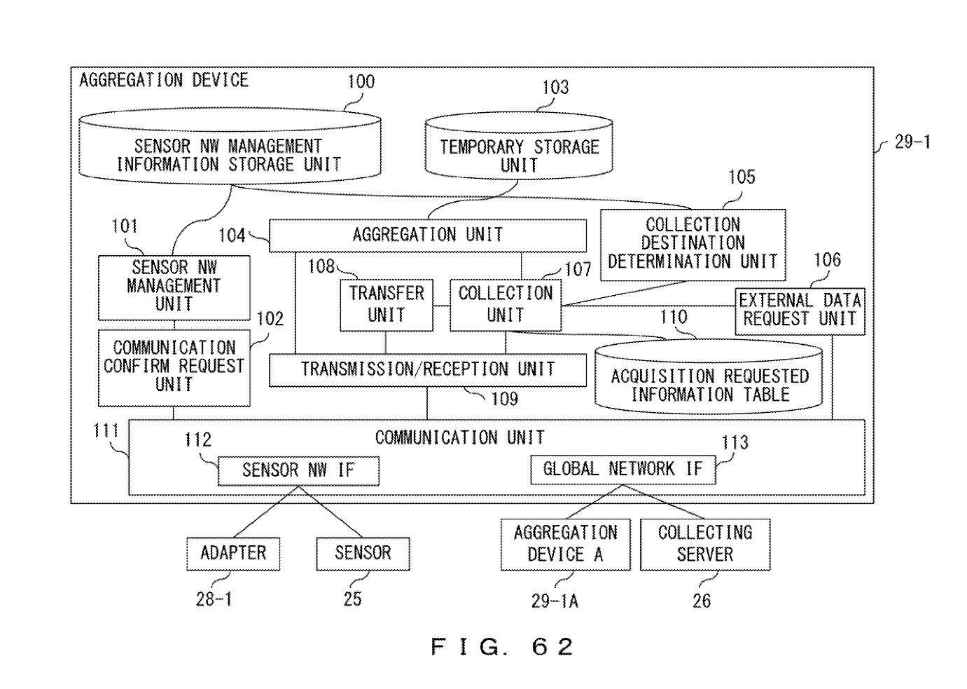

FIG. 62 is a block diagram of the function of the aggregation device according to the second mode for embodying the present invention (embodiment 3). The aggregation device 29-1 in FIG. 62 has no relation line between the collection unit 107 and the sensor NW management information storage unit 100 as in FIG. 38. In the description below, the collection unit 107, the collection destination determination unit 105, the acquisition requested information table 110, the sensor NW management unit 101, and the sensor NW management information storage unit 100 are described below.

In addition to the process according to the second mode for embodying the present invention (embodiment 1), the collection destination determination unit 105 refers to the collecting method information such as the number of aggregating operations, the collecting intervals, etc. from the sensor NW management information storage unit 100, and stores the collecting method information in the acquisition requested information table 110. The collection destination determination unit 105 notifies the collection unit 107 of the collecting method information.

In addition to the process according to the second mode for embodying the present invention (embodiment 1), the sensor NW management unit 101 manages the data collecting method of each sensor 25.

In addition to the process according to the second mode for embodying the present invention (embodiment 1), the collection unit 107 performs the following process as the collecting method at an external sensor data acquire request when the collection destination determination unit 105 transmits the collecting method information to the collection unit 107. The collection unit 107 transmits to the adapter 28-1 the sensor data acquire request including the collecting method information reported from the collection destination determination unit 105 through the transmission/reception unit 109. The contents of the sensor data acquire request is issued to the adapter 28-1 to acquire data from the sensor 25 for a specified time, and return the sensor data for the number of acquiring processes collectively to the aggregation device 29-1.

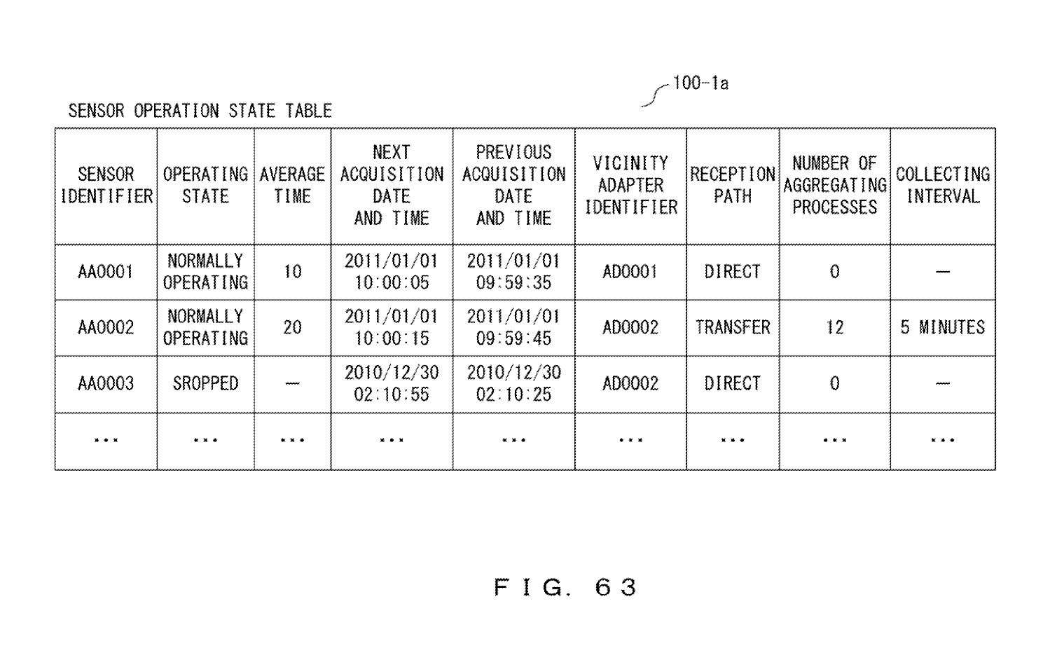

FIG. 63 is an example of the sensor operation state table according to the second mode for embodying the present invention (embodiment 3). The sensor operation state table 100-1a is obtained by adding the data items of a “number of aggregating processes” and a “collecting interval”. The “number of aggregating processes” refers to the frequency of holding the sensor data corresponding to the sensor data acquire request in the temporary storage unit 123. The “collecting interval” refers to the collecting interval of the sensor data.

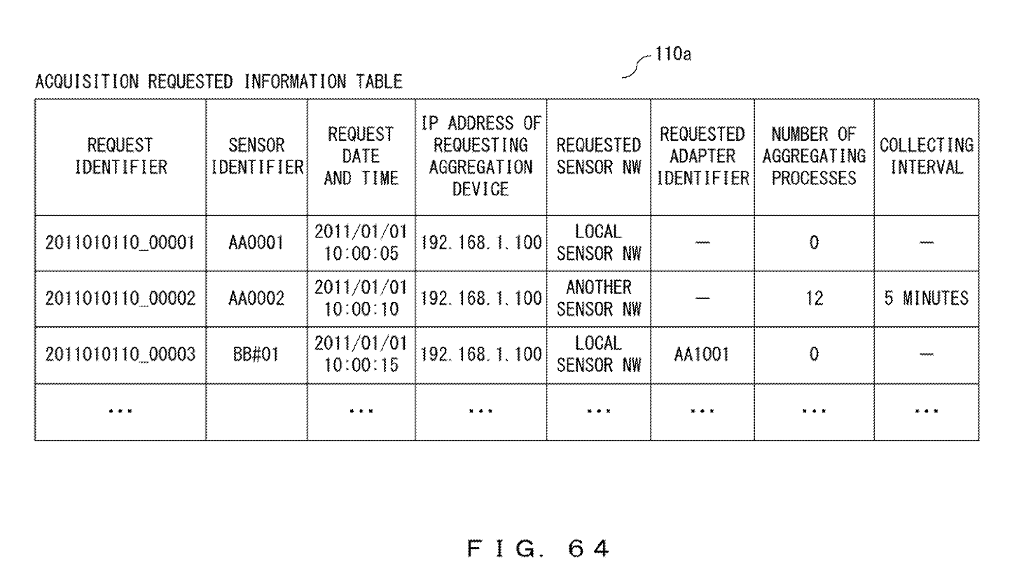

FIG. 64 is an example of the acquisition requested information table according to the second mode for embodying the present invention (embodiment 3). The acquisition requested information table 110a is obtained by adding the data items of the “number of aggregating processes” and the “collecting interval” to the acquisition requested information table 110 in FIG. 40.

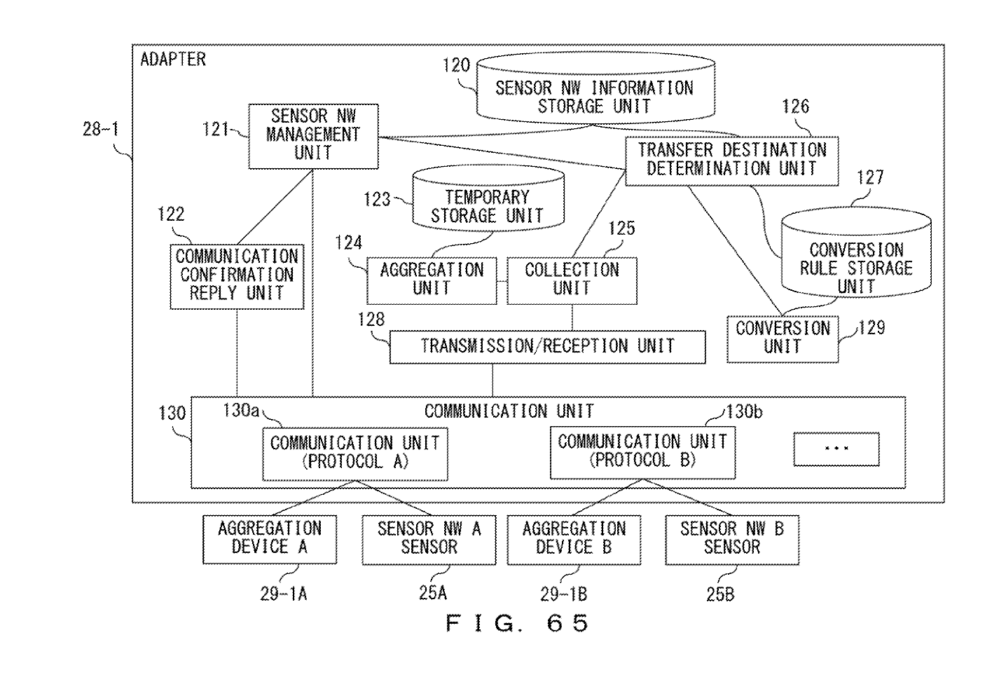

FIG. 65 is a block diagram of the function of the adapter according to the second mode for embodying the present invention (embodiment 3). FIG. 65 is obtained by adding the temporary storage unit 123, the aggregation unit 124, and the collection unit 125 to the adapter 28-1 in FIG. 45. The portion different from the operation according to the second mode for embodying the present invention (embodiment 1) is described below.

The transmission/reception unit 128 receives the sensor data acquire request and the sensor data, and notifies the collection unit 125 of the reception.

The collection unit 125 receives the sensor data acquire request from the transmission/reception unit 128, and acquires the values of the “number of aggregating processes” and the “collecting interval” included in the sensor data acquire request. When a set value of the acquired number of aggregating processes is larger than 0, the collection unit 125 performs polling to the sensor 25 at the acquired collecting interval, and issues the sensor data acquire request. In this example, the collection unit 125 performs polling to the sensor 25 capable of communicating with the adapter 28-1 for the number of aggregating processes acquired from the sensor data acquire request. If the number of aggregating processes acquired from the sensor data acquire request is 0, the collection unit 125 once issues the sensor data acquire request to the sensor 25 capable of communicating with the adapter 28-1.

Upon receipt of the sensor data from the sensor 25 in response to the sensor data acquire request, the collection unit 125 notifies the aggregation unit 124 of the sensor data. The aggregation unit 124 aggregates (stores in the temporary storage unit 123) the sensor data received from the collection unit 125. When the sensor data for the number of aggregating processes set in the sensor data acquire request by the aggregation unit 124 is aggregated (held in the temporary storage unit 123), the collection unit 125 transmits the aggregated sensor data to the aggregation device 29-1. When the sensor data is transmitted, the transfer destination determination unit 126 converts the transfer destination and data as described in the second mode for embodying the present invention (embodiment 1), and transmits the sensor data to the aggregation device 29-1 through the transmission/reception unit 128.

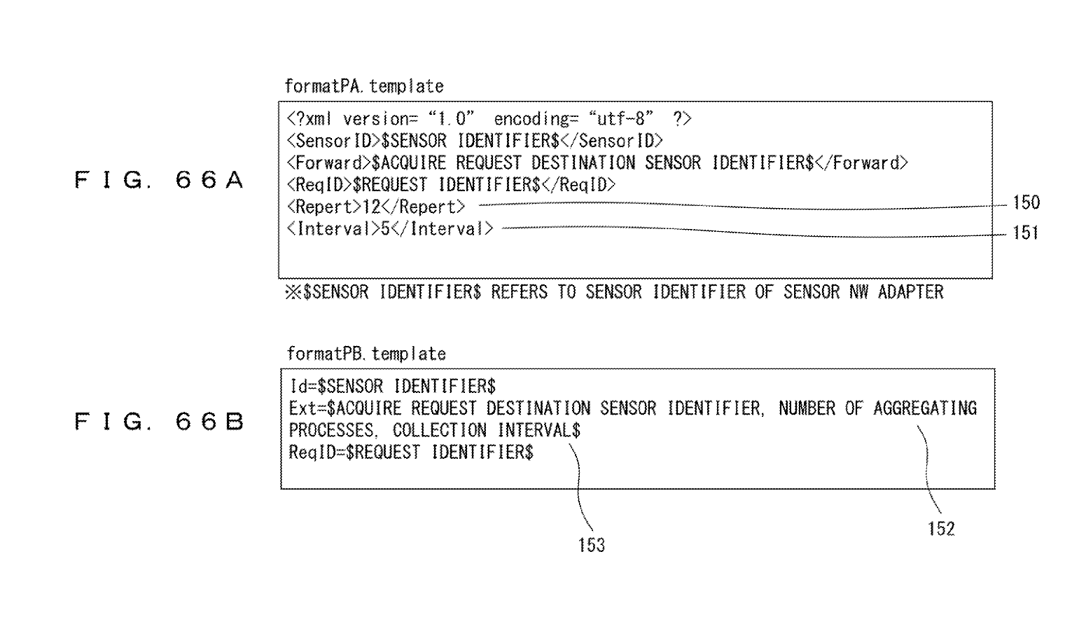

FIGS. 66A and 66B are examples of the template file used when a sensor data acquire request is issued according to the second mode for embodying the present invention (embodiment 3). FIG. 66A is an example of the format PA. FIG. 66A is obtained by adding the tags of the number of aggregating processes (150) and the collecting interval (151) to FIG. 49A. FIG. 66B is an example of the format PB. FIG. 66B is obtained by adding the number of aggregating processes (152) and the collecting interval (153) in the text format to FIG. 49B.

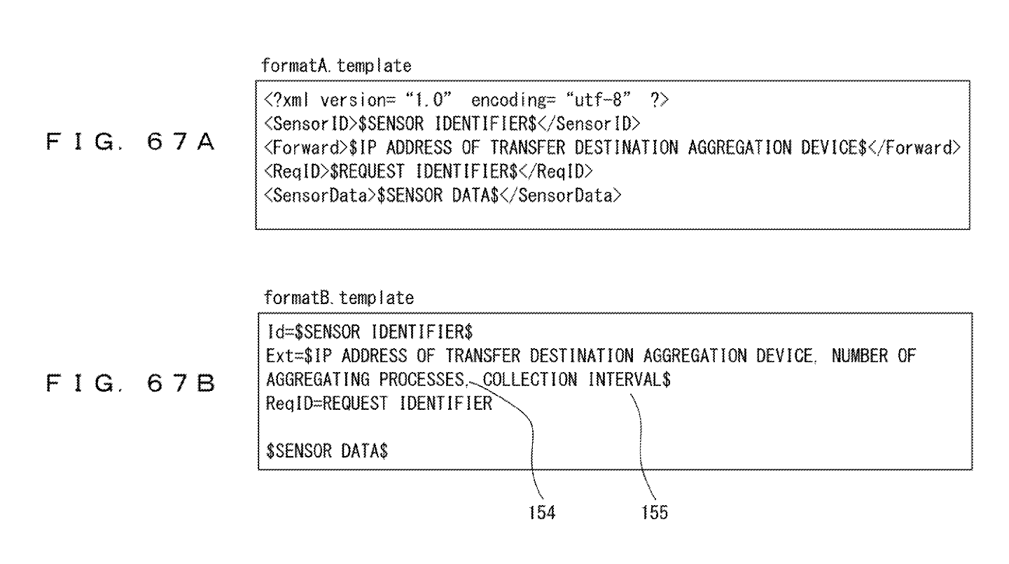

FIGS. 67A and 67B are examples of the template file used when sensor data is transmitted according to the second mode for embodying the present invention (embodiment 3). FIG. 67A is similar to FIG. 51A. FIG. 67B is obtained by adding the number of aggregating processes (154) and the collecting interval (155) in the text format.

Next, the sequence among the function blocks is described below as an operation example according to the second mode for embodying the present invention (embodiment 3). Described below are the entire sequence and the detailed sequence with respect to the adapter different in operation according to the second mode for embodying the present invention (embodiment 1).

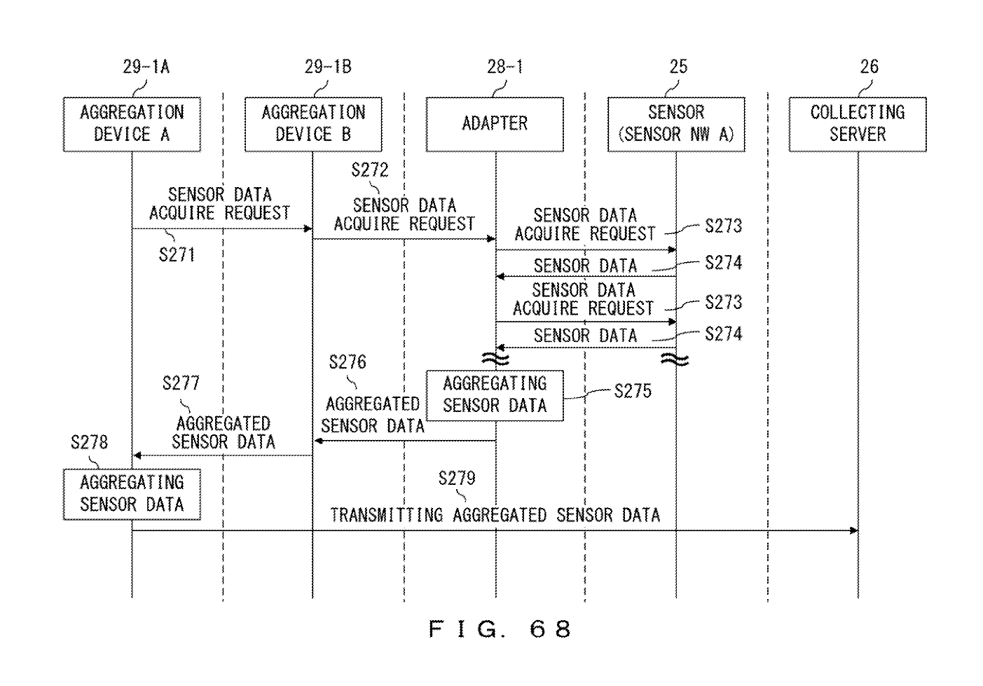

FIG. 68 is an example of the entire sequence when the sensor data is aggregated in the adapter according to the second mode for embodying the present invention (embodiment 3). The aggregation device A (29-1A) notifies the aggregation device B (29-1B) of the sensor data acquire request including the collecting method information such as the number of aggregating processes, the collecting interval, etc. illustrated in FIGS. 66A and 66B (S271).

The aggregation device B (29-1B) retrieves the adapter 28-1 corresponding to the sensor identifier included in the sensor data acquire request from each table of the sensor NW management information storage unit 100. The aggregation device B (29-1B) notifies the retrieved adapter 28-1 of the sensor data acquire request (S272).

The adapter 28-1 performs polling plural times to the sensor 25 capable of communicating with the adapter 28-1 according to the collecting method information about the sensor data acquire request, and notifies the sensor data acquire request at specified intervals (S273). The adapter 28-1 receives the sensor data from the sensor 25 each time the sensor 25 receives the notification of the sensor data acquire request (S274).

The adapter 28-1 aggregates the received sensor data (holds the data in the temporary storage unit 123), and transmits the aggregated sensor data sensor data held in the temporary storage unit 123) to the aggregation device B (29-1B) (S276).

The aggregation device B (29-1B) transmits the sensor data to the aggregation device A (29-1A) (S277).

The aggregation device A (29-1A) aggregates (holds in the temporary storage unit 103) the sensor data transmitted from the aggregation device B (29-1B) (S278). The aggregation device A (29-1A) transmits the aggregated sensor data (sensor data which has been aggregated) to the collecting server 26 (S279).

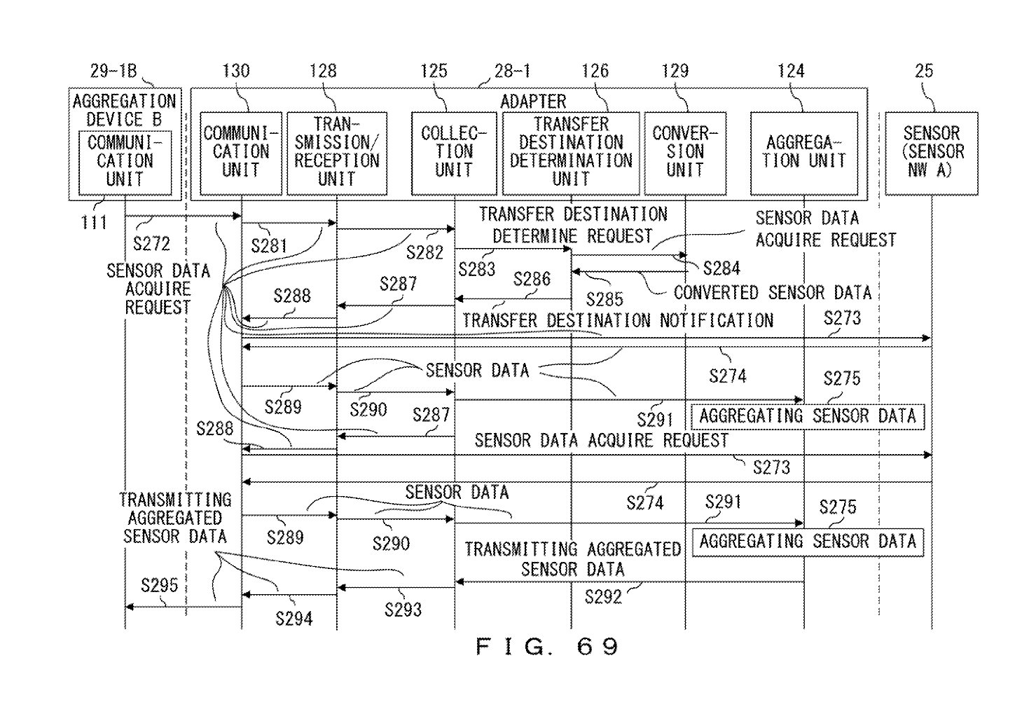

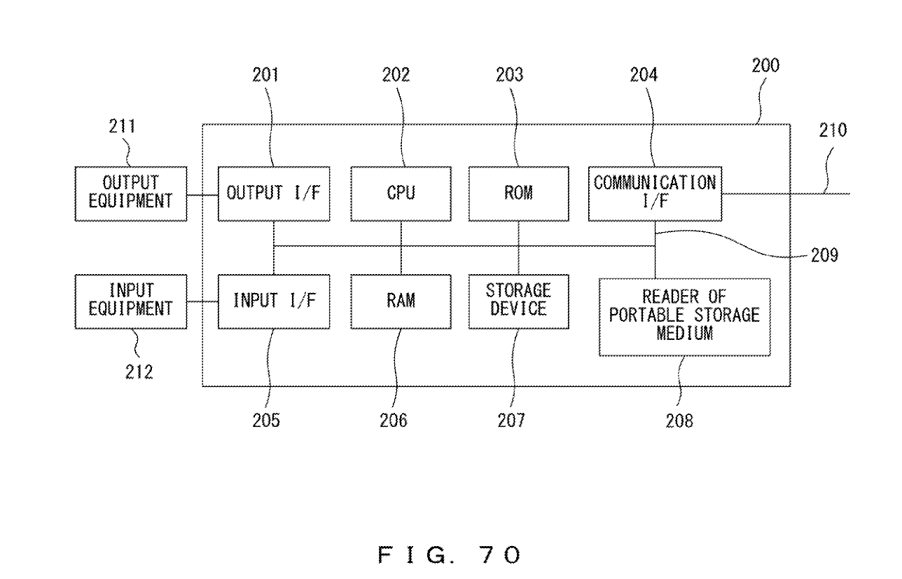

FIG. 69 is an example of the detailed sequence in S272 through S276 in FIG. 68. The aggregation device B (29-1B) retrieves the adapter 28-1 corresponding to the sensor identifier included in the sensor data acquire request from each table of the sensor NW management information storage unit 100. The aggregation device B (29-1B) notifies the retrieved adapter 28-1 of the sensor data acquire request (S272).

Upon receipt of the sensor data acquire request from the aggregation device B (29-1B), the communication unit 130 of the adapter 28-1 transfers the request to the collection unit 125 (S281, S282). The collection unit 125 notifies the transfer destination determination unit 126 of the transfer destination determine request (S283).

The transfer destination determination unit 126 determines based on the received sensor data acquire request the sensor 25 as a transfer destination of the sensor data acquire request, and notifies the conversion unit 129 of the request to convert the format of the sensor data (S284). The conversion unit 129 converts the data format of the sensor data acquire request based on the acquire request conversion table 127-1 illustrated in FIG. 48. The conversion unit 129 returns the format converted sensor data acquire request to the transfer destination determination unit 126 (S285). Then, the transfer destination determination unit 126 notifies the collection unit 125 of the transfer destination determined in S284 and the sensor data acquire request whose format has been converted in S285 (S286).

The collection unit 125 reads the collecting method information (“number of aggregating processes”, “collecting interval”) from the sensor data acquire request. The collection unit 125 transmits the sensor data acquire request to the sensor 25 through the transmission/reception unit 128 and the communication unit 130 (S287, 5288, S273). Upon receipt of the sensor data acquire request, the sensor 25 transmits the sensor data to the adapter 28-1 (S274).

The aggregation unit 124 receives the sensor data from the sensor 25 through the communication unit 130, the transmission/reception unit 128, and the collection unit 125 (S289, 5290, S291). The aggregation unit 124 aggregates the sensor data, that is, holds the data in the temporary storage unit 123 (S275).

According to the collecting method information (number of aggregating processes, collecting interval) read by the collection unit 125, the processes in S287 through 288→S273 through S274→S289 through S291→S275 are repeated on the sensor 25 to be polled.

Then, the aggregation unit 124 transmits the aggregated sensor data to the aggregation device B (29-1B) through the aggregation unit 124, the collection unit 125, the transmission/reception unit 128, and the communication unit 130 (S293 through S295, S276).

Thus, the adapter 28-1 acquires and holds the sensor data depending on the specified frequency. The adapter 28-1 can transmit to the aggregation device 29-1 the sensor data hold several times.

According to the second mode for embodying the present invention, the sensor data collection system includes the first aggregation device, the second aggregation device, and the adapter. The first aggregation device aggregates the first sensor NW in which a plurality of first sensors for measuring the first amount of observation are connected and their sensor data by a polling system. The second aggregating device aggregates the second sensor NW in which a plurality of second sensors for measuring the second amount of observation are connected and their sensor data by a polling system. The adapter issues a sensor data acquire request to the second aggregating device connected in the global network when the first aggregating device cannot issue a sensor data acquire request to the first sensor through the first sensor NW. The adapter is connected so that the second aggregating device can issue a sensor data acquire request to the first sensor in the first sensor in the first sensor NW through the second sensor NW.

With the above-mentioned configuration, since the sensor data can be collected although the communication in the sensor NW is disconnected due to the presence of an unavailable sensor in the sensor NW, the collection efficiency of the sensor data can be improved.

When the first sensor data cannot be collected, the second aggregating device further transfers the sensor data acquire request to another aggregation device.

In the first aggregating device, a sensor data collecting method can be specified when the sensor data acquire request is issued to the second aggregating device. In this case, the adapter can aggregate (hold in a temporary storage unit) the sensor data in a specified collecting method.

A sensor data acquiring schedule can be specified according to the time of use of the sensor as the polling condition for the adapter.

FIG. 70 is a block diagram of the configuration of the hardware environment of the computer according to the first or second mode for embodying the present invention. A computer 200 functions as adapters 28, 28-1, aggregation devices 29, 29-1, the collecting server 26, or the management server 27 by reading the program for performing the process according to the first or second mode for embodying the present invention.

The computer 200 includes an output I/F 201, a CPU 202, ROM 203, a communication I/F 204, an input I/F 205, RAM 206, a storage device 207, a reader 208, and a bus 209. The computer 200 can be connected to output equipment 211 and input equipment 212.

The CPU is short for a central processing unit. ROM refers to read only memory. RAM refers to random access memory. An I/F refers to an interface. The bus 209 is connected to the output I/F 201, the CPU 202, the ROM 203, the communication I/F 204, the input I/F 205, the RAM 206, the storage device 207, and the reader 208. The reader 208 is a device for reading a portable record medium. The output equipment 211 is connected to the output I/F 201. The input equipment 212 is connected to the input I/F 205.

As the storage device 207, various types of storage devices such as a hard disk drive, a flash memory device, a magnetic disk device, etc. can be used.

The storage device 207 or the ROM 203 stores the program of, for example, the adapter 28, 28-1, the aggregation device 29, 29-1, the collecting server 26, or the management server 27 for realizing the process described with reference to the first or second mode for embodying the present invention described above. In addition, the storage device 207 or the ROM 203 can store data as the temporary storage units 33, 37, 42, 50, the sensor/NW management information storage unit 55, the sensor NW information storage unit 65, and the rule storage unit 66. The storage device 207 or the ROM 203 can also store data as the sensor NW management information storage unit 100, the temporary storage unit 103, the sensor NW information storage unit 120, the temporary storage unit 123, and the conversion rule storage unit 127.

The CPU 202 reads a program for realizing the process described with reference to the first or second mode for embodying the present invention stored in the storage device 207 etc., and executes the program. Practically, the CPU 202 functions as the adapter 28, 28-1, the aggregation device 29, 29-1, the collecting server 26, and the management server 27 by executing the program.

The program for realizing the process described with reference to the first or second mode for embodying the present invention can be stored in, for example, the storage device 207 from a program provider through a communication network 210 and the communication I/F 204. The program for realizing the process described with reference to the first or second mode for embodying the present invention can also be stored in a marketed and distributed portable storage medium. In this case, the portable storage medium can be set in the reader 208, and the program in the medium can be read and executed by the CPU 202. The portable storage medium can be various types of storage media such as CD-ROM, a flexible disk, an optical disk, a magneto optical disk, an IC card, a USB memory device, etc. The program stored in such a storage medium is read by the reader 208.

The input equipment 212 can be a keyboard, a mouse, an electronic camera, a Web camera, a microphone, a scanner, a sensor, a tablet, a touch panel, etc. The output equipment 211 can be a display, a printer, a speaker, etc. The network 210 can be a communication network such as the Internet, a LAN, a WAN, a dedicated line, a cable, a radio, etc.

The following modes for embodying the present invention can provide a sensor data collecting system capable of collecting the sensor data although there is an unavailable sensor in the sensor NW.

The present invention is not limited to the above-mentioned modes for embodying the present invention, but can take various configurations and modes for embodying the invention within the scope of the gist of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A sensor data collection system, comprising:
a first collecting device which is connected to a first network to which a plurality of first sensors for measuring a first amount of observation are connected and to an external network, and collects first sensor data as a measurement result of the first amount of observation of the plurality of first sensors;
a second collecting device which is connected to a second network to which a plurality of second sensors for measuring a second amount of observation are connected and to the external network, and collects second sensor data as a measurement result of the second amount of observation of the plurality of second sensors; and
an adapter which is connected to the first network and the second network, and transfers the first sensor data to the second collecting device through the second network, and transmits the first sensor data to the first collecting device from the second collecting device through the external network when the first collecting device cannot collect the first sensor data through the first network.

2. The system according to claim 1, wherein
when the first sensor data is transmitted to the second network, the adapter converts a data format of the first sensor data into a data format of the second sensor data, and transmits the converted data.

3. The system according to claim 2, wherein
upon receipt of the first sensor data in the data format of the second sensor data from the second collecting device, the first collecting device converts the first sensor data into the data format of the first sensor data.

4. The system according to claim 2, wherein
upon receipt of the first sensor data in the data format of the second sensor data, the second collecting device converts the first sensor data into the data format of the first sensor data and transmits the data to the first collecting device.

5. The system according to claim 1, wherein
the adapter can change through a network a destination of the second sensor data by the second sensor of the first sensor data by the first sensor.

6. The system according to claim 1, wherein
the first collecting device and the second collecting device transfer collected sensor data to a server connected to the external network.

7. The system according to claim 1, wherein
when it is determined that the first collecting device cannot collect the first sensor data through the first network, the adapter determines that a communication path of the first network has been disconnected by an occurrence of a fault in at least one of the plurality of first sensors.

8. The system according to claim 1, wherein
the first collecting device transmits communication confirmation information to the adapter, and determines a communication state between the first collecting device and the adapter depending on a reply from the adapter in response to the communication confirmation information.

9. The system according to claim 1, wherein
when the first collecting device cannot collect the first sensor data through the first network, the first collecting device transmits, through the second collecting device, acquire request information about a request to the adapter to acquire the first sensor data, and acquires the first sensor data corresponding to the acquire request information from the adapter.

10. The system according to claim 1, wherein
the adapter acquires and holds the first sensor data depending on a specified frequency, and transmits the first sensor data held at the frequency to the first collecting device.

11. The system according to claim 9, wherein
the first collecting device transmits the acquire request information according to preset date and time information.

12. A repeating device connected to a first network and a second network of a sensor data collection system having: a first collecting device which is connected to the first network to which a plurality of first sensors for measuring a first amount of observation are connected and to an external network, and collects first sensor data as a measurement result of the first amount of observation of the plurality of first sensors; and a second collecting device which is connected to the second network to which a plurality of second sensors for measuring a second amount of observation are connected and to the external network, and collects second sensor data as a measurement result of the second amount of observation of the plurality of second sensors, comprising:
a detection unit detecting whether or not the first collecting device can collect the first sensor data through the first network; and
a transfer unit transferring the first sensor data by allowing the second collecting device through the second network to transmit the data from the second collecting device to the first collecting device through the external network when it is determined that the first collecting device cannot collect the first sensor data through the first network.

13. A collecting device which is connected to a first network to which a plurality of first sensors are connected and to an external network, and collects sensor data of the plurality of first sensors, comprising:
a reception unit receiving sensor data of a second sensor not directly connected to the first network; and
a transfer unit transferring through the external network the received sensor data to another collecting device provided in a second network to which the second sensor is directly connected.

14. A sensor data transfer method using a sensor data collection system having: a first collecting device which is connected to the first network to which a plurality of first sensors for measuring a first amount of observation are connected and to an external network, and collects first sensor data as a measurement result of the first amount of observation of the plurality of first sensors; a second collecting device which is connected to the second network to which a plurality of second sensors for measuring a second amount of observation are connected and to the external network, and collects second sensor data as a measurement result of the second amount of observation of the plurality of second sensors; and an adapter connected to the first network and the second network, wherein
when the first collecting device cannot collect the first sensor data through the first network, the adapter transfers the first sensor data to the second collecting device through the second network to transmit the first sensor data from the second collecting device to the first collecting device through the external network.

15. A program for directing a repeating device which is connected to a first network and a second network of a sensor data collection system having: a first collecting device which is connected to the first network to which a plurality of first sensors for measuring a first amount of observation are connected and to an external network, and collects first sensor data as a measurement result of the first amount of observation of the plurality of first sensors; and a second collecting device which is connected to the second network to which a plurality of second sensors for measuring a second amount of observation are connected and to the external network, and collects second sensor data as a measurement result of the second amount of observation of the plurality of second sensors, and directs the collection system to execute a data transfer, wherein
the repeating device is directed to:
detect whether or not the second collecting device can collect through the first network; and
transfer the first sensor data to the second collecting device through the second network when it is determined in a detecting process that the first collecting device cannot collect the first sensor data through the first network.

16. A program used to direct a collecting device, which is connected to a first network to which a plurality of first sensors and to an external network, and collects sensor data of the plurality of first sensors, to execute a data transfer, wherein
the collecting device is directed to:
receive sensor data of a second sensor not directly connected to the first network; and
transfer through the external network the received sensor data to another collecting device provided in a second network to which the second sensor is directly connected.

17. A collecting device which is connected to a network to which a plurality of sensors for measuring an amount of observation are connected, and collects sensor data as a measurement result of the amount of observation of the plurality of sensors, comprising:
a communication confirmation unit transmitting communication confirmation information to a communication device capable of any of the sensors; and
a state determination unit determining a communication state between the collecting device and the communication device depending on a reply from the communication device in response to the communication confirmation information.

18. The system according to claim 1 as a collecting device which is connected to a network to which a plurality of sensors for measuring an amount of observation are connected, and collects sensor data as a measurement result of the amount of observation of the plurality of sensors, comprising:
a transmission unit transmitting acquire request information about a request to a communication device capable of communicating with any of the plurality of sensors to acquire the sensor data through another collecting device connected to the second network when the first collecting device cannot collect the first sensor data through the first network; and
a reception unit receiving the first sensor data corresponding to the acquire request information from the communication device.
